(19) United States
(12) Patent Application Publication
(10) Pub. No.: US 2007/0093942 A1
(43) Pub. Date: Apr. 26, 2007

(54) Method for solving waveform sequence-matching problems using multidimensional attractor tokens

(75) Inventor: Kenneth M. Happel, Encinitas, CA (US)

Correspondence Address: FOLEY & LARDNER, 2029 CENTURY PARK EAST, SUITE 3500, LOS ANGELES, CA, 90067, US

(73) Assignee: Omnigon Technologies Ltd.

(21) Appl. No.: 11/485,073

(22) Filed: Jul. 11, 2006

Related U.S. Application Data
(63) Continuation of application No. 10/260,089, filed on Sep. 27, 2002, now abandoned.
Application No. 10/260,089 is a continuation-in-part of application No. 10/161,891, filed on Jun. 3, 2002, now Pat. No. 7,061,491.

(51) Int. Cl. G05D 11/00

(52) U.S. Cl. 700/294

(57) ABSTRACT

An improved method is provided for solving waveform description, matching and comparison problems using attractor-based processes to extract identity tokens that indicate sequence and subsequence symbol content and order of the waveform or waveform segments. The waveform is described with a suitable alphabet to extract the ontology of the waveform, and syntactical rules are applied to direct pattern extraction using the alphabet. The patterns are extracted in a hierarchical, embedded manner according the global or local maximia and minimia so that the resulting statements are compatible with analysis in catastrophe theory. The attractor processes map the resulting waveform sequence from its original sequence representation space (OSRS) into a hierarchical multidimensional attractor space (HMAS). The HMAS can be configured to represent equivalent symbol distributions within two symbol sequences or perform exact symbol sequence matching. The mapping process results in each sequence being drawn to an attractor in the HMAS. Each attractor within the HMAS forms a unique token for a group of sequences with no overlap between the sequence groups represented by different attractors. The size of the sequence groups represented by a given attractor can be reduced from approximately half of all possible sequences to a much smaller subset of possible sequences. The mapping process is repeated for a given sequence so that tokens are created for the whole sequence and a series of subsequences created by repeatedly removing a symbol or group of symbols from the one end of sequence and then repeating the process from the other end. The resulting string of tokens represents the exact identity of the whole sequence and all its subsequences ordered from each end.

### RELATED APPLICATIONS

The present application is a continuation of U.S. patent application Ser. No. 10/260,089, filed Sep. 27, 2002, which is a continuation-in-part of U.S. patent application Ser. No. 10/161,891, titled “METHOD FOR SOLVING FREQUENCY, FREQUENCY DISTRIBUTION AND SEQUENCE-MATCHING PROBLEMS USING MULTIDIMENSIONAL ATTRACTOR TOKENS”, filed Jun. 3, 2002, which are hereby incorporated by reference.

### BACKGROUND OF THE INVENTION

1. Field of the Invention

Embodiments of the present invention relate to solving the comparison, analysis and characterization of waveforms in 1D, 2D, 3D and ND. These embodiments reduce the structure of the morphology of the waveform itself to a descriptive alphabet, allowing a sequence of characters from the alphabet to be interpreted as an equivalent statement of the waveform morphology and an invertable statement of the quality of the waveform itself. When the waveform is so described, the quality of the waveform can be reconstructed to the degree of resolution given by the alphabet and the syntactical rules used in the descriptive statement.

2. Background Art

The following discussion of the background of the invention is merely provided to aid the reader in understanding the invention and is not admitted to describe or constitute prior art to the present invention.

Many techniques have been developed to expedite the comparison of waveform morphologies and their analysis. Probably the most familiar is Fourier which is an affine independent means of describing and characterizing the shape of a waveform such that one can match sections, intervals or segments of waveforms without having to first perform multidimensional scaling, and without having to first handle various types of affine distortions between the two things to be compared. One problem with Fourier and many similar techniques, including wavelets and fractals and other forms of analysis, is that they tend to be computationally heavy through the use of integral calculus. Embodiments of the current invention are based upon the utilization of the discrete form of Fourier, known as chain coding, as a means of creating a description of the morphology of waveforms, such that the secondary analysis, instead of proceeding with normal Fourier intervals, proceeds with an attractor based examination and characterization of the waveform alphabet's sequence order to accomplish the same result.

The most fundamental cost driver of almost all frequency and waveform-based analytical equipment and the success of their use in their domains of application, such as telecommunications, computer science, radio and various types of scientific inquiry, is the cost of computing Fourier transformations. Embodiments of the current invention reduce those transformations to a format which is executable and operable without a computer CPU and at the speed of communication, and, in fact, can be performed inline in the communication's fiber system itself.

The attractor based analysis rest upon the analysis of frequencies and signal attributes or sequences, namely the waveform alphabet's sequence and frequencies. Nearly all technical fields have problems involving the representation and analysis of frequencies, frequency distributions, waveforms, signal attributes or sequences. Computational devices including hardware or software are used for the analysis or control of frequencies, frequency distributions, waveforms, signal attributes or sequences, symbols (this includes pattern and pattern recognition features). These devices are mapped to each element or sub-element of the frequency, frequency distribution, waveform, signal attribute or sequence, thereby forming a sequence of symbols that can be either inverted back to the original frequency, frequency distribution, waveform, signal attribute or sequence or used for detection, recognition, characterization, identification or description of frequency, frequency distribution, waveform, signal attribute, sequence element or sequence.

Conventional algorithms have utilized various techniques for the identification of the number of times a symbol occurs in a symbol sequence forming a symbol frequency spectrum. An unknown symbol frequency spectrum is compared to the symbol frequency spectrum obtained by such conventional algorithms, in various applications such as modal analysis of vibrations or rotational equipment, voice recognition and natural language recognition.

In many practical applications, the symbol sequences representing frequencies, frequency distributions, waveforms, signal attributes or sequences to be matched may have regions or embedded sections with full or partial symbol sequence overlaps or may have missing or extra symbols or symbol sequence elements within one or both of their representative symbol sequences. Furthermore, the sets of symbols representing each frequency, frequency distribution, waveform, signal attribute or sequence or their sub-frequency, sub-frequency distribution, sub-waveform, signal sub-attribute or subsequence may have dissimilar elements in whole or in part.

The frequency, frequency distribution, waveform, signal attribute or sequence features to be correlated are distances, distance distributions or sets of distance distributions in the frequency, frequency distribution, waveform, signal attribute or sequence which must be discovered, detected, recognized, identified or correlated. Furthermore, in many situations, symbols in such a symbol description of frequency, frequency distribution, waveform, signal attribute or sequence typically have no known meta-meaning to allow the use of a priori statistical or other pattern knowledge to identify the significance other than the to be discovered, detected, recognized, identified or correlated frequency, frequency distribution, waveform, signal attribute or sequence themselves. A whole but unknown frequency, frequency distribution, waveform, signal attribute or sequence may be assembled from frequency, frequency distribution, waveform, signal attribute or sequence fragments which may or may not include errors in the frequency, frequency distribution, waveform, signal attribute or sequence fragments.

An unknown frequency, frequency distribution, waveform, signal attribute or sequence being assembled from fragments may have repetitive symbol sequence or symbol subsequence patterns that require recognition and may create ambiguity in assembly processes. Such ambiguity results in many types of assembly errors. Such errors may occur during the assembly of a frequency description, frequency distribution, waveform, signal attribute or sequence of wrong length due to the miss-mapping of two copies of a repeating pattern or group of repeating sub-patterns which were in different places in an unknown symbol sequence to the same position in the assembled symbol sequence. Furthermore, waveform, signal attribute or sequences may have features and feature relationships that need be discovered, indexed, classified, or correlated and then applied to the evaluation of other waveform, signal attribute or sequences.

Conventional algorithms for these types of activities usually involve the evaluation of heuristic statements or iterative or recursive searching, pattern detection, matching, recognition, identification, or correlation algorithms that can be combinatorially explosive processes, thereby requiring massive numbers of CPU cycles and huge memory or storage capacity to accomplish very simple problems.

The previously mentioned combinatorial explosion occurs because finding a specific leaf at the end of a sequence of branches from the trunk of a tree without some prior knowledge of where the right leaf may be, may require that every possible combination of trunk-(branch-sequence)-leaf be followed before the path to the right leaf is found.

In many scientific, engineering and commercial applications, the presence of ambiguity and errors makes the results unreliable, unverifiable, or makes algorithms themselves unstable or inapplicable. Efforts to mitigate these problems have centered on the restriction of the scope of heuristic evaluation and pattern algorithms by building a fixed classification structure and working from a proposed answer (the leaf) back to the original waveform, signal attribute or sequence expression (the trunk). This approach is called “backwards chaining.”

This approach works where the whole field of possible patterns and relationships has been exhaustively and mathematically completely defined (you can backward chain from the right leaf to the trunk if the right leaf is not part of the model). If any element is missing, it cannot be evaluated or returned by execution of the pattern algorithms. This problem is known as the “frame problem” that causes execution errors or failure of algorithms to satisfy their intended function. One result is that many software algorithms that have been developed are found to be unusable or impractical in many applications.

The current state of the art typically involves strategies for limiting the effect or scope of these combinatorially explosive behaviors by the development of vastly more powerful computational platforms, ever more expensive system architectures and configurations, and restriction of software algorithms to simple problems or projects which can afford the time and cost of use.

### SUMMARY OF THE INVENTION

The above background art is intended merely as a generic description of some of the challenges encountered by data processing hardware and software when solving waveform, signal attribute or sequence-matching problems, and not as any admission of prior art.

An embodiment of the invention may be described as a method of waveform, characterization or matching which includes mapping waveform (or a waveform segment) from an original representation space (ORS) into a hierarchical multidimensional attractor space (HMAS) to draw the waveform to attractors in the HMAS. Each interaction of the attractor process with the ORS exhibits a repeatable behavior which may be assigned a token or label. Repeating the mapping for sub-waveforms creates a string of tokens for the given waveform. The resulting token string is mapped to create a spatial coordinate in a hierarchy of spaces for the given waveform. Evaluation of the token strings in the hierarchy of spaces permits comparison of two or more of the waveforms (or waveform segments). This method is also exactly applicable to the solution of frequency and frequency distribution characterization, matching and identification problems.

Embodiments of the invention may also be described as a method for determining a combinatorial identity of a waveform or waveform segment source set from a waveform source multiset space. The waveform source multiset has a plurality of elements, and the method involves a) configuring a device in at least one of hardware, firmware and software to carry out an attractor process for mapping the waveform source multiset to an attractor space, the attractor process being an iterative process which cause said plurality of elements to converge on one of at least two different behaviors defined within said attractor space as a result of the iterative process, the configuring step including inputting a characterization of the waveform source multiset to input to the device the number of distinct elements of the waveform source multiset;

b) using the device, executing the mapping of the plurality of elements of the waveform source multiset to one or more coordinates of the attractor space; c) mapping the attractor space coordinates into a target space representation, the target space representation including at least the attractor space coordinates; and d) storing the representation from said target space.

Embodiments of the invention may also be described as a method of waveform comparison. This method represents a first waveform as a first series of discrete points with each point having a value. A first waveform sequence source multiset is produced wherein the multiset is at least a portion of the first series of discrete points and a plurality of subsets of the portion of the first series of discrete points. Each subset has a plurality of the discrete points as waveform sequence elements. One maps, through an iterative and contractive process, the first waveform sequence source multiset, into an attractor behavior space having at least two distinct behaviors with each behavior assigned a distinct symbol. The mapping results in a first token string consisting of a series of the symbols, corresponding to the first waveform sequence source multisets. The method further entails representing at least a second waveform as a second series of discrete points with each point having a value. A second waveform sequence source multiset is formed with the multiset defined with respect to at least a portion of the second series of discrete points and a plurality of subsets of the portion of the second series of discrete points. Each subset has a plurality of the discrete points as waveform sequence elements. One also maps the second waveform sequence source multiset through the iterative and contractive process, into the attractor behavior space. This mapping results in a second token string consisting of a series of the symbols, corresponding to the second waveform sequence source multisets. The method also entails comparing the first token string and with the second token string to determine a match among the first and second waveform sequence source multisets. Generally, the method may used to compare a large number of waveforms with one another or to compare a large number of waveforms to waveform reference patterns previously mapped through the attractor process to obtain their corresponding token strings.

Embodiments of the invention may also be characterized as a method of waveform comparison which entails representing a first waveform as a first series of discrete points; mapping, the first waveform through an iterative and contractive process, to obtain a first token based on the results of the iterative and contractive process; representing a second waveform as a second series of discrete points; mapping, the second waveform through the iterative and contractive process, to obtain a second token based on the results of the iterative and contractive process; and comparing the first token and with the second token to determine a match among said first and second waveforms. The first and second tokens each may contain one or a plurality of symbols.

Embodiments of the invention have application in vibration detection and control, voice recognition, modal analysis using FFT's, (applicable to anything that has a rotating axis such as airplanes, cars, balancing tires etc) analytic instruments, telecommunications, computer science, radio, various types of scientific inquiries, and any application in which Fourier transformations or analysis is employed or in any application where waveform analysis and comparisons are employed. The invention may be used in comparing any two waveforms and is very useful when there are a large number of waveforms to be compared with one or more reference waveforms.

### BRIEF DESCRIPTION OF THE DRAWINGS

FIGS. 1A and 1B (collectively FIG. 1) are flowcharts showing the operation of the Numgram process used to form token strings in accordance with one embodiment of an attractor process;

FIG. 2A is a block diagram showing the relationship of the various spaces in the attractor process;

FIG. 2B is a block diagram illustrating an attractor process archetype though the various spaces and processes illustrated in FIG. 2A;

FIG. 3 is a flowchart of an embodiment of the invention for the characterization of set identities using an attractor;

FIG. 4 is a flowchart of an embodiment of the invention for recognizing the identity of a family of permutations of a set in a space of sets containing combinations of set elements and permutations of those combinations of set element;

FIG. 5 is a flowchart of an embodiment of the invention for recognizing a unique set in a space of sets containing combinations of set elements or permutations of set elements;

FIGS. 6A and 6B (collectively FIG. 6) are flowcharts showing a method for hierarchical pattern recognition using an attractor based characterization of feature sets.

FIG. 7 is a waveform segment of an exemplary waveform pattern used in explaining various embodiments of the invention;

FIG. 8 is a waveform showing how the qualitative properties of a waveform can be understood in relation to the critical point or gradient zero points of the waveform;

FIGS. 9A and 9B show distorted waveforms of FIG. 7;

FIG. 9C shows an exemplary waveform;

FIG. 9D shows a distorted waveform of FIG. 9C;

FIGS. 9E-9G show high resolution examples of a sawtooth, sign and square wave respectively for use in explaining resolution characteristics associated with embodiments of the invention;

FIG. 10 shows a table setting forth an exemplary alphabet used in describing waveforms;

FIG. 11 shows the waveform of FIG. 7 after a normalization process;

FIGS. 12A and 12B (collectively FIG. 12), shows the waveform of FIG. 7 after a first level of resolution analysis in accordance with a first syntactical scheme;

FIGS. 13A and 13B (collectively FIG. 13), shows the waveform of FIG. 7 after a second level of resolution analysis in accordance with a first syntactical scheme;

FIGS. 14A and 14B (collectively FIG. 14), shows the waveform of FIG. 7 after a third level of resolution analysis in accordance with a first syntactical scheme;

FIGS. 15A and 15B (collectively FIG. 15), shows the waveform of FIG. 7 after a fourth level of resolution analysis in accordance with a first syntactical scheme;

FIGS. 16A and 16B (collectively FIG. 16), shows the waveform of FIG. 7 after a fifth level of resolution analysis in accordance with a first syntactical scheme;

FIGS. 17 and 18 show a contraction and expansion of the waveform of FIG. 7 to illustrate the differing shapes associated therewith in connection with slope resolution;

FIGS. 19-21 illustrate the waveform of FIG. 7 with a degenerate or ambiguous maxima and minima;

FIGS. 22A and 22B (collectively FIG. 22), shows the waveform of FIG. 7 after a second level of resolution analysis in accordance with a second syntactical scheme;

FIGS. 23A and 23B (collectively FIG. 23), shows the waveform of FIG. 7 after a third level of resolution analysis in accordance with a second syntactical scheme;

FIGS. 24A and 24B (collectively FIG. 24), shows the waveform of FIG. 7 after a fourth level of resolution analysis in accordance with a second syntactical scheme;

FIGS. 25A and 25B (collectively FIG. 25), shows the waveform of FIG. 7 after a fifth level of resolution analysis in accordance with a second syntactical scheme;

FIG. 26 shows an exploded view of the digitization of a waveform;

FIG. 27 shows a scatter diagram or a frequency distribution diagram;

FIG. 28 shows the results of applying a simple alphabet scheme to the scatter diagram of FIG. 27;

FIG. 29 is a tree diagram equivalent to a statement of the waveform of FIG. 7;

FIGS. 30A and 30B (collectively FIG. 30) show the separatrix and control manifold space for a cusp or A₃ catastrophe;

FIGS. 31A and 31B (collectively FIG. 31) show and end view and a three dimensional view respectively of the separatrix for an A₄ catastrophe;

FIG. 32 shows an address representation diagram in accordance with the alphabet assignments to the waveform of FIG. 7;

FIGS. 33-37 show another example of a waveform description of the waveform of FIG. 7 based on a bandpass syntax and analyzed at different levels of resolution;

FIG. 38 shows a block diagram of a hardware implementation of an embodiment of the invention; and

FIG. 39 shows a flowchart of an operation of the computer of FIG. 38 in accordance with an embodiment of the invention.

### DETAILED DESCRIPTION OF PREFERRED EMBODIMENTS

A method according to embodiments of the present invention is provided for creating software and hardware solutions for waveform, signal attribute or sequence-matching problems or frequency and frequency distribution problems where:

(1) the waveforms, signal attributes or sequences to be matched are exactly identical or may have missing or extra waveform, signal attribute or sequence elements within one or both waveform, signal attribute or sequences,

(2) the waveform, signal attribute or sequences to be matched may have regions or embedded sections with full or partial waveform, signal attribute or sequence overlaps or may have missing or extra waveform, signal attribute or sequence elements within one or both waveform, signal attribute or sequences,

(3) the symbols in each waveform, signal attribute or sequence description are all or in-part dissimilar sets, (4) the symbols composing the waveform, signal attribute or sequence have no meta-meaning allowing the use of a priori statistical or other pattern knowledge to identify the significance other than the two waveforms, signal attributes or sequences themselves,

(5) unknown sequences are being reconstructed from waveform, signal attribute or sequence fragments,

(6) the combinatorial explosion in waveform, signal attribute or sequence pattern matching, relational searching or heuristic evaluation processes would otherwise require very fast and expensive computational systems, very large memory capacities, large and complex storage hardware configurations, very slow software response times, or restriction of application of conventional algorithms to problems of limited complexity, or

(7) the waveforms, signal attributes or sequences are random patterns generated by different random processes and the goal is to segment, match and organize the waveforms, signal attributes or sequences by the random processes which generated them.

The method according to embodiments of the present invention uses attractor-based processes to extract identity tokens indicating the content and order of frequencies, frequency distributions, waveforms, signal attributes or sequences or harmonics and sub-harmonics of frequencies or frequency distributions, or sub-waveforms, signal sub-attributes or subsequence symbols. These attractor processes map the frequency, frequency distribution, waveform, signal attribute or sequence from its original representation space (ORS), also termed a “source space” into a hierarchical multidimensional attractor space (HMAS). The HMAS can be configured to represent (1) embedded patterns (2) equivalent frequency, frequency distribution, waveform, signal attribute or symbol distributions within two or more frequencies, frequency distributions, waveforms, signal attributes or sequences or (3) exact frequency, frequency distribution, waveform, signal attribute or sequence matching.

Various types of waveform, signal attribute or sequence analysis operations can be performed by computational devices utilizing attractor tokens. Examples of such types of waveform, signal attribute or sequence analysis operations include:
(1) detection and recognition of waveform, signal attribute or sequence patterns;
(2) comparison of whole waveform, signal attribute or sequence or embedded sub-waveform, signal sub-attribute or subsequence pattern relationships in symbol sequences;
(3) relationship of waveform, signal attribute or sequence pattern structures between groups of sequence patterns represented by symbols; and
(4) detection and recognition of structurally similar sequence patterns or pattern relationship structures composed of completely or partially disjoint symbol sets.

The symbol sequences and/or patterns can be representations of:
(1) sequences and/or patterns of events in a process;
(2) sequences and/or patterns of events in time;
(3) sequences and/or patterns of statements, operations, data types or sets of any combination thereof in computer languages forming a program or a meta-language;
(4) sequences and/or patterns of characters and Boolean operations or sets of any combination thereof, forming an executable or object code;
(5) sequences and/or patterns of nodes forming a network of linked notes forming astrophysical, geographic or geometric constructions or abstract structures such as graphs, and any representations of such constructions or structures;
(6) sequences and/or patterns of nodes forming a pathway in the network of linked nodes forming astrophysical, geographic or geometric constructions or abstract structures such as graphs, and any representations of such constructions or structures;
(7) sequences and/or patterns of physical states in materials, machines, or any physical system in general;
(8) sequences and/or patterns of graphics entities and the logical operators forming a graphics pattern;
(9) sequences and/or patterns of coefficients of binary polynomials and other types of mathematical or algebraic expressions;
(10) sequences and/or patterns of geometric building blocks and logical operators forming a geometric construction or abstract structure;
(11) sequences and/or patterns of words and word relationships forming a dictionary, a thesaurus, or a concept graph;
(12) sequences and/or patterns of diffeomorphic regions forming an atlas, chart, model or simulation of behavioral state expressions;
(13) sequences and/or patterns of terms in mathematical expansion series such as Taylor series or hierarchical embedding sequences such as catastrophe-theory seed functions;
(14) sequences and/or patterns of transactions, transaction types or transaction evaluations;
(15) sequences and/or patterns of computational or signal processing devices or device states or sequences and/or patterns of sets of device states representing a circuit, or arrangement of devices and circuits;
(16) sequences and/or patterns of entities, entity states, locations, activities and times or sets of any combinations thereof forming operational commands, schedules, agendas, plans, strategies, tactics or games;
(17) sequences and/or patterns of symbols expressing the identity of any numerical distribution series such as Fibonacci series;
(18) sequences and/or patterns of pixel patterns in images, sequences of pixel pattern relationships, sequences and/or patterns of Boolean or other logical operators or any combinations thereof or any sets thereof;
(19) sequences and/or patterns of waveforms, random or pseudo-random patterns, waveform features, attractors, repellers or types of relationships or sets of any combinations thereof; or
(20) anything else which can be described by mapping to symbols, sets of symbols, sequences, sets of sequences and/or patterns, embeddings of sequences and/or patterns, hierarchical or otherwise, relationships between symbols, relationships between sets of symbols, relationships between sequences and/or patterns, relationships between sets of sequences and/or patterns, relationships between sequence and/or pattern embeddings, whether hierarchical or otherwise, relationships between sets of sequence and/or pattern embeddings, whether hierarchical or otherwise, or any combinations thereof in any order, context or structure.

Such problems typically involve the discovery of symbols, sets of symbols, symbol-order patterns, or sets of symbol-order patterns or any combinations thereof, or relationships between symbols, symbol-order patterns, sequences or subsequences in any combination, or involve the detection, recognition or identification of symbols within sequences.

Discovering, detecting, recognizing or identifying these symbols, patterns or sequences or relationships between them allows the analysis of:
(1) similarities or anomalies in the identity of two or more sequences;
(2) similarities or anomalies in the patterns created by symbol-order within a sequence or a group of two or more sequences;
(3) similarities or anomalies in the structure or order of the symbol-order patterns within a sequence of symbol-order patterns or a sequence with a subset of its symbol-order being composed of symbol-order patterns;
(4) similarities or anomalies in the symbol content of symbol-order patterns including the sequence position of symbols within symbol-order patterns or sequences which represent insertions or deletions of symbols in sequences or in symbol-order patterns being compared;
(5) similarities or anomalies in symbol-order pattern types;
(6) similarities or anomalies in the occurrence or re-occurrence of symbol-order patterns within a sequence or a group of sequences;
(7) similarities or anomalies in the occurrence or re-occurrence of symbol-order pattern within a sequence or a group of sequences in a hierarchy of embedded sequences, embedded symbol-order patterns or a combination thereof;
(8) assembly of a whole sequence using symbol-order patterns made of or found within fragments of the whole sequence;
(9) similarities or anomalies in distances:
   a. between occurrences or re-occurrences of a symbol;
   b. between occurrences or re-occurrences of sets of symbols;
   c. between occurrences or re-occurrences of sets of different symbols;
   d. between occurrences or re-occurrences of sets of different symbol sets;
   e. between occurrences or re-occurrences of a symbol-order pattern;
   f. between occurrences or re-occurrences of sets of symbol-order patterns;
   g. between occurrences or re-occurrences of sets of different symbol-order patterns;
   h. between occurrences or re-occurrences of sets of different symbol-order pattern sets;
   i. between occurrences or re-occurrences of sequences having different symbol mappings; or
   j. between occurrences or re-occurrences of hierarchical embeddings of symbols, sets of symbols, symbol-order patterns, sets of symbol-order patterns, sequences or embeddings of the previous within hierarchical sequences or within a hierarchical sequence space;
(10) similarities or anomalies in any form of distance distribution, hierarchical embedding, embedding of embedding, distribution of distributions, or embeddings of the distances;
(11) indexing, classification or ranking schemes for symbols, sets of symbols, symbol-order patterns, sequence fragments or whole sequences by symbol content, symbol-order pattern, patterns of symbol-order patterns, distance distributions of symbols, symbol-order patterns or groups of symbol-order patterns or sequences by the similarity or difference of their features; or
   (12) prediction of the occurrence or reoccurrence of:
      a. a symbol, a set of symbols;
      b. sets of symbol sets;
      c. a symbol-order pattern;
      d. sets of symbol-order patterns;
      e. a sequence;
      f. sets of sequences;
      g. a distance distribution;
      h. sets of distance distributions;
      i. a hierarchical embedding;
      j. sets of hierarchical embeddings; or
      k. any combinations of items a-j.

The mapping process results in each sequence or set element of the representation space being drawn to an attractor in the HMAS. Each attractor within the HMAS forms a unique token for a group of sequences with no overlap between the sequence groups represented by different attractors. The size of the sequence groups represented by a given attractor can be reduced from approximately half of all possible sequences to a much smaller subset of possible sequences.

The mapping process is repeated for a given sequence so that tokens are created for the whole sequence and a series of subsequences created by repeatedly removing a symbol from the one end of sequence and then repeating the process from the other end. The resulting string of tokens represents the exact identity of the whole sequence and all its subsequences ordered from each end. A token to spatial-coordinate mapping scheme is used to create a series of coordinates in a hierarchy of embedded pattern spaces or sub-spaces. Each pattern sub-space is a pattern space similar to a Hausdorf space.

When the attractor tokens are mapped into a Hausdorf or other similar pattern space, the tokens cause sequence and/or pattern-similarity characteristics to be compared by evaluating the spatial vectors. These similarity characteristics may also be between pattern, sub-pattern or sequence of sub-patterns. For brevity whenever the term pattern is used, it is intended to include not only a pattern or sequence, but also sub-pattern or sequence of sub-patterns. When the attractor tokens are mapped into a numerical space, pattern-similarity (i.e., similarity in the pattern, sub-pattern or sequence of sub-patterns) characteristics are compared by evaluating the numerical distance of the coordinate values.

When two patterns are mapped into a hierarchical set-theoretic space whose coordinates in each layer of the hierarchy are mapped to combinations of attractor tokens of a given pattern-length, the pattern-similarity characteristics of the two patterns are compared by evaluating the arithmetic distance between tokens of each layer coordinate representing the two patterns. For this type of set-theoretical space, a method for ordering the token coordinates is provided such that the distance between the tokens indicates pattern similarity and reveals the exact structure of whole pattern or subpattern matches between patterns or groups of patterns.

Attractors have the possibility of being used as spatial identities of repeating mathematical processes which cause random walks or pathways through a modeling space or iterative process steps applied to random values to converge on a fixed and unique end point or fixed and unique set of endpoints (the attractor) as the result of each process iteration. Because of the convergence, attractor processes are typically characterized as entropic and efficient. They are inherently insensitive to combinatorial explosion.

In an embodiment, the method uses attractor processes to map an unknown symbol pattern to an attractor whose identity forms a unique token describing a unique partition of all possible patterns in a pattern space. These attractor processes map the pattern from its original sequence representation space (OSRS) into a hierarchical multidimensional attractor space (HMAS). The HMAS can be configured to represent equivalent symbol distributions within two symbol patterns or perform exact symbol pattern matching.

The mapping process results in each pattern being drawn to an attractor in the HMAS. Each attractor within the HMAS forms a unique token for a group of patterns with no overlap between the pattern groups represented by different attractors. The size of the pattern groups represented by a given attractor can be reduced from approximately half of all possible patterns to a much smaller subset of possible patterns.

The mapping process is repeated for a given pattern so that tokens are created for the whole pattern and each subpattern created by removing a symbol from one end of the pattern. The resulting string of tokens represents the exact identity of the whole pattern and all its subpatterns. A token to spatial-coordinate mapping scheme methodology is provided for creating token coordinates providing solutions to one or more of the pattern-matching problems above.

Attractors are also considered repetitive mathematical processes which cause random patterns of movements or pathways through a modeling space or repeating process steps applied to random values to converge on a fixed and unique end point or fixed and unique set of endpoints as the result of each movement or process repetition. Because of the convergence, attractor processes are characterized as efficient and are inherently insensitive to combinatorial explosion problems.

Computational devices use symbols to represent things, processes and relationships. All computational models are composed of patterns of statements, descriptions, instructions and punctuation characters. To operate in a computer, these statements, descriptions, instructions and punctuation characters are translated into unique patterns of binary bit patterns or symbols that are interpreted and operated on by the processing unit of the computational device. A set of all symbols defined for interpretation is called the Symbol Set. A symbol-pattern is an ordered set of symbols in which each symbol is a member of the Symbol Set.

In an embodiment, the method uses an attractor process applied to a symbol-pattern, causing it to converge to a single coordinate or single repeating pattern of coordinates in a coordinate space. Each coordinate or pattern of coordinates is the unique end-point of an attractor process for a unique group of symbol-patterns. The collection of the all the group members of all the attractor end-points is exactly the collection of all possible symbol-patterns of that pattern length with no repeats or exclusions.

The attractor end-point coordinates or coordinate patterns are given unique labels that are the group identity for all symbol-patterns whose attractor processes cause them to arrive at that end-point coordinate or pattern of coordinates. As a result, all the possible symbol-patterns of a given length are divided into groups by their end-point coordinates or coordinate patterns.

By repeating this process for each symbol-subpattern created by deleting one symbol from the end of the symbol-pattern, each symbol-subpattern is given a group identity until the last symbol of the symbol-pattern is reached which is given its own symbol as its label.

The set of all these attractor end-point coordinates or coordinate set labels is called the Label Set. The labels within the Label Set are expressed in pattern from the label for the end symbol to the label for the group containing the whole symbol-pattern. The Label Set forms a unique identifier for the symbol-pattern and its set of subset symbol-patterns ordered from the end symbol. The target space is a representation space whose coordinates are the labels of the label set. The coordinates of the attractor space are mapped to the coordinates of the target space such that an attractor result to a coordinate in the attractor space causes a return from the target space of the representation for that attractor result. The target space can be configured to return a single label or a series o labels including punctuation for a series of attractor results. Whenever a label set is used, a target space will be created for the mapping of the representation from the attractor space.

In a set-theoretic space, the coordinate axes are composed of labels. The space between labels is empty and has no meaning. Coordinates in the space are composed of a set of labels with one label for each dimension.

If a set-theoretic space:
(1) has as many axes as the number of symbols in a symbol-pattern, and
(2) the axes of that space are ordered from the whole symbol-pattern to the last symbol, and
(3) the labels of each symbol-pattern and symbol-subpattern axis are the labels of the attractor end-point coordinates or coordinate patterns in that space, and
(4) the end symbol axis has as its labels the Symbol Set, and
(5) the coordinates of that space are the Label Sets of all the symbol-patterns of the same length composed of symbols from the Symbol Set,

then the space is called the Label Space or the attractor space representation.

A set-theoretic space composed of a hierarchy of Label Spaces arranged so they form a classification tree with branches and leaves representing symbol-pattern groups of similar composition and order is called the Classification Space or the analytic space.

The Classification Space allows the sorting of Label Sets into groups of predetermined content and content order. By sorting the Label Sets of symbol-patterns through the branch structure to leaves, each leaf collects a set of symbol-patterns of the same symbol content and symbol order structure. All symbol-patterns sharing the same branch structure have the same symbol content and order to the point where they diverge into different branches or leaves.

The Symbol Set, the Label Set, the Label Space, and the Classification Space are the building blocks of solution applications. Their combination and configuration allows the development of software and hardware solutions for problems represented by symbol-patterns which were heretofore intractable because of combinatorial explosion. Subsequently, the solution configuration can be run on small platforms at high speed and can be easily transported to programmable logic devices and application specific integrated circuits (ASICs). Furthermore, such pattern-matching methods using attractor tokens according to embodiments of the present invention are applicable to various fields including, for example, matching of deoxyribonucleic acid (DNA) patterns or other biotechnology applications, and waveform analysis and matching problems of all kinds.

The basic idea behind the attractor process is that some initial random behavior is mapped to a predictable outcome behavior. An analogy may be made to a rubber sheet onto which one placed a steel ball which caused the sheet to deform downward. The placement of the steel ball on the rubber sheet deforms the rubber sheet and sets up the attractor process. A marble that is subsequently tossed onto the rubber sheet will move around and around until it reaches the ball. The attractor is the process interaction between the marble and the deformed rubber sheet.

The primary characteristics of attractors are as follows:
(1) they cause random inputs to be mapped to predictable (i.e., fixed) outputs;
(2) variation of the specific parameters for a given attractor may be used to modify the number and/or type of predictable outputs; and
(3) the output behaviors of attractors may be configured so they represent a map to specific groups of input patterns and/or behaviors, i.e., mapped to the type and quality of the inputs.

By “predictable” used above, it is not intended that one knows in advance the type of behavior but rather that the behavior, once observed, will be repeatable and thus continue to be observed for the chosen set of specific parameters.

The input behavior is merely as set of attributes which is variable and which defines the current state of the object under consideration. In the marble example, the input behavior would specify the initial position and velocity of the marble when it is released onto the deformed rubber sheet.

In the first characteristic where random inputs to be mapped to predictable outputs, these mappings are done by an iterative process and this process converges to a fixed behavior.

In the third characteristic, the parameters of the attractor may be adjusted, to tune the mapping of the random inputs and the outputs such that, while the inputs are still random, the input behaviors within a specified range will all map to output one behavior and the input behavior within a second range will all map to another, different output behavior, and the input behavior within a third range will all map to yet another, still different output behavior. Thus, the output behavior then becomes an identity or membership qualifier for a group of input behaviors. When this happens, the attractor turns into a classifier.

The primary characteristics of a good classifier are as follows:
(1) every input is handled uniquely and predictably;
(2) there must be at least one other input which is also handled according to a) but is mapped to a different behavior; and
(3) for efficient classifiers, classifiers must do at least as well as least squares on random maps.

The concept of least squares is related to random walk problems. One may illustrate the procedure by assuming one want to find a randomly placed point in a square 1 meter on each side. First divide the square into half by drawing a horizontal line through the middle and ask if the point is on above or below the line. One it is established that the point is say above the line, one then divides the upper half into half by drawing a vertical line through the upper half and ask if the point is to the right or left. The process continues until one confines the point within an area of arbitrarily small size, thus solving the problem of finding the point within a certain degree of accuracy. When the prior knowledge about the existence of the input point is null, then the most efficient classifier is one that operates on this least squares principle.

The principles of embodiments of the invention may be understood in relation to an example of DNA pattern matching used to determine overlaps in nucleotide patterns. The DNA fragment patterns are only used as an example and are not meant to be limiting. The principles of the invention as elucidated by the DNA examples below are generally applicable to any random or non-random pattern. The overall objective is to classify different inputs into different groups using different behaviors as these inputs are mapped via an attractor process. The essence of the procedure is to classify patterns by studying the frequency of occurrences within the patterns.

As an example of the attractor process, the following two fragments will be examined.

Fragment 1:
GGATACGTCGTATAACGTA
Fragment 2
TATAACGTATTAGACACGG

The procedure for implementing embodiment of the invention extracts patterns from the input fragments so that the input fragments can be uniquely mapped to certain types of behavior.

The procedure is first illustrated with Fragment 1.

Fragment 1:
GGATACGTCGTATAACGTA

One first takes the entire fragment considering each nucleotide separately and counts the number of distinct nucleotide symbols. To facilitate and standardize the counting process for implementation on a data processor, one may assigns a digit value to each nucleotide using, for example, the mapping shown in Table 1.

TABLE 1

| | Mapped |
|---|---|
| Symbol | symbol |
| A | 0 |
| C | 1 |
| G | 2 |
| T | 3 |

Using the above mapping one can map the input sequence or pattern into the following string 1:
[2,2,0,3,0,1,2,3,1,2,3,0,3,0,0,1,2,3,0] String 1

One now chooses a base in which to perform the succeeding steps of the procedure. While any base (greater than 5) may be used, the below example proceeds with base 7 as a representative example.

One first converts the string 1 into a base 7 representation which can be labeled String 2. Since none of the entries of string 1 are greater than 6, the base 7 representation is the same sequence as string 1, so that string 1=string 2 or
[2,2,0,3,0,1,2,3,1,2,3,0,3,0,0,1,2,3,0] String 2

Table 2 below, called a Numgram, is used to implement another part of the process. The first row of the Numgram list the integers specifying the base. For base, 7, integers 0, 1, . . . 6 are used to label the separate columns.

For row 2, one counts the number of 0's, 1's, 2's and 3's in string 2 and enters these count values in the corresponding column of row 2 of the Numgram.

For row 3, one counts the number of 0's, 1's, . . . 6's in row 2 and list these numbers in the corresponding column of row 3.

One repeats the counting and listing process as shown in Table 2. The counting and listing process is iterative and is seen to converge at row 4. Thus, continuing the counting and listing produces the same sequence as first appearing in row 4. Note that rows 5, 6 and all additional rows (not shown) are the same as row 4.

TABLE 2

| | | | | | | | Row |
|---|---|---|---|---|---|---|---|
| | | | | | | | Number |
| 0 | 1 | 2 | 3 | 4 | 5 | 6 | 1 |
| 5 | 6 | 5 | 3 | 0 | 0 | 0 | 2 |
| 3 | 0 | 0 | 1 | 0 | 2 | 1 | 3 |
| 3 | 2 | 1 | 1 | 0 | 0 | 0 | 4 |
| 3 | 2 | 1 | 1 | 0 | 0 | 0 | 5 |
| 3 | 2 | 1 | 1 | 0 | 0 | 0 | 6 |

The sequence is seen to converge to [3,2,1,1,0,0,0].

The Numgram (attractor process) converges to a fixed point “behavior” in an attractor space. This fixed point has a repeating cycle of one (a single step). One may represent this behavior in the attractor space by assigning a value, which is really a label, of 1 to this single step cycle. The label is expressed in an attractor space representation (also referred to above as the Label Space). In other cases, as seen below, the Numgram behavior is observed to repeat in a cycle of more than one step and in such case, one represents such behavior by assigning a value or label of 0 in the attractor space representation to distinguish such behavior from the one cycle behavior. The multiple cycle behavior is still termed a fixed point behavior meaning that the Numgram attractor process “converges” to a fixed type (number of cycles) of behavior in the attractor space. One may of course interchange the zero and one assignments as long as one is consistent. One may term the one cycle behavior as a converging behavior and the multiple cycle behavior as oscillating. The important point, however, is that there are two distinct types of behavior and that any given sequence will always (i.e., repeatedly) exhibit the same behavior and thus be mapped from a source space (the Fragment input pattern) to the attractor space (the fixed point behavior) in a repeatable (i.e., predictable) manner.

Now one groups the nucleotides in pairs beginning at the left hand side of the fragment and counts the number of distinct pairs. Again, this counting may be facilitated by assigning a number 0, 1, 2, . . . 15 to each distinct pair and then counting the number of 0's, 1's, 2's, . . . 15's. The following Table 3 is useful for the conversion:

TABLE 3

| | Mapped |
|---|---|
| symbol | symbol |
| AA | 0 |
| AC | 1 |
| AG | 2 |
| AT | 3 |
| CA | 4 |
| CC | 5 |
| CG | 6 |
| CT | 7 |
| GA | 8 |
| GC | 9 |
| GG | 10 |
| GT | 11 |
| TA | 12 |
| TC | 13 |
| TG | 14 |
| TT | 15 |

For example, Fragment 1 is grouped into pairs as follows:

GG AT AC GT CG TA TA AC GT A

where the last nucleotide has no matching pair, it is simply dropped.

From Table 3, one may assign a number to each of the pairs as follows:

| GG AT AC GT CG TA TA AC GT | |
|---|---|
| 10 3 1 11 6 12 12 1 11 | String 3 |

The string 3 sequence [10, 3, 1, 1, 6, 12, 12, 1, 11] is now converted into base 7 to yield string 4:
[13, 3, 1, 14, 6, 15, 15, 1, 14] String 4

A new Numgram is produced as in Table 4 with the first row labeling the columns according to the base 7 selected.

One now simply counts the number of 0's, 1's . . . . 6's and enters this count as the second row of the Numgram. In counting string 4, it is noted, for example, that the number of one's is 7 since one counts the ones regardless of whether they are part of other digits. For example, the string [13, 3, 1] contains 2 ones. Using this approach, row 2 of the Numgram is seen to contain the string [0,7,0,2,2,2,1]. In the general case, every time a count value is larger than or equal to the base, it is converted modulo the base. Thus, the 7 in row 2 is converted into 10 (base 7) and again, the number of 0's, 1's . . . 6's are counted and listed in row 3 of the Numgram. (The intermediate step of mapping 7 into 10 is not shown). The counting step results in string [3,2,3,0,0,0,0] in row 3.

TABLE 4

| | | | | | | | Row |
|---|---|---|---|---|---|---|---|
| | | | | | | | Number |
| 0 | 1 | 2 | 3 | 4 | 5 | 6 | 1 |
| 0 | 7 | 0 | 2 | 2 | 2 | 1 | 2 |
| 3 | 2 | 3 | 0 | 0 | 0 | 0 | 3 |
| 4 | 0 | 1 | 2 | 0 | 0 | 0 | 4 |
| 4 | 1 | 1 | 0 | 1 | 0 | 0 | 5 |
| 3 | 3 | 0 | 0 | 1 | 0 | 0 | 6 |
| 4 | 1 | 0 | 2 | 0 | 0 | 0 | 7 |
| 4 | 1 | 1 | 0 | 1 | 0 | 0 | 8 |
| 3 | 3 | 0 | 0 | 1 | 0 | 0 | 6 |
| 4 | 1 | 0 | 2 | 0 | 0 | 0 | 7 |
| 4 | 1 | 1 | 0 | 1 | 0 | 0 | 8 |

This sequence has a 3-cycle behavior, repeating values beginning at row 5 with the string [4,1,1,0,1,0,0,]. As such, the Numgram is assigned a value of 0 in the attractor space representation.

Triplets

One now groups the nucleotides into triplets (or codons) and again counts the number of distinct triplets. Fragment 1 separated into triplets is as follows:

GGA TAC GTC GTA TAA CGT A

For ease of computation, one assigns a numerical value to each distinct triplet to assist in counting the sixty-four possible permutations. Any incomplete triplet groupings are ignored. The following Table 5 may be utilized.

TABLE 5

| sym- | Mapped | | Mapped | | Mapped | | Mapped |
|---|---|---|---|---|---|---|---|
| bol | symbol | symbol | symbol | Symbol | Symbol | Symbol | Symbol |
| AAA | 0 | CAA | 16 | GAA | 32 | TAA | 48 |
| AAC | 1 | CAC | 17 | GAC | 33 | TAC | 49 |
| AAG | 2 | CAG | 18 | GAG | 34 | TAG | 50 |
| AAT | 3 | CAT | 19 | GAT | 35 | TAT | 51 |
| ACA | 4 | CCA | 20 | GCA | 36 | TCA | 52 |
| ACC | 5 | CCC | 21 | GCC | 37 | TCC | 53 |
| ACG | 6 | CCG | 22 | GCG | 38 | TCG | 54 |
| ACT | 7 | CCT | 23 | GCT | 39 | TCT | 55 |
| AGA | 8 | CGA | 24 | GGA | 40 | TGA | 56 |
| AGC | 9 | CGC | 25 | GGC | 41 | TGC | 57 |
| AGG | 10 | CGG | 26 | GGG | 42 | TGG | 58 |
| AGT | 11 | CGT | 27 | GGT | 43 | TGT | 59 |
| ATA | 12 | CTA | 28 | GTA | 44 | TTA | 60 |
| ATC | 13 | CTC | 29 | GTC | 45 | TCC | 61 |
| ATG | 14 | CTG | 30 | GTG | 46 | TTG | 62 |
| ATT | 15 | CTT | 31 | GTT | 47 | TTT | 63 |

Using Table 5, Fragment 1 is seen to be represented as String 5 below:
[40, 49, 45, 44, 48, 27] String 5.

Converting this string into base 7 yields:
[55, 100, 63, 62, 66, 36] String 6.

The Numgram may now be developed as seen in Table 6 below.

TABLE 6

| | | | | | | | Row |
|---|---|---|---|---|---|---|---|
| | | | | | | | Number |
| 0 | 1 | 2 | 3 | 4 | 5 | 6 | 1 |
| 2 | 1 | 1 | 2 | 0 | 2 | 5 | 2 |
| 1 | 2 | 3 | 0 | 0 | 1 | 0 | 3 |
| 3 | 2 | 1 | 1 | 0 | 0 | 0 | 4 |
| 3 | 2 | 1 | 1 | 0 | 0 | 0 | 5 |

The above sequence, as seen to exhibit type “1” behavior.

Collecting the tokens for strings 2 (single symbol), 4 (pair symbols) and 6 (triplet symbols) gives the sequence: [101]. Fragment 1 is further mapped using the Numgram tables for each of the three symbol combinations (single, pairs and triplets) for each of a plurality of sub-fragments obtained by deleting, one symbol at a time from the left of Fragment 1. A further mapping is preformed by deleting one symbol a time from the right of Fragment 1. Table 7 below illustrates a pyramid structure illustrating this further mapping and shows the main fragment (line 0) and the resulting 18 sub-fragments (lines 1-18).

TABLE 7
Sequence 1: GGATACGTCGTATAACGTA

| | | |
|---|---|---|
| Left copy | Right copy | Line # |

| | | |
|---|---|---|
| GGATACGTCGTATAACGTA | GGATACGTCGTATAACGTA | 0 |
| GATACGTCGTATAACGTA | GGATACGTCGTATAACGT | 1 |
| ATACGTCGTATAACGTA | GGATACGTCGTATAACG | 2 |
| TACGTCGTATAACGTA | GGATACGTCGTATAAC | 3 |
| ACGTCGTATAACGTA | GGATACGTCGTATAA | 4 |
| CGTCGTATAACGTA | GGATACGTCGTATA | 5 |
| GTCGTATAACGTA | GGATACGTCGTAT | 6 |
| TCGTATAACGTA | GGATACGTCGTA | 7 |
| CGTATAACGTA | GGATACGTCGT | 8 |
| GTATAACGTA | GGATACGTCG | 9 |
| TATAACGTA | GGATACGTC | 10 |
| ATAACGTA | GGATACGT | 11 |
| TAACGTA | GGATACG | 12 |
| AACGTA | GGATAC | 13 |
| ACGTA | GGATA | 14 |
| CGTA | GGAT | 15 |
| GTA | GGA | 16 |
| TA | GG | 17 |
| A | G | 18 |

To illustrate the further mapping, one examines the first, left sub-fragment shown in line 1 which is the sub-fragment:

GATACGTCGTATAACGTA

Performing the Numgram procedure for this first sub-fragment using one symbol at a time, two symbols at a time and three symbols at a time (in a similar fashion as illustrated above for the main fragment in line 0) gives the further mapping [000].

Taking the second sub-fragment on the left hand side of the pyramid shown in line 2 and performing the Numgram procedure for each symbol separately, pairs of symbols and triplets give the mapping: [100]. Continuing with this process one may build a table of behavior values for each of the sub-fragments as shown in Table 8 below.

TABLE 8
Fragment 1; main and sub-fragment token strings for Left hand Side

| Line | Token String |
|---|---|
| 0 | 101 |
| 1 | 000 |
| 2 | 100 |
| 3 | 000 |
| 4 | 111 |
| 5 | 001 |
| 6 | 110 |
| 7 | 000 |
| 8 | 110 |
| 9 | 000 |
| 10 | 100 |
| 11 | 100 |
| 12 | 100 |
| 13 | 000 |
| 14 | 000 |
| 15 | 000 |
| 16 | 000 |
| 17 | 000 |
| 18 | 000 |

The complete token string for the 19 symbols (labeled 0-18) of Fragment 1 obtained from the left hand side of the pyramid is thus written as:

SEQ#1

G1010001000001110011100001100001001001000000000000
00000000 (0 . . . 18L)

SEQ#1 refers to Fragment 1, and (0 . . . 18L) refers to the initial source set which had 19 elements (nucleotides) and whose token string was formed, inter ala, by chopping one symbol at a time from the left of the original pattern. The label (0 . . . 18L) SEQ#1 thus uniquely identifies the source set. It will be recalled that the token string is simply a representation of the behavior of the source set interacting with the attractor process. Appending the identifying label (e.g., (0 . . . 18L) SEQ#1 to the token string maps the source set representation to an analytic space (also referred to above as the Classification Space). The analytic space is a space containing the union of the source set identification and the attractor set representation.

It will be appreciated that the subsequences as set forth in the inverted pyramids of Table 7 are assigned tokens according to the behavior resulting from the interaction of that subsequence with the attractor process. When elements are grouped one-at-a-time, the collective elements form an analytic sequence with each element of the analytic sequence being a single element from the initial fragment, namely, A, C, T or G. When the initial fragment elements (i.e., A, C, T, and G) are taken two-at-a-time, they form analytic sequence elements defined by Table 3 of which there are 16 unique elements. Thus, the original 4 distinct elements under this grouping are set forth as 16 distinct element pairs, and, under this grouping, string 1 becomes string 3. String 3 is collectively an analytic sequence where the sequence elements are given by Table 3. In a similar fashion, string 5 is collectively an analytic sequence where the sequence elements are given by Table 5 for the triplet grouping.

It is possible to perform further grouping of the original sequence elements to take them four-at-a-time, five-at-a-time, six-at-a-time and higher. Each further level of grouping may, in some applications prove useful in defining the fragment and uniquely characterizing it within an analytic space. These further groupings are especially appropriate were they have ontological meaning within the problem domain of interest. The methodology for forming these higher levels of grouping follows exactly the same procedure as set forth above for the single, pair and triplet groupings.

One may now repeat the same process by deleting one symbol from the right, essentially treating the sub-fragments of the right hand side of the pyramid. The resulting token string for the right side of the pyramid is given as:

SEQ#1

G1010011011011010001101101100100001001000000000000
00000000000 (0 . . . 18R)

The initial “G”: is used as a prefix to indicated the first letter symbol in the fragment as a further means of identifying the sequence. Similarly T, A and C may be used as a prefix where appropriate.

The resulting string of tokens represents the exact identity of the whole sequence and all its subsequences ordered from each end.

The two token strings corresponding to source sets (0 . . . 18L) SEQ#1 and (0 . . . 18R) SEQ#1 characterize Fragment 1, characterizing the behavior of single/pair/triplet groups of the nineteen symbols and their possible sub-fragments taken from the left and right.

One now needs to similarly map each of the sub-fragments. First one may chop off a symbol from the left hand side of fragment 1. Referring again to the pyramid of Table 7, the sequence to be mapped is:

GATACGTCGTATAACGTA

Treating this sub-fragment as before, one may develop the complete token strings for symbols (1 . . . 18L) using the Numgram tables as illustrated above. The nomenclature (1 . . . 18L) indicates that the starting sequence is composed of symbols 1 through 18 and that the token string is derived by chopping off one symbol from the left after each single/pair/triplet token is produced. A simplification may be used upon realizing that the sub-sequences are already present in (0 . . . 18L) and may be obtained by dropping the first three digits [101] resulting from the main Fragment single/pair/triplet mapping. Thus using (0 . . . 18L) SEQ#1 and dropping the first three digits gives:

SEQ#1

G0001000001110011100001100001001001000000000000000
00000 (1 . . . 18L)

The token strings for the right hand side of the pyramid may not be simply obtained from the prior higher level fragment and thus need to be generated using the Numgram tables as taught above.

The resulting token strings obtained by continuing to chop off a symbol from the left hand side of the pyramid (together with their token strings resulting by chopping off from the right for the same starting sequence) are as follows:

Chopping GGATACGTCGTATAACGTA from the left . . .
Initially GGATACGTCGTATAACGTA gives

(SEQ#1)

G1010001000001110011100001100001001001000000000000
00000000 (0 . . . 18L)

(SEQ#1)

G1010011011011010001101101100100001001000000000000
00000000 (0 . . . 18R)

The second line ((0 . . . 18R) (SEQ#0 . . . 1)) uses the same starting sequence of the 19 initial symbols (0 . . . 18) but chops from the right. Chopping one additional symbol from the left gives,

GATACGTCGTATAACGTA

(SEQ#1)

G0001000001110011100001100001001001000000000000000
00000 (1 . . . 18L)

(SEQ#1)

G0001001001000001101100100100000000000000000000000
00000 (1 . . . 18R)

where again, the second line ((1 . . . 18R) (SEQ#1)) uses the starting sequence of symbols (1 . . . 18) and chops successively from the right in building the token strings. One may continue to delete addition symbols from the left had side as seen below.

ATACGTCGTATAACGTA

(SEQ#1)

A1000001110011100001100001001001000000000000000000
00 (2 . . . 18L)

(SEQ#1)

A1000001100101100101000000000000000000000000000000
00 (2 . . . 18R)
TACGTCGTATAACGTA

(SEQ#1)

T000111001110000110000100100100000000000000000000
(3 . . . 18L)

(SEQ#1)

T000100001101001110010010110000000000000000000000
(3 . . . 18R)
ACGTCGTATAACGTA

(SEQ#1)

A111001110000110000100100100000000000000000000
(4 . . . 18L)

(SEQ#1)

A111011011111110010000000000000000000000000000
(4 . . . 18R)
CGTCGTATAACGTA

(SEQ#1)

C001110000110000100100100000000000000000000
(5 . . . 18L)

(SEQ#1)

C001011011000000000100000000000000000000000
(5 . . . 18R)
GTCGTATAACGTA

(SEQ#1)

G110000110000100100100000000000000000000
(6 . . . 18L)

(SEQ#1)

G110110010010110110100000000000000000000
(6 . . . 18R)
TCGTATAACGTA

(SEQ#1)

T000110000100100100000000000000000000
(7 . . . 18L)

(SEQ#1)

T000101001101000100000000000000000000
(7 . . . 18R)
CGTATAACGTA

(SEQ#1)

C110000100100100000000000000000000 (8 . . . 18L)

(SEQ#1)

C110010000100100000000000000000000 (8 . . . 18R)
GTATAACGTA

(SEQ#1)

G000100100100000000000000000000 (9 . . . 18L)

(SEQ#1)

G000100100100000000000000000000 (9 . . . 18R)
TATAACGTA

(SEQ#1)

T100100100000000000000000000 (10 . . . 18L)

(SEQ#1)

T100000100000000000000000000 (10 . . . 18R)
ATAACGTA

(SEQ#1)

A100100000000000000000000 (11 . . . 18L)

(SEQ#1)

A100100000000000000000000 (11 . . . 18R)
TAACGTA

(SEQ#1)

T100000000000000000000 (12 . . . 18L)

(SEQ#1)

T100000000000000000000 (12 . . . 18R)

Further chopping of the symbols will only produce zeros so that the Numgram process may be stopped at symbols sequence (12 . . . 18), i.e., the 13^{th} through 19^{th} symbol.

One may now go back to the main Fragment 1 and form “right” side sub-fragments taken from the right hand side of the pyramid. Successive left and right symbol chopping using the right hand side of the pyramid gives token strings of the symbol sequences, (0 . . . 17L); (0 . . . 17R); (0 . . . 16L); (0 . . . 16R) . . . etc. It is noted that some simplification may again take place in that (0 . . . 17R) may be obtained from the already computed value of (0 . . . 18R) by dropping the initial 3 digits. Further, (0 . . . 16R) may be obtained from (0 . . . 17R) by dropping the initial 3 digits from (0 . . . 17R) etc.

The resulting token strings obtained by continuing to chop off a symbol from the right hand side of the pyramid (together with their token strings for the same level left hand side) are as follows:

Chopping GGATACGTCGTATAACGTA from the right . . .
GGATACGTCGTATAACGT

(SEQ#1)

G0011000001000110111101010101000001000000000000000
00000 (0 . . . 17L)

(SEQ#1)

G0011011011010001101101100100001001000000000000000
00000 (0 . . . 17R)
GGATACGTCGTATAACG

(SEQ#1)

G1011001100010110110100010001001000000000000000000
00 (0 . . . 16L)

(SEQ#1)

G1011011010001101101100100001001000000000000000000
00 (0 . . . 16R)
GGATACGTCGTATAAC

(SEQ#1)

G101100010101111000010101100100000000000000000000
(0 . . . 15L)

(SEQ#1)

G101101000110110110010000100100000000000000000000
(0 . . . 15R)
GGATACGTCGTATAA

(SEQ#1)

G101000110001110000110000100000000000000000000
(0 . . . 14L)

(SEQ#1)

G101000110110110010000100100000000000000000000
(0 . . . 14R)
GGATACGTCGTATA

(SEQ#1)

G000110010110010000110100000000000000000000
(0 . . . 13L)

(SEQ#1)

G000110110110010000100100000000000000000000
(0 . . . 13R)
GGATACGTCGTAT

(SEQ#1)

G110110100010000100100000000000000000000
(0 . . . 12L)

(SEQ#1)

G110110110010000100100000000000000000000
(0 . . . 12R)
GGATACGTCGTA

(SEQ#1)

G110010000010000000000000000000000000
(0 . . . 11L)

(SEQ#1)

G110110010000100100000000000000000000
(0 . . . 11R)
GGATACGTCGT

(SEQ#1)

G110010000110000000000000000000000 (0 . . . 10L)

(SEQ#1)

G110010000100100000000000000000000 (0 . . . 10R)
GGATACGTCG

(SEQ#1)

G010000000000000000000000000000 (0 . . . 9L)

(SEQ#1)

G010000100100000000000000000000 (0 . . . 9R)
GGATACGTC

(SEQ#1)

G000000000000000000000000000 (0 . . . 8L)

(SEQ#1)

G000100100000000000000000000 (0 . . . 8R)
GGATACGT

(SEQ#1)

G100000000000000000000000 (0 . . . 7L)

(SEQ#1)

G100100000000000000000000 (0 . . . 7R)
GGATACG

(SEQ#1)

G100000000000000000000 (0 . . . 6L)

(SEQ#1)

G100000000000000000000 (0 . . . 6R)

A similar procedure may be used to obtain the token strings for Fragment 2 (sequence 2). The pyramid for use in computing the right and left sub-fragments is as follows:

Sequence 2: TATAACGTATTAGACACGG

| | | |
|---|---|---|
| Left Copy | Right Copy | Line # |

| | | |
|---|---|---|
| TATAACGTATTAGACACGG | TATAACGTATTAGACACGG | 0 |
| ATAACGTATTAGACACGG | TATAACGTATTAGACACG | 1 |
| TAACGTATTAGACACGG | TATAACGTATTAGACAC | 2 |
| AACGTATTAGACACGG | TATAACGTATTAGACA | 3 |
| ACGTATTAGACACGG | TATAACGTATTAGAC | 4 |
| CGTATTAGACACGG | TATAACGTATTAGA | 5 |
| GTATTAGACACGG | TATAACGTATTAG | 6 |
| TATTAGACACGG | TATAACGTATTA | 7 |
| ATTAGACACGG | TATAACGTATT | 8 |
| TTAGACACGG | TATAACGTAT | 9 |
| TAGACACGG | TATAACGTA | 10 |
| AGACACGG | TATAACGT | 11 |
| GACACGG | TATAACG | 12 |
| ACACGG | TATAAC | 13 |
| CACGG | TATAA | 14 |
| ACGG | TATA | 15 |
| CGG | TAT | 16 |
| GG | TA | 17 |
| G | T | 18 |

The results for Fragment 2 are as follows:

Chopping TATAACGTATTAGACACGG from the left . . .
TATAACGTATTAGACACGG

(SEQ#2)

T0011101001001100111101101000001000000000000000000
00000000 (0 . . . 18L)

(SEQ#2)

T0011010111111010011110111100101000001000000000000
00000000 (0 . . . 18R)
ATAACGTATTAGACACGG

(SEQ#2)

A1101001001100111101101000001000000000000000000000
00000 (1 . . . 18L)

(SEQ#2)

A1101000001001010010011000001001001000000000000000
00000 (1 . . . 18R)
TAACGTATTAGACACGG

(SEQ#2)

T1001001100111101101000001000000000000000000000000
00 (2 . . . 18L)

(SEQ#2)

T1001000101101100101100101000001000000000000000000
00 (2 . . . 18R)
AACGTATTAGACACGG

(SEQ#2)

A100110011110110100000100000000000000000000000000
(3 . . . 18L)

(SEQ#2)

A100010111111111000000100000100000000000000000000
(3 . . . 18R)
ACGTATTAGACACGG

(SEQ#2)

A110011110110100000100000000000000000000000000
(4 . . . 18L)

(SEQ#2)

A110011111111101001101000100000000000000000000
(4 . . . 18R)
CGTATTAGACACGG

(SEQ#2)

C011110110100000100000000000000000000000000
(5 . . . 18L)

(SEQ#2)

C011011111110010100100100000000000000000000
(5 . . . 18R)
GTATTAGACACGG

(SEQ#2)

G110110100000100000000000000000000000000
(6 . . . 18L)

(SEQ#2)

G110110110010100000000000000000000000000
(6 . . . 18R)
TATTAGACACGG

(SEQ#2)

T110100000100000000000000000000000000
(7 . . . 18L)

(SEQ#2)

T110101001101000000000000000000000000
(7 . . . 18R)
ATTAGACACGG

(SEQ#2)

A100000100000000000000000000000000 (8 . . . 18L)

(SEQ#2)

A100000100100100000000000000000000 (8 . . . 18R)
TTAGACACGG

(SEQ#2)

T000100000000000000000000000000 (9 . . . 18L)

(SEQ#2)

T000000100100000000000000000000 (9 . . . 18R)
TAGACACGG

(SEQ#2)

T100000000000000000000000000 (10 . . . 18L)

(SEQ#2)

T100100100000000000000000000 (10 . . . 18R)
AGACACGG

(SEQ#2)

A000000000000000000000000 (11 . . . 18L)

(SEQ#2)

A000000000000000000000000 (11 . . . 18R)
GACACGG

(SEQ#2)

G000000000000000000000 (12 . . . 18L)

(SEQ#2)

G000000000000000000000 (12 . . . 18R)
Chopping TATAACGTATTAGACACGG from the right . . .
TATAACGTATTAGACACG

(SEQ#2)

T1011001000100110111101010000001000000000000000000
00000 (0 . . . 17L)

(SEQ#2)

T1010111111010011110111100101000001000000000000000
00000 (0 . . . 17R)
TATAACGTATTAGACAC

(SEQ#2)

T0110000101111111111100011001001000000000000000000
00 (0 . . . 16L)

(SEQ#2)

T0111111010011110111100101000001000000000000000000
00 (0 . . . 16R)
TATAACGTATTAGACA

(SEQ#2)

T111100110111111110010101100100000000000000000000
(0 . . . 15L)

(SEQ#2)

T11110100111101111O010100000100000000000000000000
(0 . . . 15R)
TATAACGTATTAGAC

(SEQ#2)

T101101110111101010100000100000000000000000000
(0 . . . 14L)

(SEQ#2)

T101001111011110010100000100000000000000000000
(0 . . . 14R)
TATAACGTATTAGA

(SEQ#2)

T001001010000001100000000000000000000000000
(0 . . . 13L)

(SEQ#2)

T001111011110010100000100000000000000000000
(0 . . . 13R)
TATAACGTATTAG

(SEQ#2)

T111001110000101100000000000000000000000
(0 . . . 12L)

(SEQ#2)

T111011110010100000100000000000000000000
(0 . . . 12R)
TATAACGTATTA

(SEQ#2)

T011100010100000100000000000000000000
(0 . . . 11L)

(SEQ#2)

T011110010100000100000000000000000000
(0 . . . 11R)
TATAACGTATT

(SEQ#2)

T110000100000100000000000000000000 (0 . . . 10L)

(SEQ#2)

T110010100000100000000000000000000 (0 . . . 10R)
TATAACGTAT

(SEQ#2)

T010100000100000000000000000000 (0 . . . 9L)

(SEQ#2)

T010100000100000000000000000000 (0 . . . 9R)
TATAACGTA

(SEQ#2)

T100100100000000000000000000 (0 . . . 8L)

(SEQ#2)

T100000100000000000000000000 (0 . . . 8R)
TATAACGT

(SEQ#2)

T000100000000000000000000 (0 . . . 7L)

(SEQ#2)

T000100000000000000000000 (0 . . . 7R)
TATAACG

(SEQ#2)

T100000000000000000000 (0 . . . 6L)

(SEQ#2)

T100000000000000000000 (0 . . . 6R)

Since the fragments (and their sub-fragments) are uniquely mapped to the token strings, fragment matching is simply obtained by sorting the token strings in ascending order for like pre-fixed letters. Matching fragment and/or sub-fragments will sort next to each other as they will have identical values for their token strings.

Sorting gives the following results:

Sorted bit strings:

(SEQ#2)

A000000000000000000000000 (11 . . . 18R)

(SEQ#2)

A000000000000000000000000 (11 . . . 18L)

(SEQ#2)

A100000100000000000000000000000000 (8 . . . 18L)

(SEQ#2)

A100000100100100000000000000000000 (8 . . . 18R)

(SEQ#1)

A1000001100101100101000000000000000000000000000000
00 (2 . . . 18R)

(SEQ#1)

A1000001110011100001100001001001000000000000000000
00 (2 . . . 18L)

(SEQ#2)

A100010111111111000000100000100000000000000000000
(3 . . . 18R)

(SEQ#1)

A100100000000000000000000 (11 . . . 18R)

(SEQ#1)

A100100000000000000000000 (11 . . . 18L)

(SEQ#2)

A100110011110110100000100000000000000000000000000
(3 . . . 18L)

(SEQ#2)

A110011110110100000100000000000000000000000000
(4 . . . 18L)

(SEQ#2)

A110011111111101001101000100000000000000000000
(4 . . . 18R)

(SEQ#2)

A1101000001001010010011000001001001000000000000000
00000 (1 . . . 18R)

(SEQ#2)

A1101001001100111101101000001000000000000000000000
00000 (1 . . . 18L)

(SEQ#1)

A111001110000110000100100100000000000000000000
(4 . . . 18L)

(SEQ#1)

A111011011111110010000000000000000000000000000
(4 . . . 18R)

(SEQ#1)

C001011011000000000100000000000000000000000
(5 . . . 18R)

(SEQ#1)

C001110000110000100100100000000000000000000
(5 . . . 18L)

(SEQ#2)

C011011111110010100100100000000000000000000
(5 . . . 18R)

(SEQ#2)

C011110110100000100000000000000000000000000
(5 . . . 18L)

(SEQ#1)

C110000100100100000000000000000000 (8 . . . 18L)

(SEQ#1)

C110010000100100000000000000000000 (8 . . . 18R)

(SEQ#2)

G000000000000000000000 (12 . . . 18L)

(SEQ#2)

G000000000000000000000 (12 . . . 18R)

(SEQ#1)

G000000000000000000000000000 (0 . . . 8L)

(SEQ#1)

G0001000001110011100001100001001001000000000000000
00000 (1 . . . 18L)

(SEQ#1)

G000100100000000000000000000 (0 . . . 8R)

(SEQ#1)

G000100100100000000000000000000 (9 . . . 18R)

(SEQ#1)

G000100100100000000000000000000 (9 . . . 18L)

(SEQ#1)

G0001001001000001101100100100000000000000000000000
00000 (1 . . . 18R)

(SEQ#1)

G000110010110010000110100000000000000000000
(0 . . . 13L)

(SEQ#1)

G000110110110010000100100000000000000000000
(0 . . . 13R)

(SEQ#1)

G0011000001000110111101010101000001000000000000000
00000 (0 . . . 17L)

(SEQ#1)

G0011011011010001101101100100001001000000000000000
00000 (0 . . . 17R)

(SEQ#1)

G010000000000000000000000000000 (0 . . . 9L)

(SEQ#1)

G010000100100000000000000000000 (0 . . . 9R)

(SEQ#1)

G100000000000000000000 (0 . . . 6R)

(SEQ#1)

G100000000000000000000 (0 . . . 6L)

(SEQ#1)

G100000000000000000000000 (0 . . . 7L)

(SEQ#1)

G100100000000000000000000 (0 . . . 7R)

(SEQ#1)

G1010001000001110011100001100001001001000000000000
00000000 (0 . . . 18L)

(SEQ#1)

G101000110001110000110000100000000000000000000
(0 . . . 14L)

(SEQ#1)

G101000110110110010000100100000000000000000000
(0 . . . 14R)

(SEQ#1)

G1010011011011010001101101100100001001000000000000
00000000 (0 . . . 18R)

(SEQ#1)

G101100010101111000010101100100000000000000000000
(0 . . . 15L)

(SEQ#1)

G1011001100010110110100010001001000000000000000000
00 (0 . . . 16L)

(SEQ#1)

G101101000110110110010000100100000000000000000000
(0 . . . 15R)

(SEQ#1)

G1011011010001101101100100001001000000000000000000
00 (0 . . . 16R)

(SEQ#1)

G110000110000100100100000000000000000000
(6 . . . 18L)

(SEQ#1)

G110010000010000000000000000000000000
(0 . . . 11L)

(SEQ#1)

G110010000100100000000000000000000 (0 . . . 10R)

(SEQ#1)

G110010000110000000000000000000000 (0 . . . 10L)

(SEQ#1)

G110110010000100100000000000000000000
(0 . . . 11R)

(SEQ#1)

G110110010010110110100000000000000000000
(6 . . . 18R)

(SEQ#2)

G110110100000100000000000000000000000000
(6 . . . 18L)

(SEQ#1)

G110110100010000100100000000000000000000
(0 . . . 12L)

(SEQ#1)

G110110110010000100100000000000000000000
(0 . . . 12R)

(SEQ#2)

G110110110010100000000000000000000000000
(6 . . . 18R)

(SEQ#2)

T000000100100000000000000000000 (9 . . . 18R)

(SEQ#2)

T000100000000000000000000 (0 . . . 7R)

(SEQ#2)

T000100000000000000000000 (0 . . . 7L)

(SEQ#2)

T000100000000000000000000000000 (9 . . . 18L)

(SEQ#1)

T000100001101001110010010110000000000000000000000
(3 . . . 18R)

(SEQ#1)

T000101001101000100000000000000000000
(7 . . . 18R)

(SEQ#1)

T000110000100100100000000000000000000
(7 . . . 18L)

(SEQ#1)

T000111001110000110000100100100000000000000000000
(3 . . . 18L)

(SEQ#2)

T001001010000001100000000000000000000000000
(0 . . . 13L)

(SEQ#2)

T0011010111111010011110111100101000001000000000000
00000000 (0 . . . 18R)

(SEQ#2)

T0011101001001100111101101000001000000000000000000
00000000 (0 . . . 18L)

(SEQ#2)

T001111011110010100000100000000000000000000
(0 . . . 13R)

(SEQ#2)

T010100000100000000000000000000 (0 . . . 9L)

(SEQ#2)

T010100000100000000000000000000 (0 . . . 9R)

(SEQ#2)

T0110000101111111111100011001001000000000000000000
00 (0 . . . 16L)

(SEQ#2)

T011100010100000100000000000000000000
(0 . . . 11L)

(SEQ#2)

T011110010100000100000000000000000000
(0 . . . 11R)

(SEQ#2)

T0111111010011110111100101000001000000000000000000
00 (0 . . . 16R)

(SEQ#1)

T100000000000000000000 (12 . . . 18R)

(SEQ#1)

T100000000000000000000 (12 . . . 18L)

(SEQ#2)

T100000000000000000000 (0 . . . 6R)

(SEQ#2)

T100000000000000000000 (0 . . . 6L)

(SEQ#2)

T100000000000000000000000000 (10 . . . 18L)

(SEQ#1)

T100000100000000000000000000 (10 . . . 18R)
***********************

(SEQ#2)

T100000100000000000000000000 (0 . . . 8R)
**********************

(SEQ#2)

T1001000101101100101100101000001000000000000000000
00 (2 . . . 18R)

(SEQ#2)

T100100100000000000000000000 (0 . . . 8L)
***********************

(SEQ#2)

T100100100000000000000000000 (10 . . . 18R)

(SEQ#1)

T100100100000000000000000000 (10 . . . 18L)
***********************

(SEQ#2)

T1001001100111101101000001000000000000000000000000
00 (2 . . . 18L)

(SEQ#2)

T101001111011110010100000100000000000000000000
(0 . . . 14R)

(SEQ#2)

T1010111111010011110111100101000001000000000000000
00000 (0 . . . 17R)

(SEQ#2)

T1011001000100110111101010000001000000000000000000
00000 (0 . . . 17L)

(SEQ#2)

T101101110111101010100000100000000000000000000
(0 . . . 14L)

(SEQ#2)

T110000100000100000000000000000000 (0 . . . 10L)

(SEQ#2)

T110010100000100000000000000000000 (0 . . . 10R)

(SEQ#2)

T110100000100000000000000000000000000
(7 . . . 18L)

(SEQ#2)

T110101001101000000000000000000000000
(7 . . . 18R)

(SEQ#2)

T111001110000101100000000000000000000000
(0 . . . 12L)

(SEQ#2)

T111011110010100000100000000000000000000
(0 . . . 12R)

(SEQ#2)

T111100110111111110010101100100000000000000000000
(0 . . . 15L)

(SEQ#2)

T111101001111011110010100000100000000000000000000
(0 . . . 15R)

From the above example, it may be seen that a match appears at (10.18R)SEQ#1 with (0 . . . 8R)SEQ#2 both of which correspond to the sub-fragment TATAACGTA.

As may be seen by the above example, when the attractor tokens are mapped into a numerical space, sequence-similarity characteristics are compared by evaluating the numerical distance of the coordinate values. When the attractor tokens are mapped into a Hausdorf or other similar pattern space, the tokens cause sequence-similarity characteristics to be compared by evaluating the spatial vectors.

While the example above has been given for base 7, any other base may be chosen. While choosing a different base may result in different token strings, the token strings will still be ordered next to each other with identical values for identical fragments or sub-fragments from the two (or more) fragments to be compared. For example, one could spell out “one” “two” etc. in English (e.g., for Tables 1-7). With an appropriate change in the Numgram base, such as 26 for the English language, the attractor behavior will still result in unique mappings for input source sets. For example, using Fragment 1 (GGATACGTCGTATAACGTA), the number of A's, C's, G's and T's is shown below in Table 9 designated by Arabic symbols in row 1 and by spelling out the quantity using a twenty six base English alphabet symbol scheme in row 2.

TABLE 9

| A | C | G | T | Row |
|---|---|---|---|---|
| 5 | 6 | 5 | 3 | 1 |
| five | six | Five | three | 2 |

The Numgram table may be constructed as before, but the count base is now 26 and each entry is spelled out using the 26 English alphabet count base. Thus, the first few rows of the thus constructed Numgram table are shown below as Table 10 with columns deleted that contain no entries to conserve space in the table presentation.

TABLE 10

| | A | C | E | F | G | H | I | L | M | N | O | R | S | T | U | V | W | X |
|---|---|---|---|---|---|---|---|---|---|---|---|---|---|---|---|---|---|---|
| 1 | Five | six | | | five | | | | | | | | | three | | | | |
| 2 | | | four | two | | one | Three | | | | | One | one | one | | two | | one |
| 3 | | | seven | one | | one | | | | five | eight | Two | | three | one | | two | |
| 4 | | | nine | one | one | two | Two | | | four | five | One | one | four | | two | two | |
| 5 | | | six | three | | | Two | | | six | ten | Two | | four | two | one | four | |
| 6 | | | four | two | | one | Two | | | two | six | Three | two | five | two | | three | two |

The fixed point behavior (convergence) of the sequence does not occur until line 74 (at the 573^{rd} iteration) and the cycle repeats again at iteration line 601 for a cycle length of 7 as shown in the partial Table 11 below.

TABLE 11

| Row | E | F | G | H | I | L | N | O | R | S | T | U | V | W | X |
|---|---|---|---|---|---|---|---|---|---|---|---|---|---|---|---|
| 574 | twelve | two | | two | two | one | six | nine | four | two | four | two | one | two | two |
| 575 | five | two | | | two | one | four | eleven | two | one | eight | two | one | eight | one |
| 576 | ten | two | two | two | three | one | five | nine | one | | six | one | two | four | |
| 577 | eight | two | | one | three | | six | eight | two | one | six | one | one | four | one |
| 578 | nine | one | two | three | four | | five | eight | two | two | five | one | | two | two |
| 579 | eight | three | one | two | four | | four | eight | two | | seven | one | two | five | |
| 580 | nine | three | two | Three | three | | three | seven | three | one | six | two | two | three | |
| 581 | sixteen | | | Six | two | | four | four | six | two | nine | | one | three | one |
| 582 | seven | two | | One | four | | five | six | three | three | four | two | | two | three |
| 583 | ten | three | | Three | two | | two | six | five | two | six | two | two | three | one |
| 584 | nine | one | | Three | three | | two | six | three | two | nine | | one | five | two |
| 585 | eleven | one | | Three | four | | six | five | three | one | six | | one | three | one |
| 586 | fourteen | two | | Three | three | one | five | five | four | two | three | one | two | | two |
| 587 | twelve | four | | Three | two | | three | eight | five | | eight | two | two | four | |
| 588 | nine | three | two | Four | three | one | | five | four | | eight | two | two | four | |
| 589 | eight | four | one | Three | three | | three | seven | five | | six | three | one | three | |
| 590 | sixteen | two | one | Six | three | | three | three | six | two | six | one | two | | one |
| 591 | eleven | | | Three | four | | four | six | three | four | seven | | | three | four |
| 592 | eleven | four | | Three | one | one | two | Four | seven | two | three | four | two | | one |
| 593 | twelve | three | | Two | | one | five | Nine | five | one | five | three | two | three | |
| 594 | fourteen | three | | Three | four | one | four | Four | three | | six | | four | three | |
| 595 | eleven | five | | Four | one | | two | Six | nine | one | five | five | | | one |
| 596 | ten | four | | | five | one | six | Five | one | one | one | one | four | one | one |
| 597 | ten | four | | | three | | eight | Nine | two | one | one | two | two | | one |
| 598 | eight | one | one | Two | two | | six | Seven | two | | six | one | | three | |
| 599 | eight | | one | Two | three | | four | Six | one | three | five | | one | three | two |
| 600 | eleven | two | one | Four | three | | three | Six | four | one | six | one | one | two | one |
| 601 | twelve | two | | Two | two | one | six | Nine | four | two | four | two | one | two | two |
| 602 | five | two | | | two | one | four | Eleven | two | one | eight | two | one | eight | one |
| 603 | ten | two | two | Two | three | one | five | Nine | one | | six | one | two | four | |

In the above Table 11, only the first three lines, lines 601-603 of the second repeat cycle are shown. Other sequences result in other convergence cycles and internal structures. For simplicity in presentation of the table only non-zero columns are set forth.

A second fixed point behavior having a second distinct cycle length is illustrated by the starting sequence 10, 1, 16, 8. Here, the input to the 26 base Numgram is “ten, one, sixteen and eight”, which could correspond to occurrences of the base pairs in the DNA model. This sequence converges in only 29 cycles and has a cycle length of 3 as shown by the partial pattern results in the Table 12 below.

TABLE 12

| | E | F | H | I | L | N | O | R | S | T | U | V | W | X |
|---|---|---|---|---|---|---|---|---|---|---|---|---|---|---|
| 29 | Nine | three | two | one | | five | Nine | five | one | five | three | | two | one |
| 30 | Twelve | three | two | five | | seven | Five | two | | four | | three | two | |
| 31 | Ten | three | two | two | one | one | Four | three | one | six | one | four | four | |
| 32 | nine | three | two | one | | five | Nine | five | one | five | three | | two | one |
| 33 | twelve | three | two | five | | seven | Five | two | | four | | three | two | |
| 34 | ten | three | two | two | one | one | Four | three | one | six | one | four | four | |

Yet a further fixed point behavior is observed with the input pattern 4, 6, 4, 3 which is input into the 26 base Numgram as “four, six, four three” for the base pairs C, T, G and A. The results are shown in Table 13 below.

TABLE 13

| | E | F | H | I | L | N | O | R | S | T | U | V | W | X |
|---|---|---|---|---|---|---|---|---|---|---|---|---|---|---|
| 9 | nine | two | one | two | one | three | six | two | two | five | one | three | Four | one |
| 10 | ten | two | two | three | | six | nine | three | one | six | one | one | Four | one |
| 11 | ten | one | two | three | | seven | seven | three | two | five | one | | Two | two |
| 12 | twelve | one | two | one | | five | six | two | two | seven | | three | Four | |
| 13 | nine | two | one | two | one | three | six | two | two | five | one | three | Four | one |
| 14 | ten | two | two | three | | six | nine | three | one | six | one | one | Four | one |

The above Table 13 shows a fixed point behavior of 4 cycles. The examples of Tables 11, 12, and 13 demonstrate that at least three fixed point behaviors (each having different cycle lengths) are obtained with the 26 base Numgram using the English letters as the symbol scheme.

Moreover, one may generalize the notion of bases as one is not restricted to numeric bases or even alpha-numeric bases. The Numgram process is much more generally applicable to any symbol set and any abstract base to represent the symbols. For example consider the following sequence:
Sequence A: [symbol] [symbol] [symbol] [symbol] [symbol]
Base A: @#$%&

One can code sequence A with base A using the Numgram procedure as follows:

Associate each unique sequence of sequence A with a base. If there are not enough terms in the chosen base, represent the number modulo the number of terms in the base. For example, there are 5 unique members of the base set representing numerals 0, 1, 2, 3, and 4. To represent the next higher number, i.e., 5, one can write # @. Alternatively, one may simply, add more elements to the base, say new element £ until there are enough members to map each symbol of Sequence A to one member of the base or unique combinations of base members.
Sequence [symbol] [symbol] [symbol] [symbol] [symbol]
Base A: @ # $ # % @ @ $ % &

Now count the number of each base element and insert into the Numgram:

| | | | | |
|---|---|---|---|---|
| @ | # | $ | % | & |
| % | $ | $ | $ | # |
| @ | # | % | # | @ |
| $ | $ | @ | # | @ |
| $ | # | $ | @ | @ |
| $ | # | $ | @ | @ |

The sequence is seen to converge to the behavior $ # $ @ @. In the example used earlier, one would assign a token value of 1.

The above example using non-conventional symbols and base members is meant to illustrate the generality of the Numgram approach in producing iterative and contractive results. By “contractive” it is understood that the process eventually converges to a fixed point behavior (repetitive over one or more cycles).

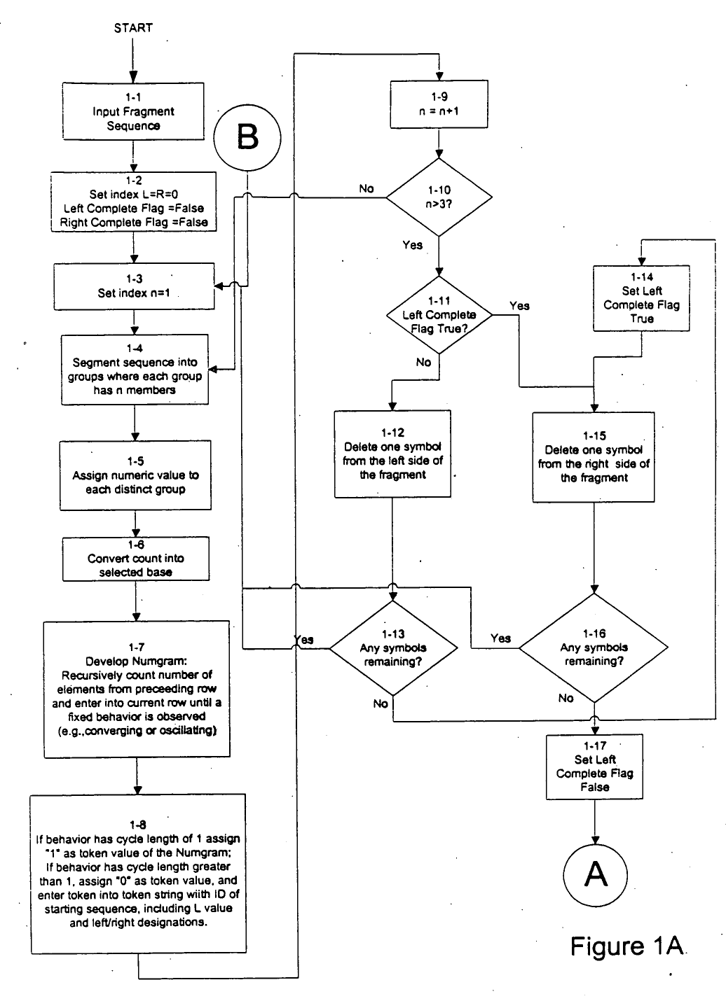

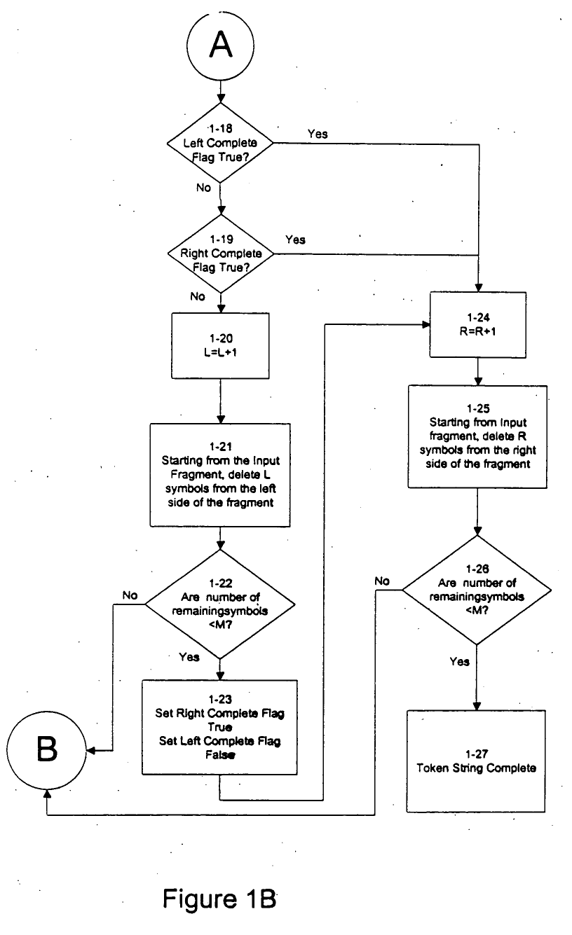

The iterative and contractive process characteristic of hierarchical multidimensional attractor space is generally described in relation to FIGS. 1A and 1B, collectively referred to as FIG. 1. In step 1-1 of FIG. 1 an input fragment is read into the system which may comprise, for example a digital computer or signal processor. More generally, the system or device may comprise any one or more of hardware, firmware and software configured to carry out the described Numgram process. Hardware elements configured as programmable logic arrays may be used. In step 1-2, index values L and R are both set to zero; the Left Complete Flag is set false; and the Right Complete Flag is set false. In step 1-3, index value n is initialized to 1. In step 1-4 the input sequence is broken up into groups, with n (in this case, initially, n=1) member in each group. This step corresponds to taking each nucleotide singly as in the examples discussed above. In step 1-5, a numeric value is assigned to each member of each group using a base 10 for example. The count value for each number is then converted into the selected base in step 1-6. In step 1-7 the Numgram procedure is performed for the fragment or sub-fragment under consideration. One recursively counts the number of elements from the preceding row and enters this counted value into the current row until a fixed behavior is observed (e.g., converging or oscillating, or alternatively oscillating with cycle 1 or oscillating with cycle greater that 1). If the observed behavior has a cycle length of 1, the behavior is assigned a token value of “1” as performed in step 1-8. If the observed behavior has cycle length greater than 1, one assigns a “0” as the token value. The token values are entered into a token string with the ID of the starting sequence, including all prefixes and suffixes.

In step 1-9, the index value is increased by one so that n=2. In step 1-10 the current value of n is compared to some fixed value, as for example, 3. If n is not greater than 3, the procedure goes again to step 1-4 where the input sequence or fragment is broken into groups with each group having 2 members. Thus, n=2 corresponds to taking the nucleotides in pairs. Steps 1-5 to 1-9 are again repeated to obtain the second token.

In step 1-9, the index value is again increased by one so that n=3. In step 1-10 the current value of n is compared to the same fixed value, as for example, 3. If n is not greater than 3, the procedure goes again to step 1-4 where the input sequence or fragment is broken into groups with each group having 3 members (codon). Thus, n=3 corresponds to taking the nucleotides in triplets. Steps 1-5 to 1-9 are again repeated to obtain the third token.

In the example of the first fragment GGATACGTCGTATAACGTA, the token value for n=1 is 1; for n=2 is 0; and for n=3 is 1 as seen by the first three digits of (0 . . . 18L)(SEQ#1),

Once step 1-10 is reached after the third time around, n>3 and the program proceeds to step 1-11 where the Left Complete Flag is checked. Since this flag was set false in step 1-2, the program proceeds to step 1-12 where one symbol is deleted from the left side of the fragment. Such deletion produces the first sub-fragment in the pyramid of Table 7 (line 1, left side), namely the sequence: GATACGTCGTATAACGTA. In step 1-13 one examines the resulting sequence to determine if there are any symbols left, and if there is a symbol left, the program proceeds to steps 1-3 where n is set to 1. By repeating steps 1-4 through 1-10 three times for n=1, 2, and 3, a Numgram token string for the current sub-fragment (line 1, left side of Table 7) may be developed corresponding to single/double/triplet member groups. This token string is seen to be “000” as shown by the 4^{th} through 6^{th} digits of (0 . . . 18L)(SEQ#1). The process repeats steps 1-12 to delete yet another symbol off of the left side of the sequence resulting in the second sub-fragment shown in line 2 of Table 7, left side. Again, since there is still at least one symbol present as determined in step 1-13, steps 1-4 through 1-10 are again repeated to build the additional three digits of the token string, namely, “100” as seen from the 7^{th} through 9^{th} digits of (0 . . . 18L)(SEQ#1). In this manner the entire token string of (0 . . . 18L)(SEQ#1) may be developed.

After all of the symbols have been used as indicated in step 1-13, the program goes to Step 1-14 where the Left Complete Flag is set true. In step 1-15, the input sequence is chopped off by one symbol from the right hand side of the fragment and the resulting sub-fragment is examined in step 1-16 to see if any symbols remain. If at least one symbol remains, the program proceeds through steps 1-3 through 1-11 where the Left Complete Flag is checked. Since this flag was set true in step 1-14, the program goes to step 1-15 where another symbol is deleted from the right hand side of the preceding sub-fragment. The sub-fragments so formed are those illustrated for example by the right hand side of the pyramid of Table 7. Each loop through 1-15 and 1-16 skips down one line in Table 7. With each line, the token string is again developed using the Numgram tables according to steps 1-3 through 1-10. As a result the token string (0 . . . 18R)(SEQ#1) is obtained.

After there are no remaining symbols as determined in step 1-16, the Left Complete Flag is set false in step 1-17, and the program goes to branch A (circle A in FIG. 1A) and to step 1-18 of FIG. 1B. In this step, the Left Complete Flag is examined and is determined to be set false (step 1-17). In step 1-19, the Right Complete Flag is examined and found to be false, as it is still set to its initial value from step 1-2. As a result, the index L is incremented in step 1-20. Since L was originally initialized to 0 in step 1-2, L is now set to 1 and, according to step 1-21, one symbol is deleted from the left side of the initial input fragment. In step 1-22 the number of sequences remaining after the symbol deletion from step 1-21 is examined. If the number of remaining symbols is not less than M, a predefined number, then the program goes to branch B (circle B) and accordingly to step 1-3 (FIG. 1A). The Numgram tables and token sequences are computed as before for both left and right pyramids starting from the fragment defined by step 1-21 (i.e., line 1 of Table 7, left hand side). Thus the token strings (1 . . . 18L)(SEQ#1) and (1 . . . 18R)(SEQ#1) are defined. After completion of these token strings, the program again loops to step 1-21 where L is incremented to L=2. Now the token strings (2 . . . 18L)(SEQ#1) and (2 . . . 18R)(SEQ#1) are tabulated and the cycle continues until the remaining symbols are less than M as determined in step 1-22. In the detail examples given for the first and second main input fragments, M is set to 7 so that sequences of 6 or less are ignored. In practice, these short sequences exhibit a constant behavior so they are not very interesting as fragment discriminates. However, in general M may be any integer set by the user to terminate the computation of the token strings.

After step 1-22 the procedure continues at step 1-23 where the Right Complete Flag is set true and the Left Complete Flag is set false. In step 1-24, the index R is incremented so that in this cycle R=1. At step 1-25 a single symbol (R=1) is deleted from the right of the input starting fragment. In step 1-26 the number of symbols is examined, and if they are not less than M, the program branches to B (circle B) and thus to step 1-3 of FIG. 1A. As before, the token strings are computed, but this time since the starting sequence was obtained by deleting one symbol from the right, the resulting token strings are (0 . . . 17L)(SEQ#1) and (0 . . . 17R)(SEQ#1). The next iteration proceeds, inter ala by steps 1-18, 1-19 and 1-24 to generate the next token string with L=2 so that token strings (0 . . . 16L)(SEQ#1) and (0 . . . 16R)(SEQ#1) are produced. This process continues until step 1-26 determines that the remaining symbols are too few to continue and then all of the token strings have been generated as in step 1-27.

While the detail example given above use the base 7 for the Numgram tables, other bases could also be used. The selection of different bases produces a different Numgram table but still produces at least two types of behavior. These two types of behaviors could in general by any two distinct number of cycles of repeat sequences and in general could also be parameterized by the number of cycles needed to reach the beginning of a repeat sequence. For the Numgram examples using different Arabic base symbols, there appears to be at least one behavior with cycle one, and one with a cycle greater than one. For example, base 9 produces the following oscillating type of behavior:

Oscillating Type Behavior for Base 9

| | | | | | | | | |
|---|---|---|---|---|---|---|---|---|
| 0 | 1 | 2 | 3 | 4 | 5 | 6 | 7 | 8 |
| 5 | 3 | 0 | 0 | 0 | 0 | 1 | 0 | 0 |
| 6 | 1 | 0 | 1 | 0 | 1 | 0 | 0 | 0 |
| 5 | 3 | 0 | 0 | 0 | 0 | 1 | 0 | 0 |

Base 9 also produces a converging type behavior to the value: [5,2,1,0,0,1,0,0,0,]. Similar behavior occurs for different bases where the generalized statement for base n is as follows:

For single cycle behavior:

| | | | | | | | | | |
|---|---|---|---|---|---|---|---|---|---|
| Number | 0 | 1 | 2 | 3 | . . . | n-4 | n-3 | n-2 | n-1 |
| count | n-4 | 2 | 1 | 0 | 0 | 1 | 0 | 0 | 0 |

and for multiple cycle behavior:

| | Number | | | | | | | | |
|---|---|---|---|---|---|---|---|---|---|
| | 0 | 1 | 2 | 3 | . . . | n − 4 | n − 3 | n − 2 | n − 1 |
| count | n − 4 | 3 | 0 | 0 | 0 | 0 | 1 | 0 | 0 |
| count | n − 3 | 1 | 0 | 1 | 0 | 1 | 0 | 0 | 0 |

While the token strings would be different for different selected bases, the groupings of the token strings still produces a match in that when these token strings are placed in ascending order, adjacent, identical token strings appears if there is a match between the corresponding fragments. This indeed must be so, since according to property one of an attractor, there must be a consistent, fixed mapping of the same input behavior to output behavior. Thus, matching tokens strings appear adjacent one another and identify the identical sub-fragment. It is assumed of course that for any sets of comparisons used, the same base and consistent attractor behavior label assignments for the behaviors has been used.

The following Table shows the behavior of selected bases chosen for the Numgram to which 10000 random inputs have been applied.

Number of each type of behavior for 10,000 random inputs

| | Number for | Number for |
|---|---|---|
| | behavior 0 | behavior 1 |
| Base | (>cycles) | (1 cycle) |
| 7 | 7033 | 2967 |
| 9 | 3632 | 6268 |
| 10 | 5504 | 4496 |
| 11 | 4608 | 5392 |
| 14 | 2516 | 7484 |
| 19 | 1322 | 8678 |

As seen from the above table, if one knows nothing about the input sequence, one would simply choose a base, such as base 10 or 11 so that a roughly 50/50 split will be produced for any given sequence of inputs. However, if one has some additional knowledge about the mapping of the inputs and outputs, then one may use this additional knowledge to build a more selective classifier. For example, if past experience has shown that a base 19 is appropriate of the source multiset of interest or if the symbol base can be expressed to take advantage of base 19, then a relatively high selectively will occur since 87% of the random inputs will exhibit type 1 behavior and 13% exhibit type 0 behavior. If one is looking for sequences which exhibits type 0 behavior, one can eliminate a large percentage of the input source set resulting in a highly efficient classifier. Classifying the input sequence in this manner throws out 87% of the inputs which are not of interest and greatly simplifies the segregation of the inputs to isolate the remaining 13% of interest

Fragment assembly may be achieved by using the Numgram process described above to identify multiple overlapping fragments. The following table illustrates a matrix that may be constructed to identify overlaps.

| | Column 0 | Column 1 | Column 2 | Column 3 |
|---|---|---|---|---|
| Row 0 | 0 | 12 | 0 | 0 |
| Row 1 | 15 | 0 | 10 | 0 |
| Row 2 | 0 | 0 | 0 | 20 |
| Row 3 | 0 | 18 | 0 | 0 |

In the above table, the numbers represent the number of overlapping sequences between the fragments identified by their row and column. By convention, the overlap is taken with the “row” fragment on the left side of the overlap. Thus, fragments 2 and 3 overlap as follow with a symbol (nucleotide) length of 20 as indicated by the overlap below.

<<<<<<Fragment 2>>>>>>>>>>
<<<<<<<Fragment 3>>>>>>>>>>>

A zero in any given cell means that there is no left-to-right overlap from the given row's fragment to the given column's fragment. The diagonal, representing fragments mapping onto themselves is always zero.

To assemble the fragments one starts with the fragment that has the fewest overlaps on its left. The fragments are chained with the longest overlap on that fragments right, the longest on the next fragment's right and so on. If the resulting chain includes all fragments, then the assembly is terminated. If not, one back's up one fragment and tries again starting with the fragment with the next-most overlaps on its right. The procedure is recursively applied to explore all possible paths. The first chain that includes all the fragments is the desired assembly. If this procedure fails to yield assembly of fragments, the longest chain found is the assembly.

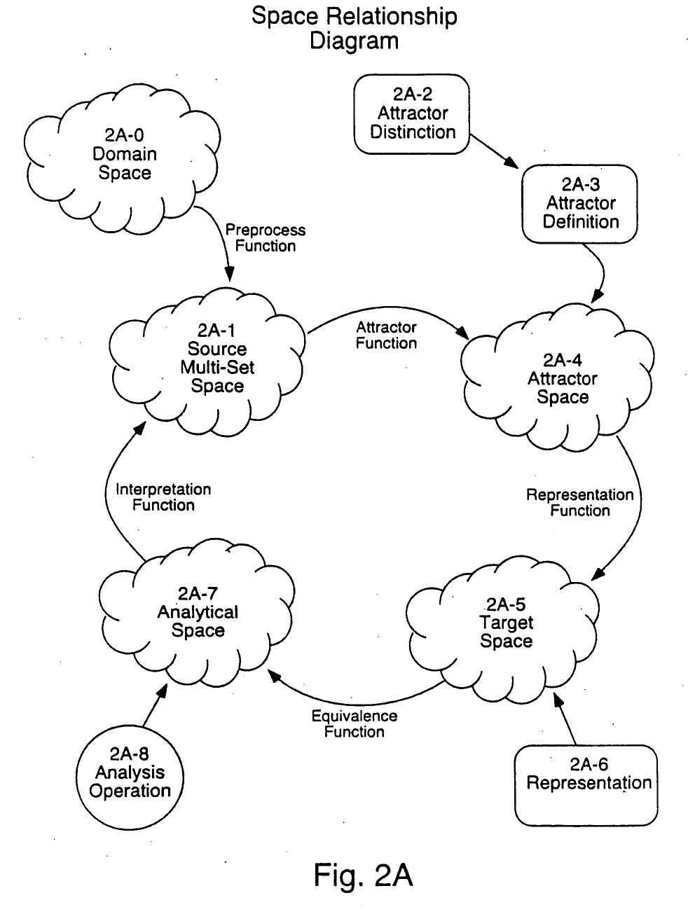

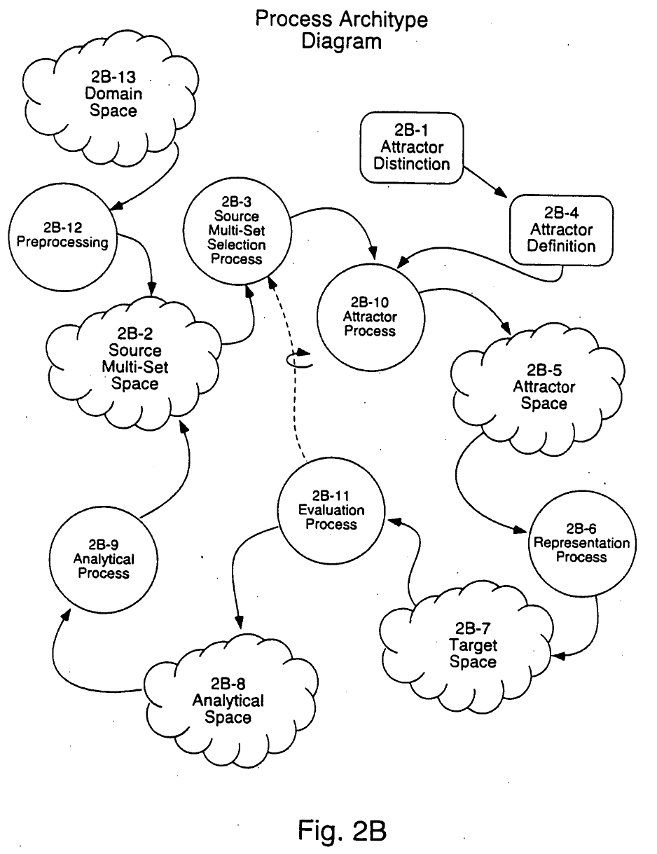

While a particular implementation of an attractor process used as a classifier has been set forth above, there are many types of attractors what may be used. Attractors of interest will have the property of being one-to-one and onto so that they exhibit the primary characteristics of attractors discussed above. Note in addition that one ultimately needs an invertable process so that for any output of the attractor, one is able to get back to the original input source multiset. This inevitableness is achieved by mapping the identification of the source multiset with the attractor space representation so that this latter mapping is one-to-one, onto and invertable. These characteristics will become clear from the discussion below in connection with FIGS. 2-5 below.

FIGS. 2A and 2B illustrate the relationships among various spaces in the attractor process. In particular, FIG. 2A is a space relationship diagram illustrating the various spaces and the various functions and processes through which they interact.

A space is a set of elements which all adhere to a group of postulates. Typically, the elements may be a point set. The postulates are typically a mathematical structure which produces an order or a structure for the space.

A domain space block 2A-0 is provided from which a source multiset space is selected through a pre-process function. The domain space 2A-0 may be a series of pointless files that may be normalized, for example, between 0 and 1. The source multiset space is mapped to the attractor space 2A-4 via an attractor function.

An attractor process 2B-10 (shown in FIG. 2B) may be an expression of form exhibiting an iterative process that takes as input a random behavior and produces a predictable behavior. In other words, an attractor causes random inputs to be mapped to predictable output behaviors. In the above example, the predictable output behaviors may be the converging or oscillating behaviors of the Numgram process.

The attractor process 2b-10 may be determined by an attractor distinction 2A-2 and an attractor definition 2A-3. In the above example, the attractor distinction 2A-2 may be the selection of the Numgram, as opposed to other attractors, while the attractor definition 2A-3 may the selection of the base number, the symbol base, the symbols, etc.

The behaviors in the attractor space 2A-4 may be mapped to a target space 2A-5 through a representation function. The function of the target space is to structure the outputs from the attractor space for proper formatting for mapping into the analytical space. In the above example, the oscillating or converging outputs in the attractor space may be mapped to a 0 or a 1 (via representation 2A-6). in the target space. Further, the target space may concatenate the representation of the attractor space output for mapping to the analytical space 2A-7. The concatenation is done by grouping together the outputs of the representations (2A-6) of the attractor space output to form the token strings as shown, for example, in Table 8 and (0 . . . 18L)SEQ#1. The analytical space 2A-7 may be a space with a set of operators defined for their utility in comparing or evaluating the properties of multisets. The operators may be simple operators such as compliment, XOR, AND, OR etc so one can sort, rank and compare token strings. Thus, evaluation of the analytical space mappings of the multisets allows such comparisons as ranking of the multisets. The target space and the analytic space could be collapsed into one space having the properties of both, but it is more useful to view these two spaces as separate.

In the analytical space, an analysis operation 2A-8 or an analytical process 2B-9 (FIG. 2B) may be used to evaluate the matching (or commonality) properties of the multisets. For example, the multisets were obtained by deleting one element at a time from the right and left sides of the original fragment to obtain the inverted pyramids of Table 7. The analytic space with its defined operators for comparing, was able to order the token strings. These ordered token strings were then used to detect overlaps in different fragments, that is fragments that had some portion of the sequence the same as revealed by the multiset selection. The construction of the multisets by chopping off one element from the left and right or the subsequent one-at-a-time, two-at-a-time and three-at-a-time groupings may or may not be appropriate depending on the particular problem domain one is interested in. Thus there is a feedback path shown in step 2B-11 and 2B-3 of FIG. 2B to evaluate the results of the target space representation and to select or modify the selection of the source multiset to be used in the attractor process. If one is interested in a closed loop controller then there is also a feedback path from the analytic space 2A-7 (FIG. 2A) or the analytic process 2B-7 (FIG. 2B) to the source multiset space 2A-1 (of FIG. 2A) or 2B-2 (of FIG. 2B).

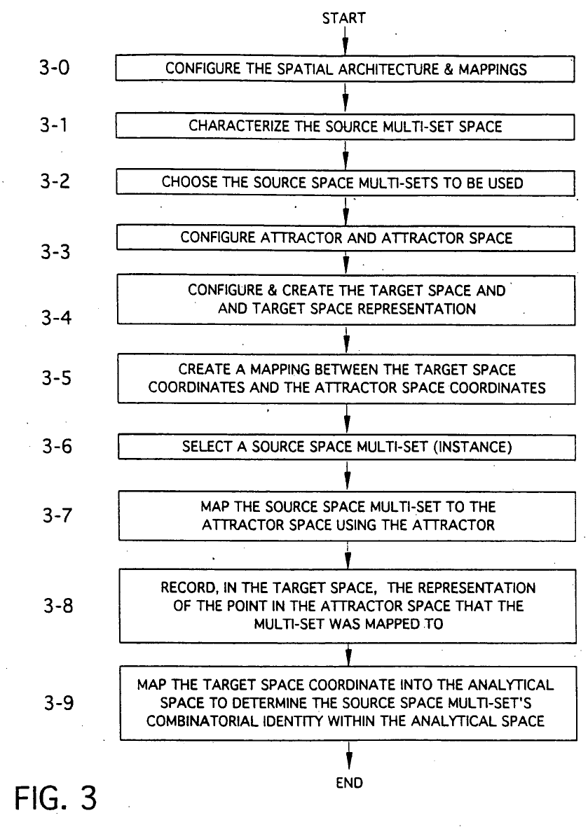

An embodiment of the invention is shown in FIG. 3. The flowchart of FIG. 3 starts with step 3-0, which configures the spatial architecture and mappings according to, for example, the illustration of FIG. 2A. The spatial architecture contain the entities (e.g., A's, C's, T's. and G's) and relationships (entities form a sequence), and the mappings which are configured consist of selecting a methodology to expose solutions (e.g., expose DNA sequence matching). With the spatial architecture and mappings configured, the method according to the embodiment proceeds to the step 3-1 which is the step of characterizing the source multiset space. In this step, one looks at the size of the source multiset one desires to run through the attractor process. One also recognizes that there are only for distinct entities in the source domain space and that one will ignore any attributes of the measurement instrument used to obtain the A's, C's, T's, and G's.

It is noted here that, with reference to FIGS. 3-6B, sets are generally idempotent, i.e., do not have multiple occurrences of the same element, while multisets are generally not. Elements in multisets are, however, ordinary unique.

Turning to the DNA example by way of illustration and not by way of limitation, one may be interested in an entire set of say 10,000 fragments or only a smaller subset such as half of them, namely 5,000. The 5,000 fragments may be selected based on some criteria or some random sampling. The DNA fragments may be characterized such that one uses the fragments that are unambiguous in their symbol determination, that is in which every nucleotide is clearly determined to be one of C, T, A or G, thus avoiding the use of wild card symbols. In an image processing example, one may be interested in a full set say 11,000 images or some subset of them. The subset may be chosen, for example, based on some statistical.

In step 3-2 of FIG. 3, one chooses or defines the source multiset or multisets to be used to define the domain scope. In this step, the number of unique elements or the number of unique element groups are determined for each set of interest within a source multiset space. For example, if the sources multiset space comprises the nucleotides within any DNA fragment, then the number of unique elements needed when taking each nucleotide one at a time is 4 corresponding to C, T, A and G. However, if the nucleotides were taken as a group two elements at a time or three elements at a time, then the number of unique element groups needed to characterize the source space multiset would be 16 and 64, respectively, as shown earlier in Tables 3 and 5. In other case, the four base nucleotides may have been represented as a pairing of binary numbers using the four “symbols” for the elements such as 00, 01, 10, and 11. In both the case of C, T, A, and G and in the case of 00, 01, 10, and 11 both source multiset spaces have four distinct symbols. One may also introduce additional symbols to the source multiset space representative of a wild card “X” to represent an unrecognized nucleotide where X may stand for any one of C, T, A and G. In such case, there would be five distinct elements, and one may choose these 5 elements to be interacted with the attractor process.

More generally, the characterizing of the source multiset space and choosing the source set elements includes stating or recording what is known or discernable about the unique elements, symbols and/or unique patterns contained within, or representative of, the source multiset space. In cases where knowledge of the source space is unknown, an artificial symbol pattern or template structure can be imposed on the source space. This artificial template structure would be used for lots of different types of data such as text (different languages), graphics, waveforms, etc. and like types of data will behave similarly under the influence of the attractor process.

For definition purposes, in the DNA example, one may consider the source multiset to be a particular DNA fragment and the resulting inverted pyramid structures of subsets of the original fragment. Fragment 1 used in the detailed example above is composed of 19 elements. In general, elements are represented by at least one symbol and typically there are a plurality of symbols which represent the elements. In the DNA example of Fragment 1, there are 4 distinct symbols when the members are considered one at a time, 16 distinct symbols when the members are considered two at a time, and 64 distinct symbols when the members are considered three at a time.

Step 3-3 entails configuring the attractor the attractor space. As discussed above with reference to FIGS. 2A and 2B, configuring the attractor involves choosing parameters to change (i.e., increase or decrease) the number of behaviors exhibited by the attractor. Some of these parameters in the case of the Numgram attractor include changing the count base, changing the symbol base or the representation of the symbol sets (going from “1”, “2”, to “one”, “two” etc). Another parameter, as it relates to the Numgram process and the DNA example is inputting the number of distinct symbols which was determined from the choosing step 3-2. In the Numgram process, one uses the number of distinct symbols to build the Tables 1, 3 and 5.

The attractor space contains sets of qualitative descriptions of the possibilities of the attractor results. The term “qualitative” is used to mean a unique description of the behavior of a attractor process as opposed to the quantitative number actually produced as a result of the attractor process. For example, Table 2 shows that the attractor process converges to 3211000 at row 4 of the table. In contrast, Table 4 shows a qualitatively different behavior in that the attractor process exhibits an oscillatory behavior which starts at row 5 of Table 4. Thus, the attractor space represents the set of these unique descriptors of the attractor behavior. Other qualitative descriptors may include the number of iterations exhibited in reaching a certain type of behavior (such as convergence or oscillatory behavior); the iteration length of an oscillatory behavior (i.e., the number of cycles in the oscillation); the trajectory exhibited in the attractor process prior to exhibiting the fixed point behavior etc. By fixed point behavior, one means a typological fixed point behavior and thus, an oscillatory and converging behaviors in the detailed examples given above are both “fixed point” behaviors. The same parameterizations that are used to configure the attractor (e.g., changes to symbol base, count base etc.) also change the attractor space and generally, it may be desirable to examine how the combined attractor and attractor space changes are optimally performed in response to the parameterizations. For example, it may be desired to pick a count base with two fixed point behaviors and also a small number of cycles in an oscillatory behavior to optimum performance and speed.

There are many ways to configure the attractor. For example, one could spell out “one” “two” etc. in English or French (or any representation) instead of using the numeric labels 1, 2 etc. in all of the tables (such as tables 1-7). With an appropriate change in the Numgram base, such as 26 for the English language, the attractor behavior will still result in similar mappings for similar input source sets.

Step 3-4 is the step of creating a target space representation and configuring the target space. For example, in the Numgram attractor process, one may assign token values 0 or 1 for the two fixed points corresponding to oscillatory and converging behaviors. Further one could take into account the number of iterations in the attractor process to reach the convergence or oscillatory fixed points and assign labels to the combinations of the number of iterations and the number of different fixed points. For example, if there are a maximum of 4 iterations to reach the fixed point behaviors, then there are a combination of 8 unique “behaviors” associated with the attractor process. Here, the concept of “behavior” instead of being limited to only the two fixed points, oscillatory and converging, is generalized to be understood to include the number of iterations needed to reach the fixed point. Thus, unique labels may be 1, 2, . . . 8 may be assigned to the eight types of behavior exhibited by the attractor process. Of course, a different representation may be used such as a base 2 in which case the labels 0, 1, 2, 4, 8, 16, 32 and 64 would be used as labels to represent the unique attractor behaviors. It may be appreciated that other attributes of the attractor process may be further combined to define unique behaviors such as a description of the trajectory path (string of numerical values of the Numgram process) taken in the iterations to the fixed point behaviors. The number of behaviors would then be increased to account for all the combinations of not only the oscillatory/fixed characteristics and number of iterations, but also to include the trajectory path.

Step 3-5 is the step of creating a mapping between the target space coordinates (i.e., the symbols such as “1” and “0” assigned to the behavior as well as other assignments, if made, such as trajectory path, number of cycles etc.) and the attractor space coordinates (i.e., the “oscillatory” or “converging” behavior of the attractor). The mapping may be done by making a list and storing the results. The list is simply a paired association between an identification of the target space and the attractor space using the target space representation as assigned in step 3-4. Thus, to return to the DNA example, for each DNA fragment in the sources space multiset, the mapping would consist of the listing of the identification of each fragment with the attractor space representation. Such an identification is seen by appending the labels (0 . . . 18R)SEQ#1 or (12 . . . 18L) SEQ#1 etc. to the token string as done above.

Steps 3-1 through 3-5 represent the initialization of the system. Steps 3-6 through steps 3-9 represent actually passing the source multiset through the attractor process.

In step 3-6 an instance of the source-space multiset is selected from the source multiset space (2B-2 of FIG. 2B). The broadest definition of multiset, includes any set that contains one or more occurrances of an entity or element. For example, AAATCG is a multiset because it contains multiple occurences of the entity “A”. Further, the inverted pyramids of Table 7 are also termed multisets. One then extracts the number of like elements such as the number of C's, T's, A's and G's as shown in detail above.

In step 3-7 one maps the source space multiset to the attractor space using the attractor which was configured in step 3-3. This mapping simply passes the selected source multiset from step 3-6 through the attractor process. In other words, the source multiset is interacted with the attractor process.

In step 3-8, one records, in the target space, the representation of each point in the attractor space that resulted from the mapping in step 3-7.

In step 3-9, one maps the coordinate recorded in step 3-8 into an analytic space to determine the source multiset's combinatorial identity within the analytic space. This record is a pairing or an association of a unique identification of the source multiset with the associated attractor space representation for that source multiset. The analytic space basically just contains a mapping between the original source multiset and the attractor representation.

The various spaces are delineated for purposes of clarity. It will be appreciated by those skilled in the art that, in certain implementations, two or more of the spaces may be collapsed in a single space, or that all spaces may be collapsed in a multiplicity of combinations to a minimum of two spaces, the domain space and the attractor space. For example, hierarchical spaces may be collapsed into a single space via an addressing scheme that addresses the hierarchical attributes.

By combinatorial identity, one simply means those source multisets that have the same frequency of occurrence of their elements. For example, if one is considering elements of a fragment one at a time, then the fragments ATATG and AATTG will map to the same point in the attractor space. Both of these groupings have two A's, two T's and one G, and thus when sent through the attractor process will exhibit the same behavior and be mapped to the same point in the attractor space.

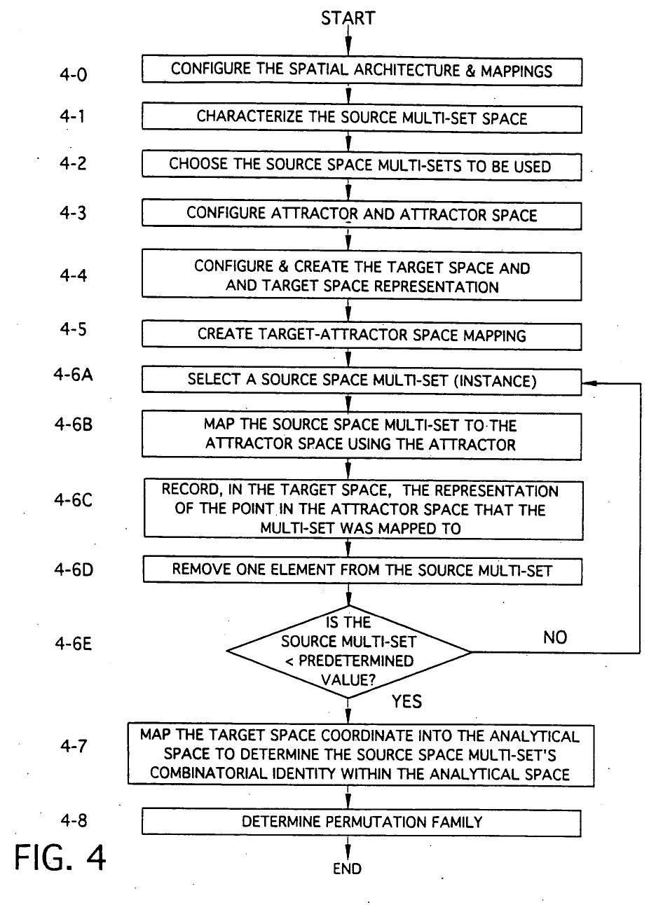

FIG. 4 is a flowchart representing another embodiment of the invention. This embodiment is characterized as a method for recognizing the identity of a family of permutations of a set in a space of sets containing combinations of set elements and permutations of those combinations of set elements. Step 4-1 through 4-5 are the same as steps 3-1 through 3-5. Step 4-6A through 4-6C are the same as steps 3-6 through 3-8 of FIG. 3.

Step 4-6D removes one element from the source multiset. Thus, if the source multiset is Fragment 1 in the above example, then one element is removed as explained above in detail. In general, it is not necessary to remove an element from the left or right and the elements can be removed anywhere within the source multiset. In other embodiments, one or more elements may be removed as a group. These groups may be removed within the sequence and may include wildcards provided the removal methodology is consistently applied.

In step 4-6E, one determines if the source multiset is empty, that is, one determines if there are any elements left in the source multiset. If the source multiset is not empty, the process goes to step 4-6A and repeats through step 4-6E, with additional elements being deleted. Once the source multiset is empty in step 4-6E, the process goes to step 4-7 which maps the representation coordinate list to the analytic space. The analytic space again contains the identification of the source element and its' mapped attractor space representation (i.e., a coordinated list). Since members are repeatedly removed from the source multiset, the attractor space representation will be a combined set of tokens representing the behavior of the initial source multiset and each successive sub-group formed by removing an element until there are no elements remaining.

While step 4-6E has been described as repeating until the source multiset is empty, one could alternatively repeat the iteration until the source multiset reaches some pre-determined size. In the detailed example of the DNA fragments set forth above, once the sub-fragment length is under 7, the tokens are identical and thus it is not necessary to continue the iterations.

Step 4-8 determines the permutation family of the mapped source multiset. It is noted that the permutations here are those source multisets that interacted in some common way with the attractor process as performed in steps 4-1 through 4-7. As a result of this common interaction, the token strings would be identical at least to some number of iterations as defined by step 4-6.

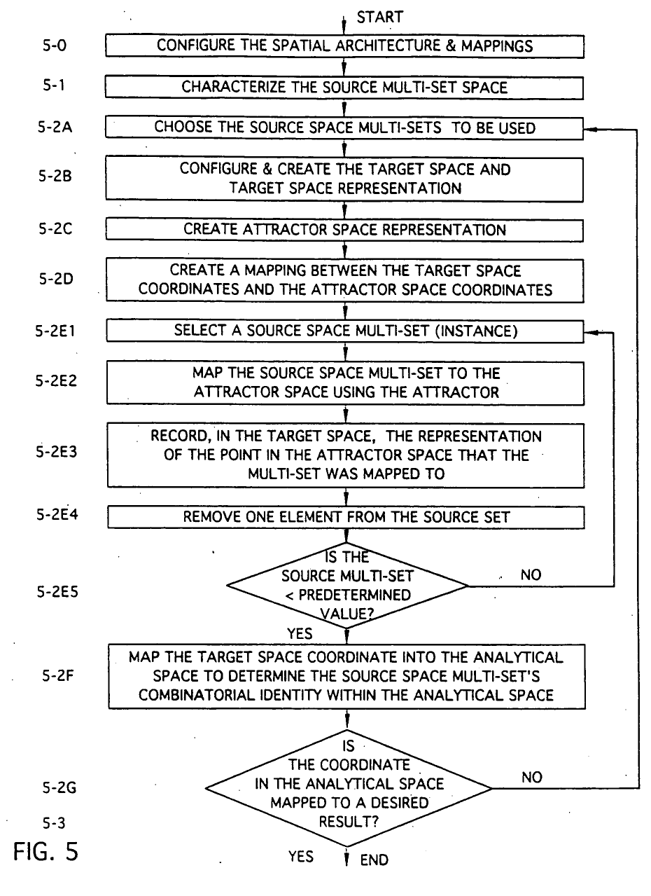

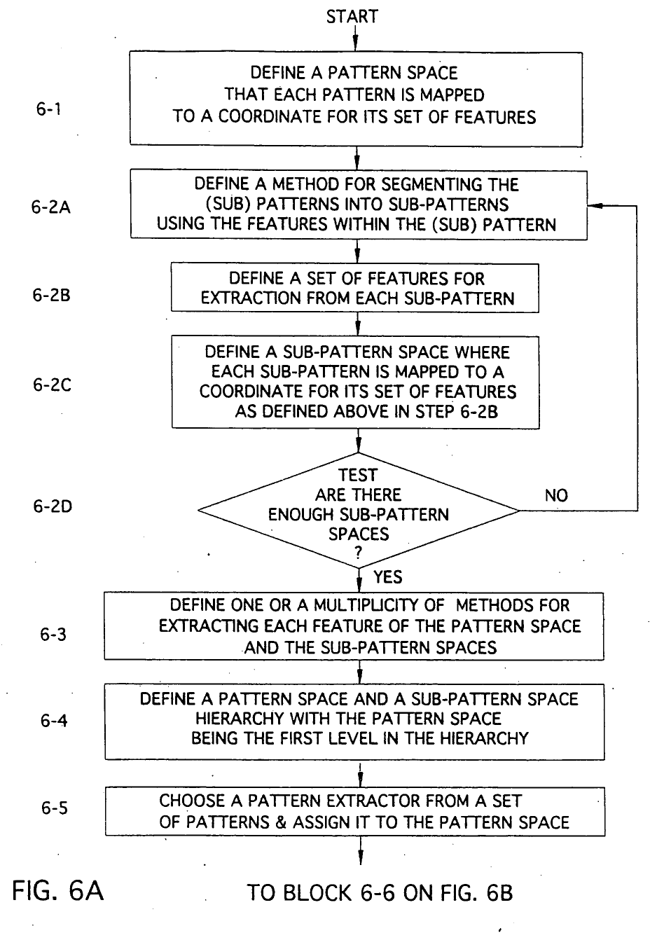

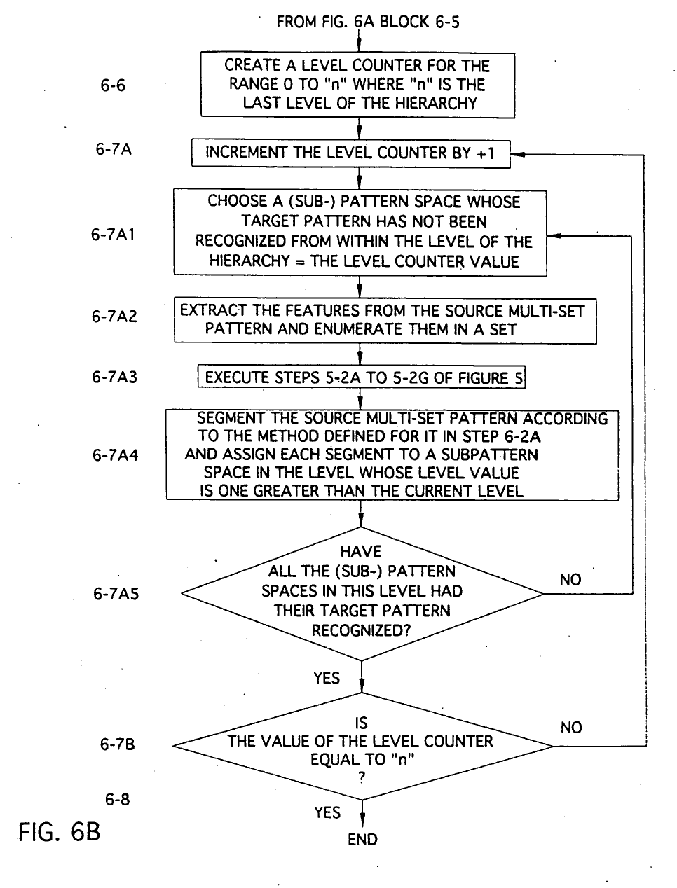

FIG. 5 illustrates yet another embodiment of the invention. In FIG. 5, steps 5-1 through 5-2F are the same as steps 4-1 through 4-7 in FIG. 4 respectively. A further step 5-2G has been added to FIG. 5 as compared to FIG. 4. In step 5-2G, one ask if the coordinate set in the source space is mapped to a unique set in the analytic space. If it is, the process ends. If there is no unique mapping, the process loops back to step 5-2A in which one chooses different source multiset elements to be used in the attractor process. For example, in the DNA example, if the attractor process of FIG. 4 did not produce a unique analytic space mapping, one may choose the elements of the source multiset two at a time and iterate steps 5-2A through 5-2G to see if a unique mapping results. In this process, it is noted that step 5-2E4 now is interpreted to mean remove one two-at-a-time element (a group of two elements taken together now forms one “element”) from the source multiset. If step 5-2G still does not produce a unique mapping one again goes to step 5-2A and chooses source multiset element to be used in a different way, as for example by choosing them three at a time. Again, in step 5-2E4, one removes one “three-at-a-time” element from the source multiset on each iteration. Eventually, with the proper choice of the source multiset elements in step 5-2A and sufficient loopings from step 5-2G to 5-2A, the mapping will be unique.

FIG. 6 is a flowchart representing another embodiment of the invention. This embodiment is characterized as a method for hierarchical pattern recognition using attractor-based characterization of feature sets. This embodiment addresses a broader process than that described with reference to FIG. 5. The embodiment of FIG. 6 addresses a hierarchical pattern recognition method using, for example, the embodiment of FIG. 5 at one or more pattern spaces at each level of the hierarchy.

Steps 6-1 to 6-4 set up the problem. Steps 6-5 to 6-7B “process” source patterns into the spatial hierarchy created in Steps 6-1 to 6-4.

At the outset of the set-up portion, a hierarchy of pattern spaces is configured. In step 6-1, a top level pattern space whose coordinates are feature sets is defined. The feature set may include features or sets of features and feature relationships to be used for describing patterns, embedded patterns or fractional patterns within the pattern space hierarchy and for pattern recognition. Each feature or feature set is given a label and the Target Space is configured so that its coordinates and their labels or punctuation accurately represent the feature set descriptions of the patterns, embedded patterns and pattern fragments of the pattern space coordinates.

In step 6-2A, a method of segmenting the top-level pattern is defined. This segmenting may be pursuant to a systematic change. In the example of the DNA fragments, two-symbols-at-a-time and three-symbols-at-a-time or symbols separated by “wild card symbols” may be sub-patterns of the pattern having a series of symbols.

At step 6-2B, a set of features in the sub-patterns is defined for extraction. In the DNA fragment example, the features to be extracted may be the frequency of occurrence of each symbol or series of symbols. In other examples, such as waveforms, the features to be extracted may be maxima, minima, etc. It is noted that, at this step, the features to be extracted are only being defined. Thus, one is not concerned with the values of the features of any particular source pattern.

At step 6-2C, one or more hierarchical sub-pattern spaces may be defined into which the patterns, sub-patterns or pattern fragments described above will be mapped. This subdivision of the pattern spaces may be continued until a sufficient number of sub-pattern spaces has been created. The sufficiency is generally determined on a problem-specific basis. Generally, the number of sub-pattern spaces should be sufficiently large such that each sub-pattern space has a relatively small number of “occupants”. A hierarchy of Target Subspaces is configured with a one to one relationship to the hierarchy of pattern space and subspaces.

Once it is determined that sufficient number of sub-pattern spaces exist (step 6-2D), a method of extracting each feature of the pattern space and the sub-pattern spaces is defined at step 6-3. This method serves as a set of “sensors” for “detecting” the features of a particular source pattern.

At step 6-4, the configuration of the problem is completed by defining a pattern space and a sub-pattern space hierarchy. In the hierarchy, the original pattern space is assigned the first level. Thus, a pattern space “tree” is created for organizing the sub-pattern spaces. Generally, each subsequent level in the hierarchy should contain at least as many sub-pattern spaces as the previous level. The same is true for the Target Spaces.

Once the configuration is completed, a source pattern may be selected from a set of patterns (step 6-5). The source pattern may be similar to those described above with reference to FIGS. 3-5.

At step 6-6, a counter is created for “processing” of the source pattern through each level of the hierarchy. In the embodiment illustrated in FIG. 6, the counter is initially set to zero and is incremented by one at step 6-7A to begin the loop.

At step 6-7A1, a pattern space or, once the pattern space has been segmented, a sub-pattern space is chosen for processing. At the first level, this selection is simply the pattern space defined in step 6-1B. At subsequent hierarchical levels, the selection is made from sub-pattern spaces to which the segmented source pattern is assigned, as described below with reference to step 6-7A4.

At step 6-7A2, the features from the source pattern at the selected sub-pattern space are extracted. The extraction may be performed according to the method defined in step 6-3. The features may then be enumerated according to any of several methods.

At step 6-7A3, steps 5-2A to 5-2G of FIG. 5, as described above, are executed. This execution results in a unique mapping of the source pattern to a unique set in the target set space.

At step 6-7A4, the source pattern in the selected sub-pattern space is then segmented according to the method defined in step 6-2A. Each segment of the source pattern is assigned to a sub-pattern space in the next hierarchical level.

Steps 6-7A1 to 6-7A4 are repeated until, at step 6-7A5, it is determined that each pattern space in the current hierarchical level has had its target pattern recognized. Thus, one or more sub-pattern spaces are assigned under each pattern space in the current hierarchical level.

This process described in steps 6-7A to 6-7A5 is repeated for the source pattern until the final level in the hierarchy has been reached (step 6-7B).

It is noted that, although the nested looping described between steps 6-7A and 6-7B may imply “processing” of the source pattern in a serial manner through each sub-pattern space at each level, the “processing” of the sub-pattern spaces may be independent of one another at each level and may be performed in parallel. Further, the “processing” of the sub-pattern spaces at different levels under different “parent” pattern spaces may also be performed independently and in parallel.

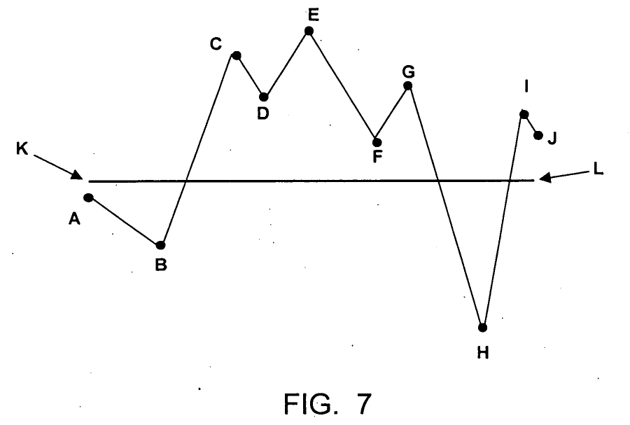

The application of the Numgram attractor process to waveform analysis is illustrated below with reference to FIG. 7. FIG. 7 shows a simple waveform which may be understood as a plot of amplitude of some variable or observable against time. The significant points for discussion are labeled A-J, and the central t=0 axis for the waveform is defined between end points K and L. Note that each significant point A-J is either a terminator point (points A and J) for the wave segment under consideration, a global maximum (point E), a global minimum (point H), local maximum (points C, G and I) or a local minimum (points B, D and F). FIG. 7 will be used extensively as a representative example. The heavy dots adjacent the points in FIG. 7 will generally be omitted in the remaining drawings.

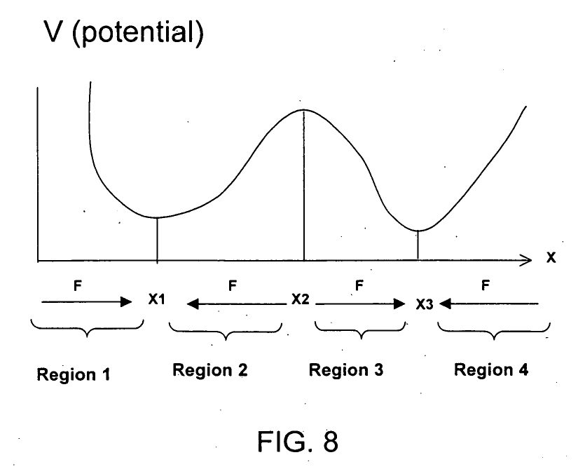

The significance of describing waveforms by their maxima and minima is that the segmentation of the waveform into regions defined by such maxima and minima permits one to study the qualitative nature of the waveform and thus the underlying “reality” that is being studied. In physics, for example, forces are often studied as gradients of potential fields. FIG. 8, shown a plot of the potential as a function of distance and contains, as an example, one maximum value at point x2 and two minimum at points x1 and x3. The directions of the forces produced as a result of this potential field (i.e., the negative gradient of the potential) are illustrated by the arrows below the graph. It may be seen that the maximum and the two minima values organize the qualitatively nature of the potential into the four regions shown in FIG. 8. The direction of the force changes upon passing through these minima and the maxima points. Knowing the location of these points and the direction of the force in any one region, gives a full qualitative description of the potential. In catastrophe theory, these minima and maxima are called isolated or non-degenerate critical points. For a more detailed discussion of catastrophe theory, reference is made to Catastrophe Theory for Scientist and Engineers, by Robert Gilmore, Dove Publications, Inc. 1981, the whole of which is incorporated herein by reference. The above discussion is modeled after Gilmore's discussion on pages 52-53.

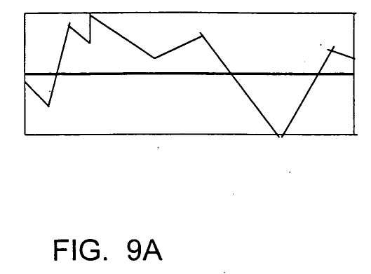

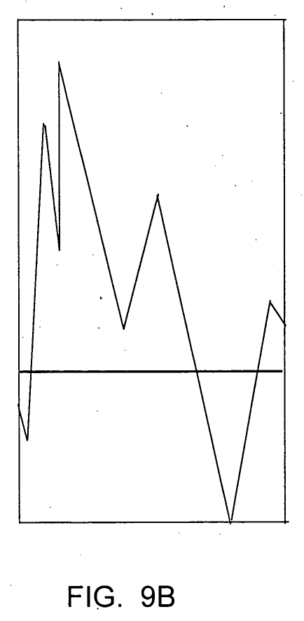

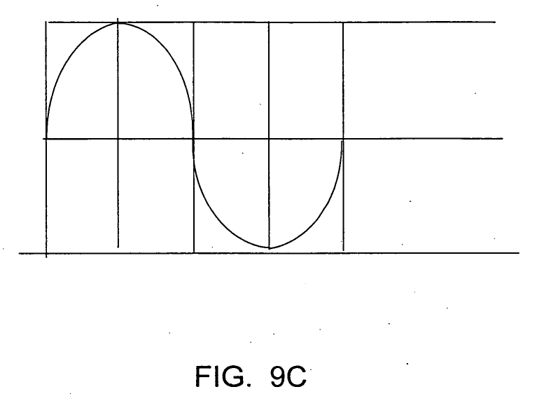

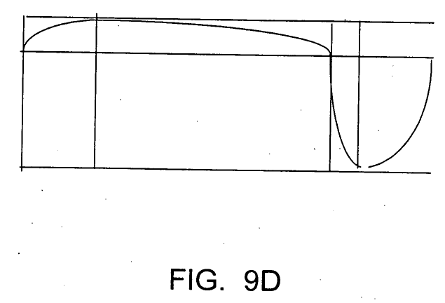

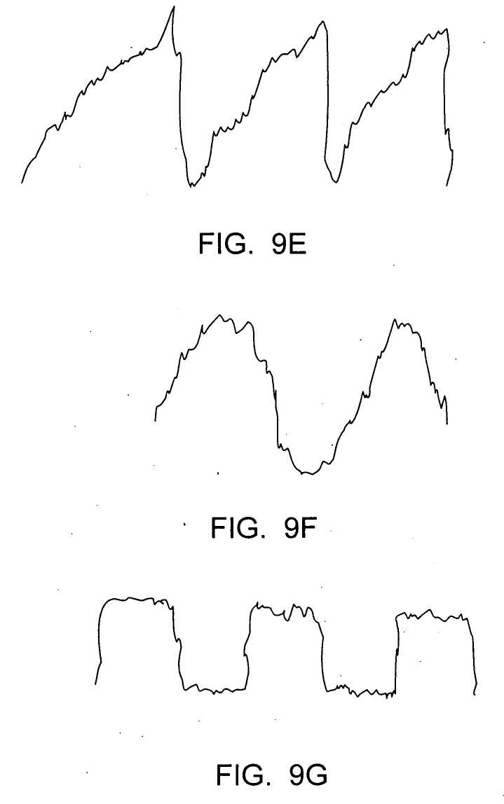

One thus wishes to describe the qualitative properties of the waveform such that the description extracts the ontology of the waveform and permits comparison of different waveforms and/or different waveform segments with one another. The standard technique of simply sampling the waveform to provide a digitized representation of the waveform is not useful for this intent since while it produces a string of numbers directly mapped from the original analog input signal, it does not permit facile comparison of the ontology of one waveform or waveform segment as compared to another because variations in scaling both in amplitude and time will make the resulting waveforms look quite different and have vastly different numerical values, thus obscure the true ontological relationships This point may be illustrated by examining FIGS. 9A and 9B which show the waveform of FIG. 7 with different scale factors applied to all or portions of the amplitude and time axes. The resulting waveforms look quite different, and while one may be able to decipher similarities in the waveforms in this simple example, in a practical case having thousand of local minimia and maxima, the task would be quite difficult if not impossible.

Another example of distortion is shown in FIG. 9C which has a maximum and minimum and zero crossing at regular (evenly distributed) intervals along the x axis. FIG. 9D shows the same graph plotted on a space with a non-uniformly distributed tiling scheme. It may be seen that the curve of FIG. 9D is grossly distorted with respect to the original shape. However, in a topological world, these two curves are the same, that is they have the same qualities as defined by their maximum and minimum points. Thus, the value of describing waveforms by their quality, namely by their max/min, permits a description which is invariant under affine transforms. The two waveforms of FIGS. 9C and 9D may be recognized as qualitatively the same waveform, and from the point of view of topology and pattern recognition, this is a very important recognition. The two waveforms, described according to an alphabet that extracts the ontology of waveform according to their maximum and minimum values, as discussed below, will interact with the Numgram attractor process in a similar way so that they will have identical or closely identical token strings (depending on the resolution level), and thus the waveforms will be ranked in the same region of the analytic space. It is noted, however, that adding slope as a further description of the waveform enhances resolution and will permit inverting the alphabet coding of the waveform to not only reproduce the max/min values but also the slope values between points and thus more accurately reproduce the shape of the waveform. In terms of catastrophe theory, the min/max analysis provides a determination of the germ terms of Gilmore's table 2.2 (as explained in Gilmore and also below) whereas the added slope analysis in the sorted analytic space will permit parameterization of the germ terms.

The waveform of FIG. 9D illustrates distortion, and distortion is a common problem in communications such as optical fibers and other areas. The waveform distortions correspond to increases and decreases in propagation speeds. Being able to recognize a distorted waveform as the same ontologically as a non-distorted waveform is of tremendous value in communications.

Recognizing one waveform as being the same ontologically as another has a lot to do with resolution. Resolution, in turn, has to do with being able to compare the relative amount of feature scope with other features. Resolution is a structure for organizing information by the magnitude or scope of description. Such organization is illustrated in detail below by the hierarchical extraction of the minimum and maximum values of a waveform. Resolution is important in all fields of information. In the communications environment, one must be able to distinguish which features of the waveform belong to the propagator (i.e., the medium) and which features belong to the propagated signal. In reference to FIGS. 9E-9G one can see three waveforms. If one describes waveform 9E at a one particular level of resolution, one may say that it has some rapidly changing spikes and valleys. But this level of resolution would not serve to differentiate the waveforms of FIGS. 9E-9G from one another as they are all equivalent at this level of description. This level of resolution is very high since it sees the rapid min/max changes within very small time (or more generally x axis) intervals. If one lowers the resolution by ignoring all small changes (i.e., filtering them out) one can then see an overall pattern of the three shapes, and one can characterize FIG. 9E as a distorted sawtooth wave, FIG. 9F as a distorted sine wave and FIG. 9G as a distorted square wave. At this lower or coarser level of resolution, one is able to extract gross patterns which were not visible in the higher or finer resolution description. The wave patterns are then differentiable at this lower or coarser level of resolution where they were not differentiable using the example description of the higher or finer level of resolution.

This example illustrates that resolution at its essence is not concerned with changes in scale or a numerical description. Resolution is a structure for organizing information by the magnitude or scope of description. In describing the ontology of a waveform, we want to organize the description according to levels of resolution which are imbedded within one another. In this fashion, one can easily rank and sort waveforms because they are described using a common hierarchical, embedded description going from the lowest level of resolution to higher and higher levels (or rings) of resolution.

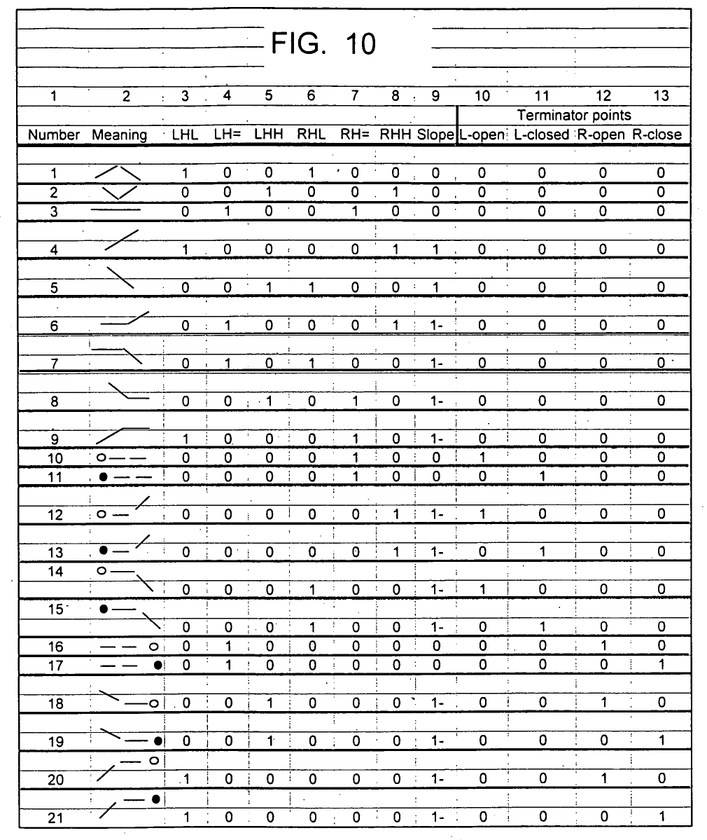

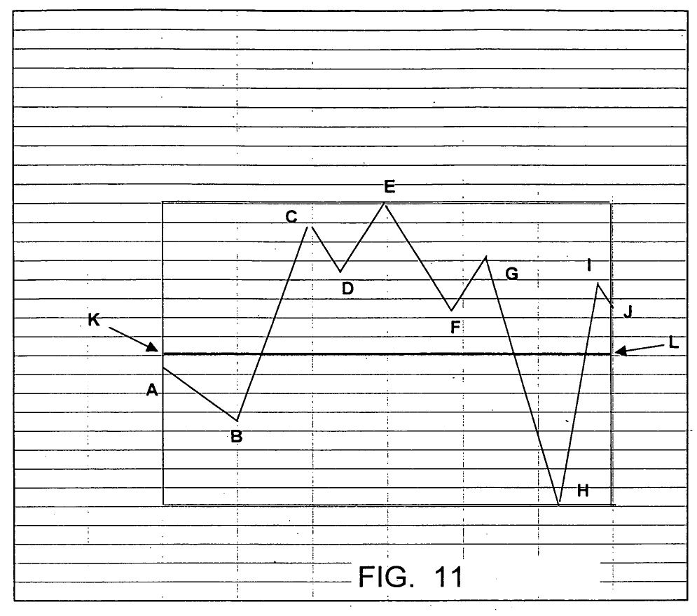

Thus, it is first necessary to build a language to describe the essence or ontology of a waveform. Language consist of an alphabet and a syntax. One begins by developing an alphabet which focuses on the qualitative characteristics of the waveform. Consider a waveform consisting of sequential points. With this in mind, one can recognize that any selected point on the waveform may be characterized, not by its absolute value (as this is a scale variant attribute and of little use here) but rather by asking what are the characteristics to the left (predecessor) and right (successor) of the selected point. The points to the right and left of the selected points may be relatively higher, relatively lower or may be unchanged at any given level of resolution. Each point may in principle be so characterized. These attributes and their various combinations are shown in the first nine rows of FIG. 10.

FIG. 10 is a truth table describing the essential qualities of a series of three points on the waveform as considered form a central selected point and an examination of the points to the left and right of the selected point. For example in row 1, a maximum is described as a point having the points to its left lower and the points to its right also lower. This is a point of zero slope. Thus a “1” is placed in columns 3 and 4 headed “LHL” (Left Hand Lower) and “RHL” (Right Hand Lower) respectively. A zero is placed in the other columns. Table 14 below describes the symbols used in columns 3-13 of FIG. 10.

TABLE 14

| | |
|---|---|
| LHL | Left Hand Lower |
| LH = | Left Hand Equal |
| LHH | Left Hand Higher |
| RHL | Right Hand Lower |
| RH = | Right Hand Equal |
| RHH | Right Hand Higher |
| Slope | Does line have slope |
| L-open | Left hand terminator point is open |
| L-closed | Left hand terminator point is closed |
| R-open | Right hand terminator point is open |
| R-closed | R hand terminator point is closed |

As seen from Table 14 and FIG. 10, the second row represents a minimum, the third row represents an unchanged line segment, the fourth row represents a positive slope and the fifth row a negative slope. Row 6 represents a change from equal to higher and row 7 from equal to lower. Row 8 represents a change from higher to equal and row 9 from lower to equal. Row 10 represents an open terminator point, that is a point at which the left hand point (from a selected “center” point) is not in the set under consideration, and line 11 represents a left hand point which is closed, meaning the left hand point is part of the set. One may make an assignment (by definition) that an open terminator points indicates that the waveform segment under consideration is an interior segment of the wave whereas closed terminator points indicates that the waveform segment under consideration is a beginning or end segment of the waveform. (Other assignments or definitions could be adopted such that left terminator points should be open and right terminator points should be closed; consistent application of the rules is the important criteria.) Lines 12-21 have clear meaning as seen from the Table 14. These rows will be referred to as pattern numbers or simply patterns.

The “slope” indicator of column 9 has been designated with values “0”, “1” and “1−”. The 0 and 1 imply that there is zero slope or some non-zero slope respectively. The symbol “1−” is used to indicate that in the case of pattern 6, for example, the value of the slope is less than that associated with say pattern 4. While the further description below does not utilize slope as a distinguishing characteristic, an alphabet could be developed that does use slope as well as the value of the slope to further refine and specify a waveform description and its corresponding alphabet.

Utilizing the value of slope to enhance resolution would serve to enhance the resolution in both the x and y axis. Since the essence of a waveform is a series of numbers in both x and y axes, one could specify a resolution for each axis. In an amplitude vs. time waveform, the x axis can be understood as where is “here” and corresponds to “place” resolution; and the y axis could be understood as what label (scale value) do I put at that particular place, and thus corresponds to label resolution. Building an alphabet with place and label resolution, or equivalently, with values of slope (e.g., 0 to 360 degrees or some other measure), offers an enhanced resolution description of the waveform. This example illustrates that the selection of the alphabet is not unique and one may use one alphabet which is a subgroup of a larger alphabet and the sub-group may be sufficient for the particular problem at hand whereas another sub-group may be used for another problem where the user has a different intent.

The fact that there is no unique alphabet should not be surprising. Humans can communicate in many different languages and each has it's own alphabet and syntactical structure. Computers likewise have different programming languages. At one level, mathematics is also simply a language. However, mathematics is a formalized structure for extracting alphabets, syntaxes and for expressing semantic statements in a rigorous way such that there is no ambiguity in meaning. This lack of ambiguity represents a big difference between mathematics and other common spoken languages. In this sense, mathematics has nothing to do with “numberness”. The statements you make in math are able to be formally resolved and affirmed as true or false by a very specific methodology. The alphabet definitions in FIG. 10 are an example of precise mathematical meanings associated with the ontology of all waveforms.

The set of rules governing the use of the alphabet, such as the formation of words, phrases and sentences, is called a syntax. Using an alphabet and a syntax, meanings are created and assigned to characters as the result of syntactical use.

One now needs to apply certain syntactical rules to the waveform of FIG. 7. The rules will permit one to identify and extract the alphabet patterns of FIG. 10 in an orderly and consistent way from the waveform of FIG. 7. We are particularly interested in using the alphabet to provide a hierarchical segmentation of the waveform as such segmentation is at the foundation of being able to describe the waveform at different levels of resolution.

One first normalizes the waveform so that the global maximum and the global minimum define the upper and lower limits of the scale. This is denoted in FIG. 11 where a line has been drawn to represent the highest scale value which matches the amplitude of the maximum point E and another line has been drawn to represent the lowest scale value which matches the amplitude of the minimum point H. Selecting the maximum and minimum and using these to provide an initial normalization produces a self referential system. In this process one always looks from the total system to the details. Comparisons to other waveforms are always done in relation to the normalized global maximum and minimum points of these other waveforms so the each waveform is self-referential. FIG. 11, also shows vertical bounding lines at the endpoints K and L indicating that one is only considering the set of numbers or attributes of the waveform within the bounded regions.

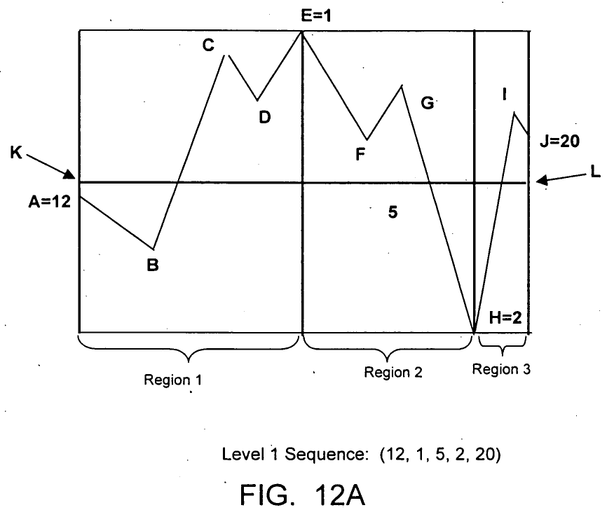

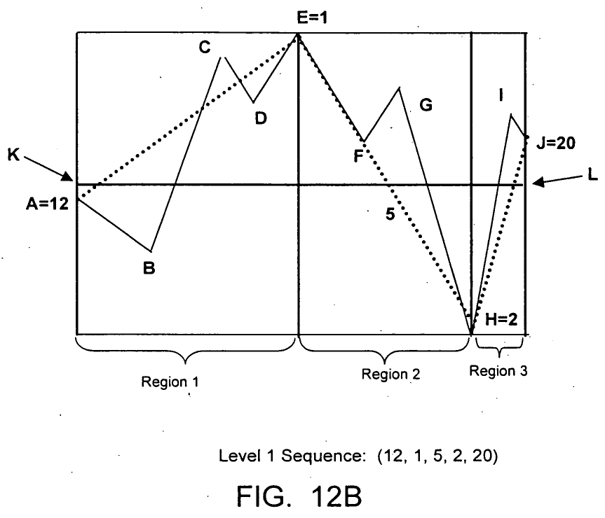

One now uses the global maximum point E and global minimum point H together with the terminal points A and J to divide the waveform into three regions as shown in FIG. 12A. This level of resolution is the lowest (or coarsest) level of resolution. One ignores all points except points A, E, H and J. All other points are not yet “visible” and will become “visible” at higher (or finer) levels of resolution as will be seen below. For the present time, however, one needs only characterize the behavior of the waveform using the identified points A, E, H and J.

Point A is a terminal point and points to the left of point A are not in the interval (set) under consideration. Thus, while there exist points to the left of point A, these points exist as part of another waveform segment and do not exist in the segment under consideration, i.e., FIG. 7. Thus, point A is represented as a Left-Open point meaning that there is an open interval to the left of point A. Thus, according to FIG. 10, the possible alphabet choices for open intervals on the left are patterns 10, 12 and 14. Looking at the point to the right of point A is point E, and point E is higher than point A. Thus, looking at the shape of the waveform, it is appropriate to extract the pattern number 12 to represent the shape of the waveform in the vicinity of point A. If point A (J) were the beginning (end) of the waveform pattern such as the first (last) vibrations present at the start of a speech recognition application, then point A (J) would be closed on the left (right).

The next part of the waveform is identified by the maximum point E and the shape the waveform in the vicinity of point E is seen to be pattern 1. Thus, the pattern sequence so far is (12, 1).

The next point is point H which is the global minimum and is easily seen to corresponds to pattern 2. However, between point E and H one characterizes this region with the pattern 5. This characterization is important to distinguish the present waveform, in which only a single global maximum and a single global minimum are found from the more ambiguous case, in which the global maximum may extent over an entire interval and there is no unique point corresponding to the maximum. The same ambiguity may be true for the minimum. Thus, in order to characterize that there are no further global maxima or global minima between the points E and H, and thus that the maximum and minimum values are unique, the alphabet pattern 5 is utilized to describe the region between the unique maximum and unique minimum. Thus, the pattern sequence one has developed so far is (12, 1, 5, 2).

The next point is the terminal point J. Similar to the analysis of point A, the terminal point J is open, but now it is open on the right, leaving the possibility patterns according to FIG. 10 as 16, 18 and 20. Since the point to the left of terminal point J is the unambiguous global minimum point H, it is appropriate to chose pattern 20 to characterize point J. Thus, the first level pattern sequence for the waveform of FIG. 12A is (12, 1, 5, 2, 20)

Thus, at the first level of resolution, one can trace a linear path from the left most terminal point, then to the global maximum, then down to the global minimum without any additional maximum or minimum points in between, and finally to the right hand terminal point. This first resolution level of the waveform is shown by the dotted lines in FIG. 12B connecting the points A, E, H and J. So, at the first level of resolution, one has described the general shape of the waveform.

In the description below it will sometimes be convenient to reference FIGS. 12A and 12B simply as FIG. 12 where, from the context, one does not need to differentiate between the two figures. In a similar fashion, other figures discussed below and labeled with the suffix A and B will sometimes be referred to collectively simply by their figure number without the suffix.

One next seeks to describe the waveform within each of the three region provided by the initial segmentation. Within each of these three regions one finds the global maximum and minimum values existing within each of the regions.

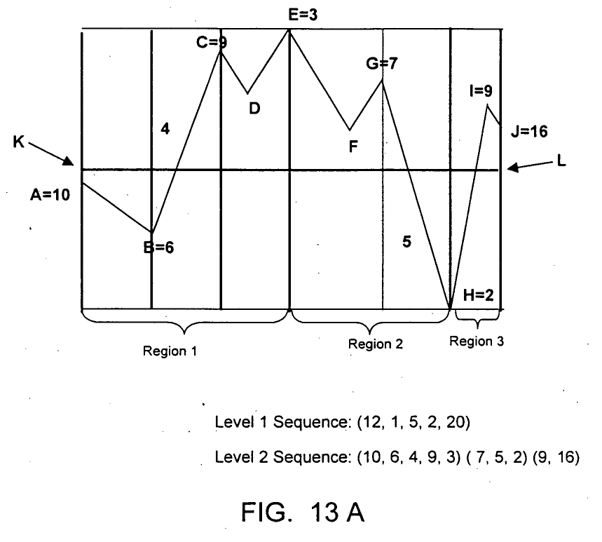

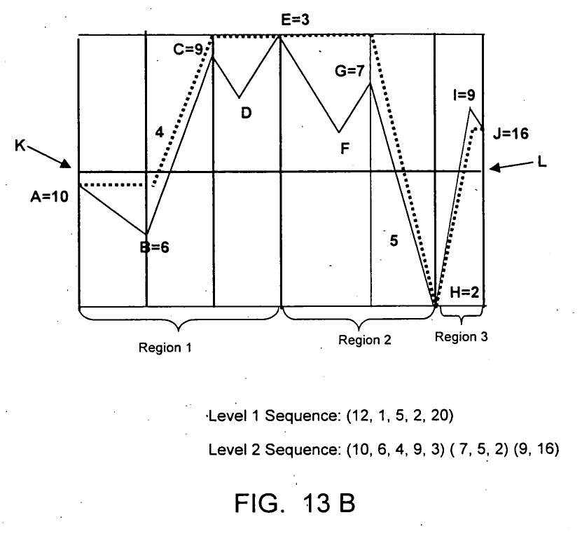

Reference is made to FIG. 13A in which the second level of resolution is illustrated. For this next level of segmentation, one cuts the field defined by the waveform amplitude in half, forming a segmentation line or meridian connecting points K and L. One may adopt a syntactical rules that starts from a selected point and recognizes a point to the left or right as being lower or higher when the line connecting that point to the selected point crosses the meridian. Again, at this level of resolution, one can see only the minima, the maxima, within the regions, the terminal points and, of course, all of the previously seen points since increasing the resolution retains the prior points, although perhaps with a different pattern extracted. It may be seen that the first level of resolution is lower than the second level and the second level is imbedded within or nested within the first level. This same hierarchical nature of the embedding of different levels of resolution is repeated throughout. One level imbeds within the next higher level. The waveform is examined at different levels of resolution and thus a level or ring of resolution corresponds to a first, second, third, etc., resolution examination of the series of discrete points that make up the waveform.

Point A is still recognized as a terminal point, but now point B, a local minimum within region 1, is recognized to its right. Point B is on the same side of the meridian K-L as point A and thus point A is characterized at this level of resolution by the pattern 10. The local minimum point B sees point A to its left as having the same value as itself and sees the local maximum, point C, as being higher since the line connecting point B to point C crosses the meridian. Thus, point B is assigned pattern 6. Again, however, since points B and C are single points (i.e., they define an unambiguous minimum and maximum) we assign pattern 5 for the line joining the terminator point A to point B. We do not assign a pattern 4 to the line crossing the meridian going from point B to point C because one does not know whether or not point A is a maximum.

Point C itself has a lower point (point B) to its left (it is lower at this level of resolution since it crossed the meridian) and an unchanged value (point E) to its right. Thus, point C is assigned alphabet pattern 9. Point D is not visible at this level of resolution so it is ignored.

Point E sees point C to its left and point G, the local maximum for region 2, to its right. Both points C and G are above the meridian as is point E. Thus, at this level of resolution, pattern 3 is extracted for point E. Point E is taken as part of region 1 as part of an adopted syntactical rule which is to consider the right end point of a region within the region. Alternatively, the right end point could be considered part of the next region as long as one was consistent.

Within region 2 of FIG. 13A, there is only one maximum value at point G. Point G can see only point E to its left which is on the same side of the meridian as itself and thus represents a constant or “equal” value within the defined alphabet of FIG. 10. To the right of point G is point H and the line between them crosses the meridian. Thus, point G is assigned alphabet pattern 7. Since, point G is unambiguously a maximum within the region 2, we assign a pattern 5 to the line between point G and H. Point H sees point G as being higher and to its left and sees point I as being higher and to its right. Thus, point H is again assigned pattern 2.

In region 3 the points I and J are not resolved at this level of resolution. Point I is labeled 9 since is “sees” a lower point to its left (point H is lower since it is on the opposite side, namely below, the meridian, from point I) and a constant point J to its right (J is constant since it is on the same side of the meridian as point I). Point J sees an open region to its right and sees I as equal and to its left. Thus, J is labeled 16. A segment 4 is not assigned to the line connecting points H and I since at this level of resolution, point J is not lower than point I.

Thus, at this second level of resolution one has developed the sequence:
Level 2 Sequence: (10, 6, 4, 9, 3) (7, 5, 2) (9, 16).

FIG. 13B shows the waveform traced in a dotted line which is the waveform described at this second level of resolution. Note that it is closer to the actual waveform than is the dotted line of FIG. 12B. For the waveform description in accordance with FIG. 13B, one starts from the terminator point A, and knows that there is a point B to the right, but point B is seen as the same value as point A (thus is drawn as a zero slope dotted line). One then goes to points C, G, E, H and I as points D and F are not yet seen. However, points C, E and G are indistinguishable and thus are all drawn at the level of the previously determined global maximum value of point E. Likewise, points I and J and not distinguishable and thus one draws the dotted line for point I at the same level as the previously determined point J. The dotted line then represent the waveform at this second level of resolution.

It is noted that the above sequence groups the numbers of each level in parenthesis. The end points E and H can be considered part of the regions to their left or right and this is one of the syntactical rules that can be devised. We have chosen to consider these “border” points as belonging to the region on their left. Consistency of application of these syntactical rules is highly important.

It should be recalled that the segmentation process is self embedding and hierarchical so that the level 2 sequence is itself embedded within the level 1 sequence which is:
Level 1 Sequence: (12, 1, 5, 2, 20).

The waveform sequence so far developed is:
Waveform sequence: (12, 1, 5, 2, 20) ((10, 6, 4, 9, 3) (7, 5, 2) (9, 16))

The double parenthesis indicates the beginning and end of the second level of resolution.

One now continues the segmentation of the waveform until all points are given an alphabet pattern that is consistent with the level of resolution chosen. If one is not interested in a high level of resolution, one could stop the segmentation process here with the waveform sequence being defined as above. In this situation, it is understood, that certain points can not be resolved and this may be acceptable for certain applications. For purposes of illustration, we will continue the segmentation example until all points are resolved as having a right or left hand point that is either higher or lower and thus has crossed some segmentation line. It is important to note, however, that such continued segmentation is not always necessary. Whether or not to continue segmentation to a given revolution level depends on the intent of the user and the demands for high resolution in the domain space of interest.

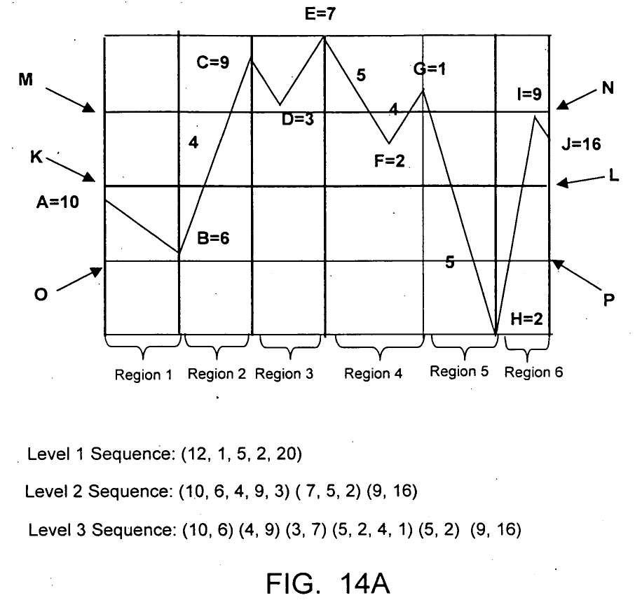

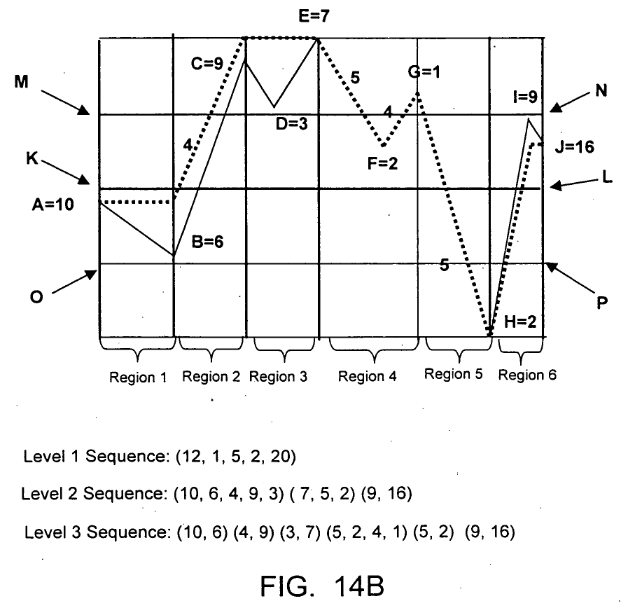

FIG. 14A is similar to FIG. 13A and shows a further segmentation of the vertical axis by lines M-N and O-P. Each of these lines divides the prior space into two regions so that there are now four vertical regions. FIG. 14A also shows the six region defined by looking at the maxima and minima values within each of the previous regions 1-3 of FIG. 13A.

In reference to FIG. 14A, only the border point B represents a minimum within region 1 and the line connecting points A and B do not cross any segmentation line. Thus, point A is assigned pattern 10. Point B sees point A to its left at the same value as itself and point C at a higher value since the line between points B and C crosses the meridian K-L (as well as M-N). Thus, point B is assigned a pattern 6. Since it is unknown whether or not point A is a maximum, one does not assign a 5 to the line joining points A and B.

In region 2 of FIG. 14A, point C is the only point and is seen to be a local maximum. To characterize point C, we must look to the point D to its right.

In region 3 of FIG. 14A, point D is visible as a local minimum. Point C sees point B lower and to the left and point D at the same level and to the right. Thus, pattern 9 is extracted for point C at this level of resolution. Again pattern 4 connects the unambiguous local minimum and maximum points B and C.

Point D sees point C to its left at the same level and point E to its right, also at the same level. The line connecting these points to point D does not cross the new segmentation line M-N and thus no change is seen by point D looking either left or right. Thus, pattern 3 is assigned to point D.

Point E sees point D to its left at the same level and point F, the local minimum of region 4 lower and to its right. Point F is seen lower since the line connecting point E and F crosses the segmentation line M-N. Thus, pattern 7 is extracted for point E. Since E and F are unambiguous maximum and minimum, a pattern 5 is extracted to represent the waveform connecting these two points.

Point F, the local minimum of region 4, sees point E higher and to its left and point G higher and to its right. Thus, pattern 2 is extracted for point F.

Point G sees point F lower and to its left and point H lower and to its right. Thus, point G is assigned pattern 1. Again, pattern 4 is inserted to describe the line connecting the unambiguous minimum and maximum values for points F and G.

In region 5, the only point visible is the border point H which is seen to be a local (and global) minimum. Point H sees point G to its left and higher and point I, in region 6, to its right and higher. Thus, pattern 2 is extracted for point H and slope pattern 5 to the waveform segment connecting points G and H.

In region 6, point I sees point H to its left and lower and terminator point J to its right and at the same level. Thus, pattern 9 is extracted for point I and pattern 4 again used for the shape connecting the unambiguous minimum and maximum points H and I.

Finally terminator point J sees point I to its left at the same level and an open right hand interval. Thus, pattern 16 is maintained for point J.

Thus, at this third level of resolution the sequence is:

Level 3 Sequence: (10, 6) (4, 9) (3, 7) (5, 2, 4, 1) (5, 2) (9, 16); and the waveform sequence so far, to this level of resolution is:

Waveform sequence: (12, 1, 5, 2, 20) ((10, 6, 4, 9, 3) (7, 5, 2) (4, 9)) (((10, 6) (4, 9) (3, 7) (5, 2, 4, 1) (5, 2) (9, 16))).

FIG. 14B illustrates the shape of the waveform as a dotted line determined at resolution level 3. At this level of resolution, all points are seen but some of them are not resolved and are thus seen at the same level or value. Points A and B are unresolved as well as points C, D and E and points I and J. The waveform is drawn accordingly.

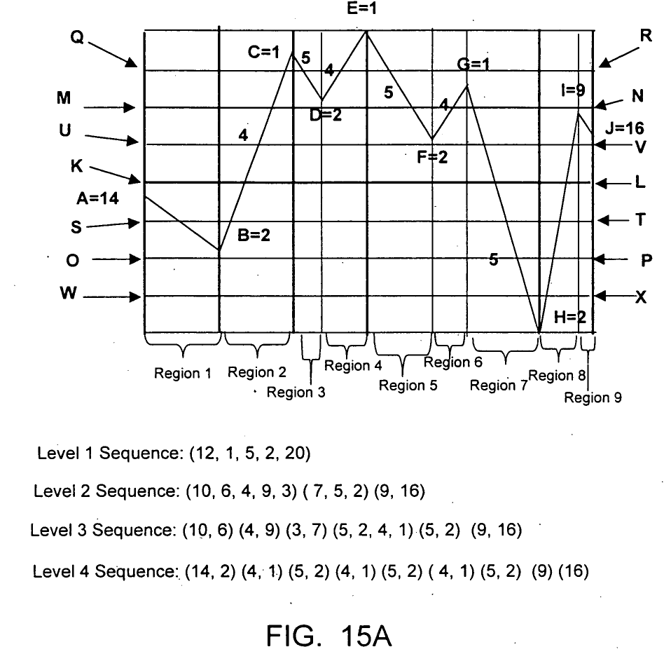

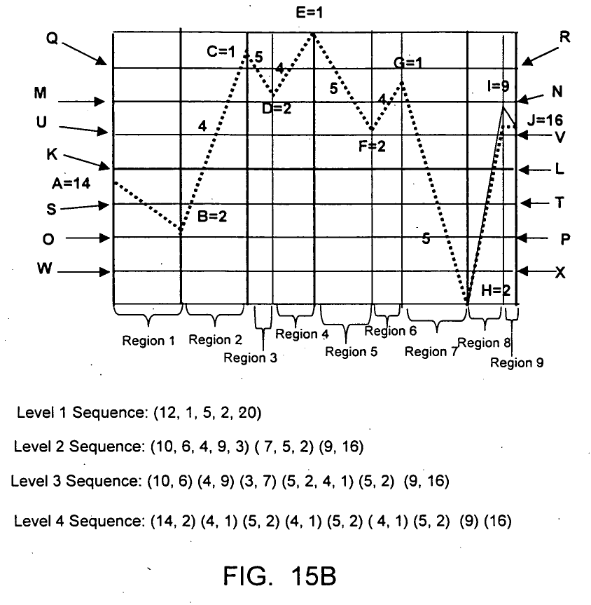

FIG. 15A is similar to FIG. 14A, but illustrates yet a further level of resolution. In FIG. 15A, these segmentation lines are labeled Q-R; S-T; U-V; W-X. The segmentation strategy is to again divide the vertical sectors into half so that there are now 4 segments above the meridian and 4 segments below the meridian. The above strategy is a form of tiling. The maximum and minimum regions defined by points D, F and I result in 9 regions for FIG. 15A. All local maxima and minima now define border points for different regions.

The fourth level of resolution is analyzed in a similar fashion as level 3. Point A sees an open interval to its left and point B to the right is seen as lower because the line connecting points A and B passes across the segmentation line S-T. Thus pattern 14 is assigned to point A.

Point B is a border point included in region 1. It sees point A to its left as higher and point C to its right as higher. Pattern 2 is thus assigned to this point B.

Point C is assigned pattern 1 since it sees point B to its left and lower and sees point D to its right and lower. That is the line connecting points C and D crosses segmentation line Q-R. Since points B and C are unambiguous minimum and maximum values, a 4 is used to describe their connection.

Point D sees point C to its left and higher (the line connecting points C and D passes through segmentation line Q-R) and sees point E to its right and higher. Thus, pattern 2 is assigned to point D. Line pattern 5 connects points C and D.

Point E sees point D lower and to its left and point F lower and to its right. Thus, point E is assigned pattern 1 and line patterns 4 and 5 are used to describe each side of this point since points D, E and F are unambiguous minima and maximum.

Point F sees point E to its left as higher and point G to its right as higher and is thus assigned pattern 2. Again, pattern 5 connects points E to F as unambiguous maximum and minimum points and point 4 connects points F and G as unambiguous minimum and maximum points.

The above pattern may readily be extended to points G and H and to the general case where the resolution is high enough that all points are resolved as being either a maximum, a minimum or a terminator point. Points G and H are easily seen to be described by patterns 1 and 2 respectively with pattern 5 connecting points G and H. Since point I is still not distinguished from point J (they have the same value within this level of resolution), one does not use a 4 to connect points H and I. Only after point I is assigned a pattern 1 does one use the pattern 4 to connect points H and I.

The remaining point I is not resolved as a maximum point at this level of resolution since the terminator point to its right is at the same value as point I. Thus point I retains is 9 pattern assignment and terminator point J retains its 16 pattern assignment. In FIG. 15B, the dotted line shows the waveform at resolution level 4. Note that is follows all the maxima and minima and accurately describes the original waveform except in the region of points I and J.

Thus, including all levels of resolution through level 4, the wave pattern becomes:

Waveform sequence: (12, 1, 5, 2, 20) ((10, 6, 4, 9, 3) (7, 5, 2) (9, 16)) (((10, 6) (4, 9) (3, 7) (5, 2, 4, 1) (5, 2) (9, 16))) ((((14, 2) (4, 1) (5, 2) (4, 1) (5, 2) (4, 1) (5, 2) (9) (16)))), were each parentheses pair indicates higher levels of resolution.

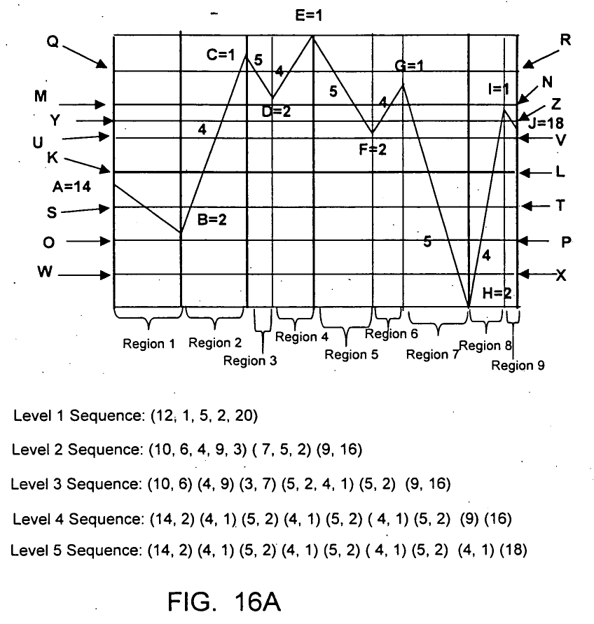

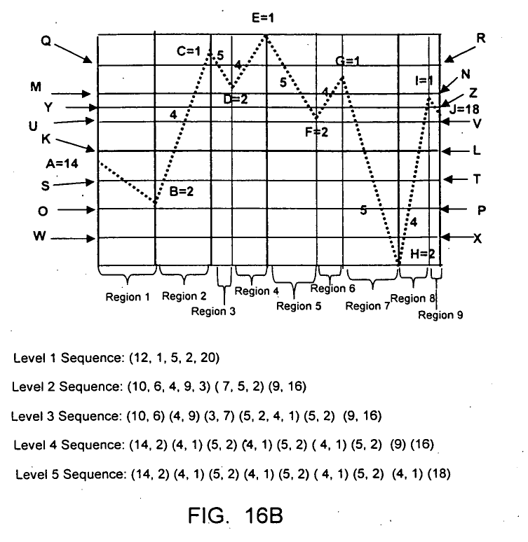

As seen in FIG. 16A, one final level of resolution is need to fully characterize all points. A segmentation line Y-Z divides segmentation lines M-N and U-V and serves to separate out point I from the terminator point J as they no longer are within the same vertical tiling region. Thus, point I will has a pattern 1 and point J a pattern 18. The pattern 4 is now used to label the line connecting points H to I. No further segmentation will yield any further resolution as four levels of resolution has fully resolved all points. All points are now recognized as being a local maximum or minimum value. In FIG. 16B, the waveform pattern shown as a dotted line now overlies the original waveform.

The full waveform sequence incorporating all five levels of resolution is thus:

(12, 1, 5, 2, 20) ((10, 6, 4, 9, 3) (7, 5, 2) (9, 16)) (((10, 6) (4, 9) (3, 7) (5, 2, 4, 1) (5, 2) (9, 16))) ((((14, 2) (4, 1) (5, 2) (4, 1) (5, 2) (4, 1) (5, 2) (9) (16)))) (((((14, 2) (4, 1) (5, 2) (4, 1) (5, 2) (4, 1) (5, 2) (4, 1) (18))))) (Statement 1)

The above sequence is labeled a “statement” since it is really a description of the original waveform using the alphabet of FIG. 10 and a syntax comprising the rules set forth above explaining how to apply that alphabet to extract and label the various points on the waveform. The syntax corresponds to taking the maxima and minima and using them to form regions, considering only those points as being changed if they cross some segmentation line, etc. Statement 1 is a statement in the sense that it describes the waveform just as an English statement describes something. One may, in fact, take the resulting statement and reconstruct the waveform to the same level of resolution as that used in making the statement. It is noted that requiring a crossing the segmentation lines for a point to become visible is actually a parameterization of the sensor used to sense the waveform. It is not part of the alphabet, but is superimpose on the alphabet as a syntactical structure.

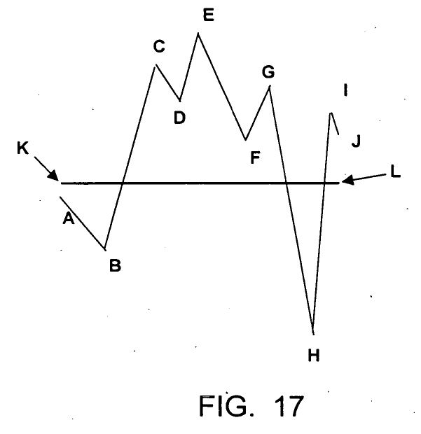

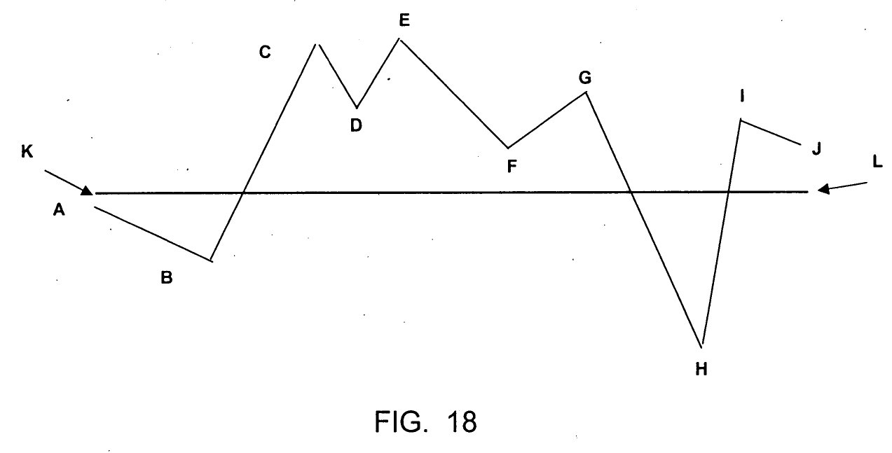

While the above string represents the waveform of FIG. 7, and while no further segmentation will further resolve points on the waveform, there is still room for further characterization of the waveform. This is because in connecting the points in FIGS. 12B, 13B etc, we ignored the slope of the line as a further characterization of the waveform. In the more general case one could, as mentioned above, assign a numerical value to the slope of each line and apply this numerical value or ranges of such values as alphabet symbols themselves. For example, the waveform of FIG. 7 may be expanded or contracted on the time axis corresponding different shapes of the waveform as seen in the time contraction of FIG. 17 and the time expansion in FIG. 18. Characterizing the slope of each line segment will enable a more comprehensive description of the shape of the waveform. The slope value assigned may be quantized to any level of resolution desired. One may use degrees of a circle assigning 0-90 degrees (or any interval of numbers) for positive slope and 180-270 for negative slope (or any different interval of numbers). For example, all lines having slope in the half-open interval [1,0) may be assigned symbol 22, all lines having slope in the interval [2,1) symbol 23, etc. These additional symbols are added to the 21 symbols of FIG. 10. Taking slope into consideration provides a higher resolution view of the waveform.

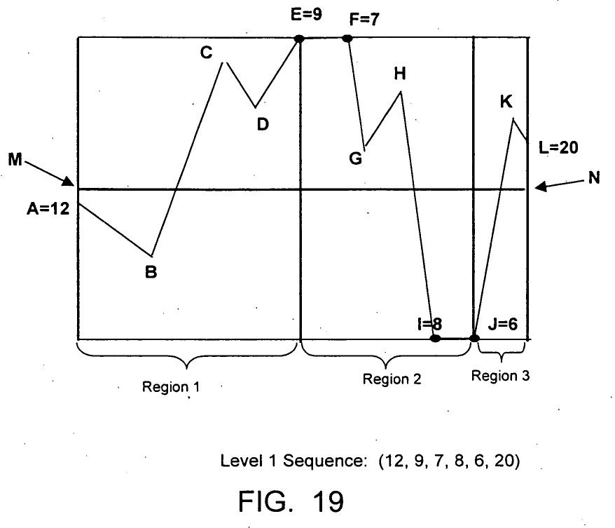

One may now examine extraction of the appropriate pattern and assignment of the alphabet labels to a waveform that includes an ambiguous maximum and/or minimum. FIG. 19 is a waveform similar to that of FIG. 7 but contains an interval at which the maximum value is a constant and an interval in which the minimum value is a constant. Thus, the point at which a maximum and minimum occurs in ambiguous.

In reference to FIG. 19, one can, as a syntactical rule, bound the region of ambiguity by end points E and F for the maxima and by end points I and J for minima. One can then proceed with the labeling of points as before and use the bound points closest to the terminator points to divide the waveform into regions as shown in FIG. 19 However, the 4 and 5 patterns which previously sandwiched the unambiguous maximum and minimum points in FIG. 7 are no longer used in the region of the ambiguous maxima and minima in order to signify that such points are no longer unambiguous.

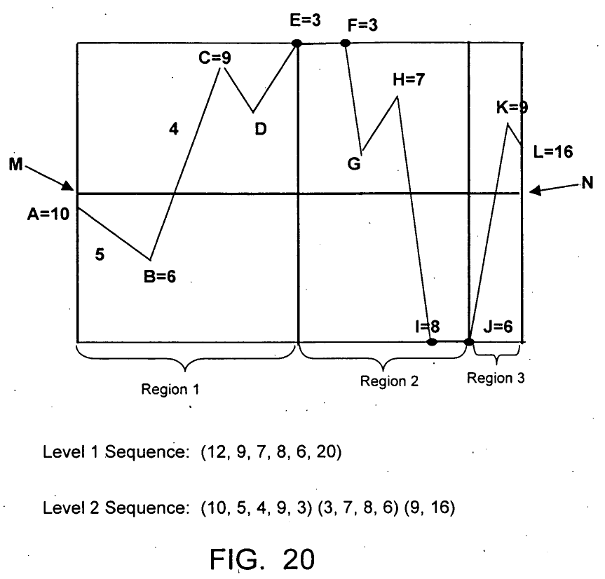

Applying a similar analysis as in FIG. 7, it may be seen that the waveform in FIG. 19 may be described at a first level of resolution by the sequence: (12, 9, 7, 8, 6, 20). In this connection it is noted that point E sees the terminator point to its left as being lower and the end point global maxima point F to its right as equal, resulting in a pattern of 9. The other points are labeled in FIG. 19 and shown as a sequence below the graph. While not all levels of resolution have been developed, FIG. 20 sows the results for the level 2 pattern extraction. One may develop the other levels as done in relation to FIGS. 13-16.

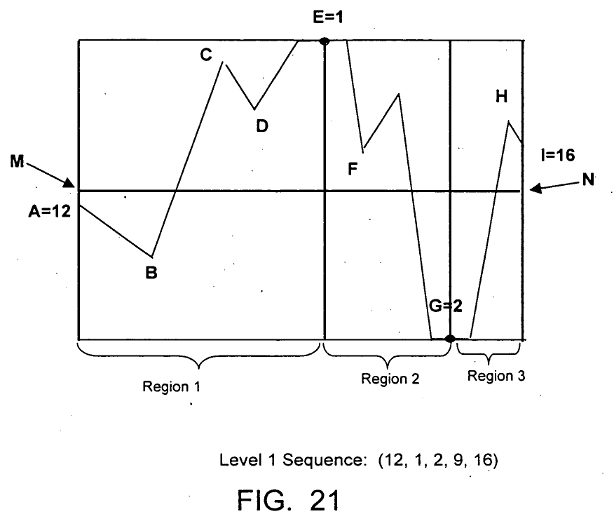

As an alternative embodiment to labeling the end points of the maximia intervals and the minima intervals, one could select the center point of each of these intervals, and consider only these center points in the pattern extraction process. This alternative is shown in FIG. 21. Note again that one does not sandwich the maxima and minima with the slope lines 4 and 5 because the maxima and minima are not unambiguous. As long as one applies consistent syntactical rules, one will be able to make comparisons of one waveform to another.

While a particular alphabet and syntactical structure has been set forth, it is important to realize that other alphabets and syntactical structures could be adopted. For example, one could label the first global maximum with a unique label, the second maximum with another label, the third with a third, etc. Minima could also be so labeled. The alphabet might become quite large with thousands of waveforms maxima and minima, but in principal such an alphabet could be adopted. Using a “minimalistic” alphabet may be elegant and concise, but it is not absolutely necessary.

In the alphabet used in FIG. 10, one could also use another pattern to represent “open parentheses” and yet another to represent “closed parenthesis”. These patterns may be useful for certain applications where one wants the computer or logic circuits to keep track of the level of resolution. Two open parentheses in a row would signify the beginning of the second level of resolution and three open parentheses would signify the beginning of the third level of resolution etc. Strings of closed parenthesis would have analogous meanings. It will be seen below that in one embodiment of the invention, the Numgram attractor process makes use of these levels of resolution, and thus, the computer or logic circuit must track the various levels of resolution.

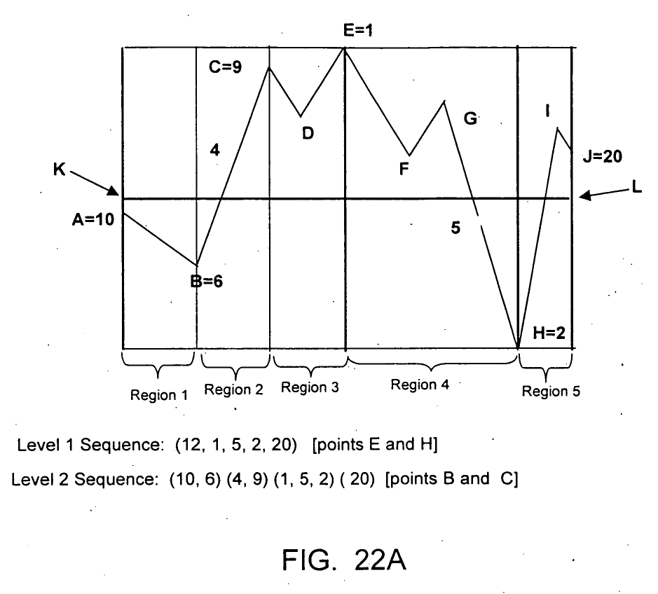

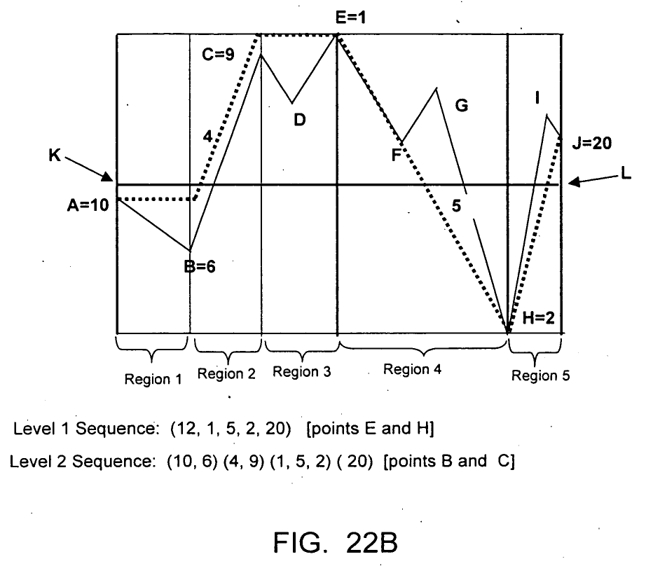

As another preferred example of applying the alphabet of FIG. 10 with different syntactical rules, one may again look at the waveform of FIG. 7 and apply the same rules of normalization and finding the global maximum and minimum points as in FIGS. 11 and 12A. Now however, one uses a different syntactical rule and finds the next global maximum and minimum points considering the waveform as a whole and not separately within each region. Under this syntactical rule, the next global maximum and minimum points are points C and B respectively. Thus, in FIG. 22A, only points A, B, C, E, H and J are seen at level 2 resolution. These points divide the waveform into 5 regions as illustrated. These points may be labeled using FIG. 10 as applied in the earlier examples, and the results are shown in FIG. 22A. Also, FIG. 22B shows the waveform reproduced as a dotted line for this level of resolution. Note that points A and B are at the same value, and points C and E are at the same value at this level of resolution.

The syntactical rules used here are particularly useful in catastrophe theory and are somewhat analogous to and an expansion upon the waveform analysis set forth in Gilmore cited above; see pages 111-140, incorporated herein by reference.

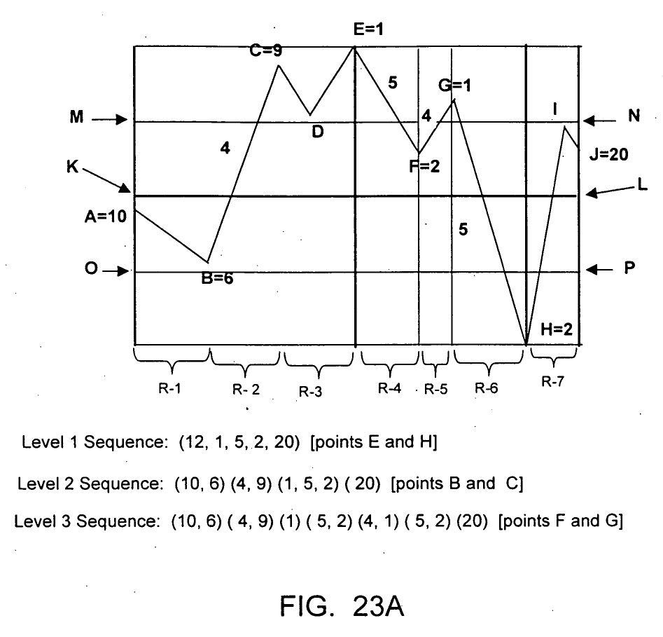

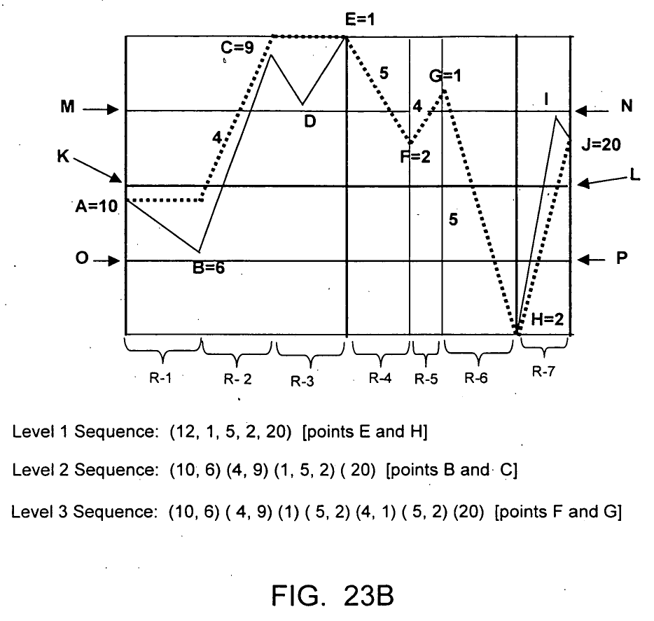

The next level of resolution is seen in FIG. 23A wherein points G and F are visible as the next level global maximum and minimum points. It is noted that these points cross the next level segmentation line M-N. It is noted that if point D were below the segmentation line M-N it would become visible at this level of resolution even though it was not the global minimum for the level of resolution under consideration. The segmentation line O-P is also drawn even thought it is not per se used to resolve any points. The alphabet extracted for the new points G and F are 2 and 1 respectively and the level 3 sequence is shown in the figure. A waveform reproduced as a result of the pattern extracted so far is shown by the dotted line in FIG. 23B. The new point together with the old points divide the waveform into 7 regions labeled R-1 through R-7 in FIG. 23. These regions are used to enclose each level of resolution in a sub-interval to be later used in forming the inverted pyramids when these segments are removed from the right and left of the waveform in building the source multi-sets of FIGS. 2A and 2B.

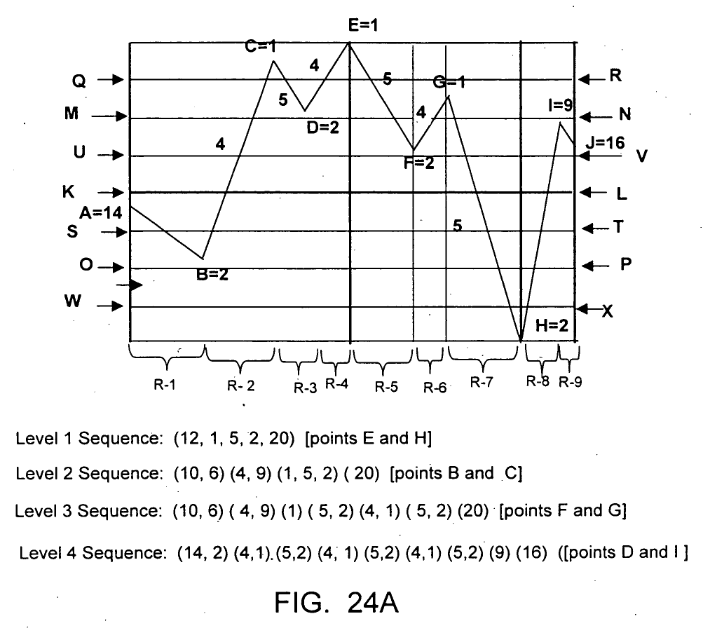

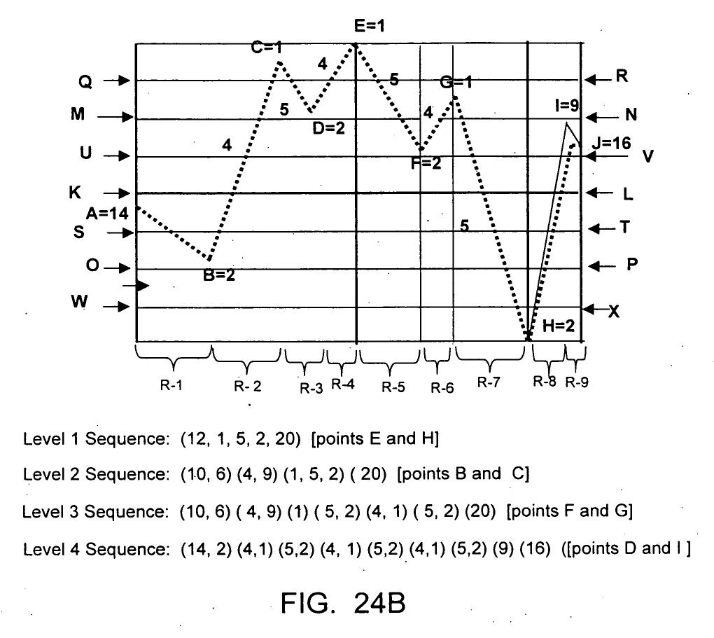

FIG. 24A shows the next level of resolution (level 4) in which points D and I become visible. The alphabet patterns of FIG. 10 are extracted as before. Note, that now point D is seen as the next minimum and that it is unambiguous in that points to its left (point C) and to its right (E) are separated by the segmentation line Q-R. Thus, the labels 4 and 5 are used on either side of point D. In contrast, point I, while visible, is not an unambiguous maximum since the point to its right (point J) is equal in value to it (point I). The pattern for point I is still the same as in the prior level of resolution but the pattern for point J now becomes 16 instead of 20 since point I is now visible (even thought not unambiguously resolvable from point J). FIG. 24B shows the resulting waveform as a dotted line at level 4 resolution.

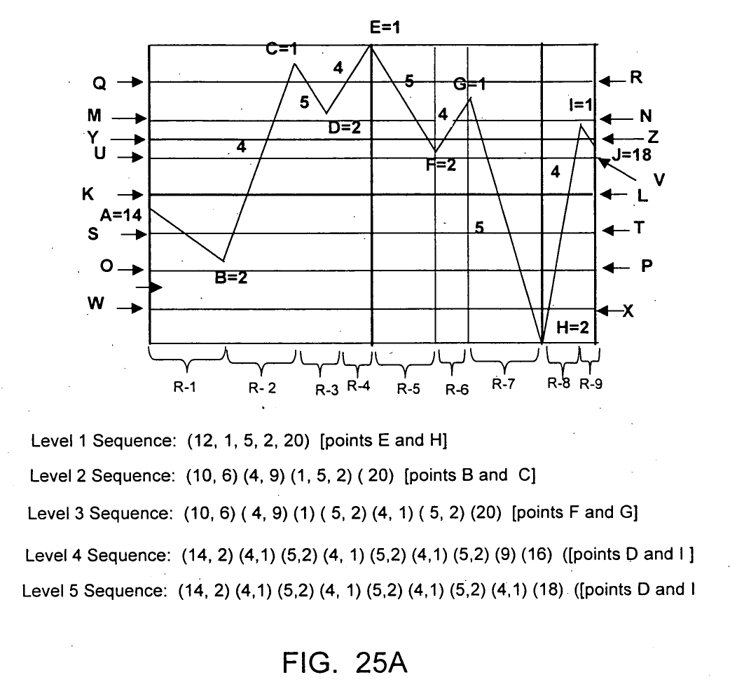

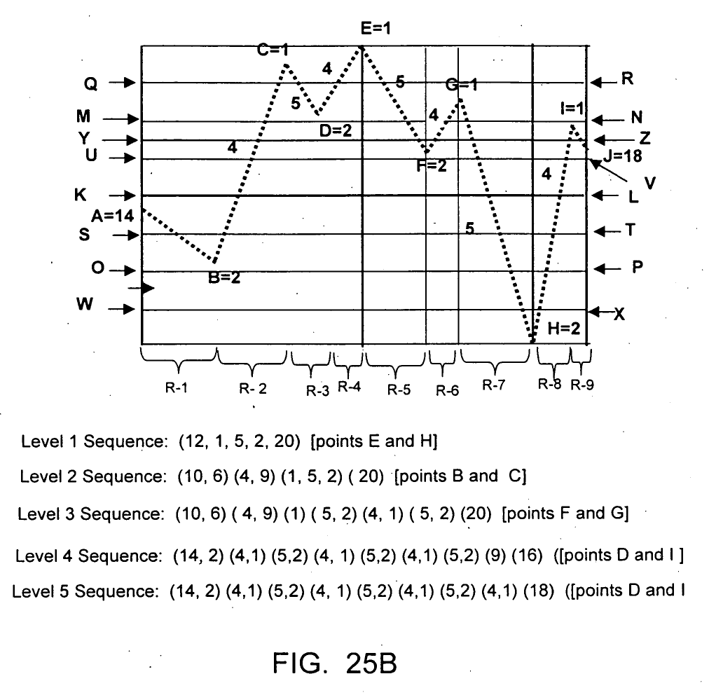

FIG. 25A illustrates the waveform at the fifth level of resolution. Here, it is only necessary to resolve point I from point J and this is accomplished with the next level of tiling using the segmentation line Y-Z. Points I and J are now resolvable with point I having pattern 1 and point J having pattern 18. The resulting dotted line in FIG. 25B shows that the waveform description follows that of the original pattern. Note, however, as explained earlier, there is an implicit assumption that the time interval between points (the x coordinate interval) is known and thus the slopes are not considered. In the general case, the pattern extracted would not exactly overly the original waveform unless slope information, and perhaps other scalar parameters, were also extracted which would amount to a shape parameterization of the waveform. However, the qualitative description of the waveform, that is its topological description as determined from the location of the min/max and its separatrices, is independent of frequency, and such a description (the description without the exact shape parameterization) is sufficient for a large number of problems in which shape-to-shape comparisons are desired to be made without concern for the parameterization of any particular shape, that is without the need to do multi-dimensional scaling. Indeed, the power of the qualitative description is that it is independent of frequency, it is affine independent. The qualitative description permits one to compare structures of waveforms without concern for their values. One can do affine independent matching.

It is noted that the sequences generated using the first syntactical rules which consider the min/max within each region formed from the initial global min/max assignments (FIGS. 12-16) have lot in common with the waveform sequences generated using the second syntactical rules which consider the next global min/max of the waveform as a whole at each further level of resolution (FIGS. 22-25). These differences are illustrated by Table 13 below. The parenthesis are important in demarcating the regions and sub-regions within each level of resolution and thus are important in generating the source multi-sets (inverted pyramids). Thus, these parenthesis carry information which may or may not be important for the particular problem of interest.

TABLE 13

| Resolution | | |
|---|---|---|
| Level | 1^{st} Syntactical Rules | 2^{nd} Syntactical Rules |
| 1 | 12, 1, 5, 2, 20 | 12, 1, 5, 2, 20 |
| 2 | (10, 6, 4, 9, 3) (7, 5, 2) (9, 16) | (10, 6) (4, 9) (1, 5, 2) (20) |
| 3 | (10, 6) (4, 9) (3, 7) (5, 2, 4, 1) (5, 2) | (10, 6) (4, 9) (1) (5, 2) (4, 1) (5, 2) |
| | (9, 16) | (20) |
| 4 | (14, 2) (4, 1) (5, 2) (4, 1) (5, 2) (4, 1) | (14, 2) (4, 1) (5, 2) (4, 1) (5, 2) (4, 1) |
| | (5, 2) (9) (16) | (5, 2) (9) (16) |
| 5 | (14, 2) (4, 1) (5, 2) (4, 1) (5, 2) (4, 1) | (14, 2) (4, 1) (5, 2) (4, 1) (5, 2) (4, 1) |
| | (5, 2) (4, 1) (18) | (5, 2) (4, 1) (18) |

From Table 13 it is seen that at the highest levels of resolution, the sequences are the same. This is not surprising when one realizes that the underlying alphabet and syntax had as its intent the description of the underlying ontology of the waveform which one would expect to be the same once each min/max were fully resolved. The full waveform sequences developed using the first and second syntactical rules will be slightly different since the beginning portions of the sequences will differ owing to the difference in the sequences developed at the low levels of resolution (in the case of Table 13 at levels 2 and 3). Thus, while either (or even other) syntactical rules (and even other alphabets such as including a pattern for open and closed parenthesis) may be used, care must be taken to apply a consistent alphabet and a consistent set of syntactical rules to a given problem so that the domain space and the source multi-sets are defined in a consistent way.

The full waveform sequence using the second set of syntactical rules is as follows:

(12, 1, 5, 2, 20)((10, 6) (4, 9) (1, 5, 2) (20))(((10, 6) (4, 9) (1) (5, 2) (4, 1) (5, 2) (20)))((((14, 2) (4,1) (5,2) (4, 1) (5,2) (4,1) (5,2) (9) (16))))(((((14, 2) (4,1) (5,2) (4, 1) (5,2) (4,1) (5,2) (4,1) (18))))) Statement 2

The choice of using the min/max of the waveform within each region separately (FIGS. 12-16) in accordance with the first syntactical rules (local syntactical rules for short) as opposed to considering the successive global min/max of the waveform as a whole (FIGS. 22-25) in accordance with the second syntactical rules (global syntactical rules for short), depends upon whether one is interested in comparing regions to regions (i.e., a localized comparison) or waveform as a whole to waveforms as a whole (global comparison). In the case where one is trying to do simplex or global optimization, one would chose the second syntactical rules (global comparison) because one needs to know the whole system morphology. In such a case point C in region 12 (see FIG. 12) is qualitatively different than point G in region 2. Thus, if one is interested in the global optimization in terms of performance by finding values in terms of their hierarchy of actual occurrences, then it is appropriate to look at the hierarchical order in terms of total amplitude of the waveform as a whole (global comparison). If, however, one is trying to recognize, for example, a shape within a region or a particular voice pattern (word) within a long waveform (speech recognition application) then one would use the local comparison syntactical rules. In these latter examples, one is not interested in the organizing the absolute amplitudes of the long waveform since the waveform for the shape or voice pattern may exist as large amplitude signals or small amplitude signals, i.e., one can say the word “pumpkin” softly or loudly, and the substantive identification of the word is still the same. Thus, the intent is to find the voice pattern regardless of the amplitude of the signal, and thus one is interested in identifying patterns within local, time-contiguous regions of the long waveform. In such voice recognition problems, one may need to store large quantities of waveform information or one may search for sub-regions of the waveform such as sounds from the letter “p” to the letter “t” and just look at that smaller sub-group. The constraint is generally that of storage capacity and the issue is one of balancing storage capacity vs. efficiency. It is important to recognize, however, that once one describes the waveform using an ontologically appropriate alphabet (such as that of FIG. 10) and with an appropriate syntax (such as the global or local syntactical rules shown above or other syntactical rules) then the qualitative description of the waveform is independent of frequency.

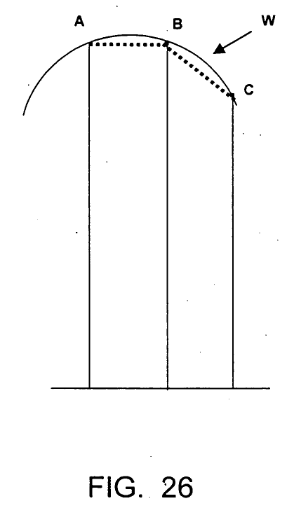

It should also be recognized that the initial waveform under consideration need not exhibit discontinuous slopes at the maxima and minima as the waveform of FIG. 7. The initial waveform may look like FIG. 8. The process of digitizing the waveform will produce a series of discrete values which are used to represent the waveform, and these discrete values may be connected together by straight line segments. This effect is illustrated in FIG. 26 where a waveform segment W is digitized at points A, B and C. These points are connected in straight line segments which approximated the original shape of the waveform to any level of resolution desired, were resolution here would be a function of the A/D converter sampling rate.

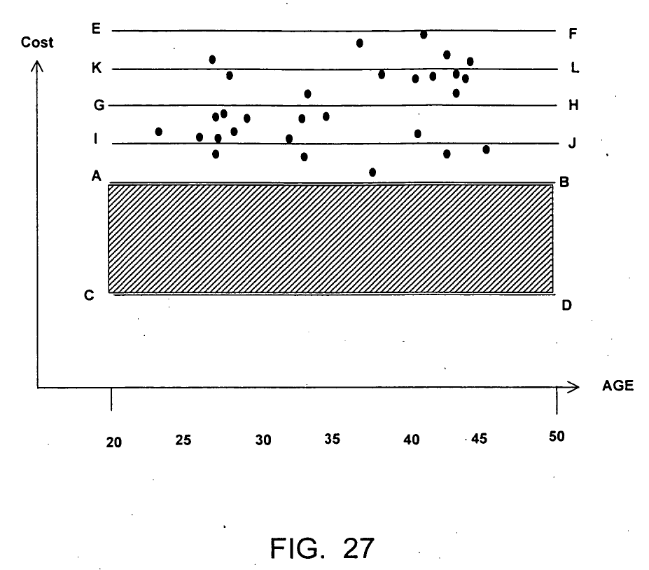

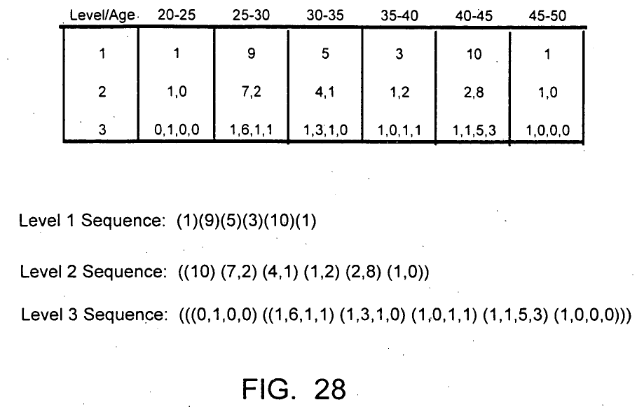

One may develop other alphabets and syntactical rules appropriate for other purposes. For example, if one was interested in discovering new trends in data, one may be primarily interested in points that fall outside of a particular “normal” range of values. For example, FIG. 27 shows a density plot (or statistical distribution or scatter diagram) of cost of an item (e.g., a car or boat) as a function of the age of buyers. It may be assumed that the cross-hatched area defined by lines A-B and C-D is the “normal” range distribution and that only the points outside are of interest since these outlying points would show new trends in the market. The general approach is to look at the furthest outlying point and use that to define an entire cost range with each level of resolution being tiled in relation to this largest value. Thus, at the highest level of resolution, defined by line E-F, one considers all points within each age category that are included between the “norm” and the highest range. FIG. 28 illustrates a table with the number of points within each age category listed in columns and the level of resolution listed in rows. At the first level of resolution all points are counted. While one may count the number of points as in the present example, one could also express the counted number as a percentage of all points including those within the “normal” range. In this example, it is noted that expressing the number of points with some symbol (e.g., 1, 2, 3) is an alphabet and the rules of how one divides and groups the numbers as the different levels of resolution constitutes the syntax.

To express the second level of resolution, one divides the space between the “norm” and line E-F in half at line G-H to arrive at two distinct regions, those below and above line G-H. FIG. 28 shows the number of points at resolution level 2 with the first number in parenthesis indicating the lower region and the second number indicating the upper region. At the third level of resolution, one divides each of the first regions in half as seen by lines I-J and K-L, resulting in four region. FIG. 28 shows the resulting numbers in each of the four regions for each of the age categories.

In this example, it may be seen that continual sub-division will ultimately result in a string of 1's and 0's in some ordered sequence. Such a condition may be taken as an indication that one may stop dividing the cost into further divisions as no additional useful information will result. The concatenation of all of the levels of resolution will provide a statement (i.e., a description) of the observed statistical distribution. It may be sufficient to look at fewer that the highest level of resolution. For example, the first three levels of resolution in FIG. 28 may be sufficient for discerning desired price ranges of the product and the number sequence from the concatenation of the numbers in the levels 1-3 of FIG. 28 may be fed into the Numgram attractor process.

One should also realize that FIG. 27 may be described as a waveform if one simply connects all the points above the cross hatched region. To do this, one may need to expand the age axis (use a higher “place” resolution) so that the separation of the points in age is more clearly shown. That is, one may need to take 1 year intervals or 3 month intervals in order to spread the points apart so as then to be able to connect them point to point. The resulting waveform may be drawn connecting the points. While, for the present intend of discerning trends, a different alphabet has been chosen from that of FIG. 10, the pattern being characterized is nevertheless a waveform. Thus, the scatter diagram (i.e., statistical distribution diagram) of FIG. 27 will be considered a type of a waveform diagram in the more generic sense of the word waveform.

The above examples illustrate ways in which one could develop and alphabet and syntax and use them to extract patterns from a waveform, waveform segment, including a density plot or statistical distribution. The alphabet and syntactical structure chosen permits one to build an embedded and hierarchical sequence. Such sequences may be fed the Numgram attractor process as done in the DNA example.

For the sake of completeness, we will now show how one may use the sequence of Statement 1, and feed it into the Numgram attractor process in the same fashion as illustrated earlier in the DNA examples. Statement 2 could equally well be used, but for purposes of illustration we will retain the sequence and parenthesis structure that is present in Statement 1.

In the waveform example, the alphabet consist of 21 unique patterns. Thus, the symbol base for Numgram is base 21, but the Numgram itself may use any count base greater than 5 and this count base may be selected as a parameterization of the Numgram attractor process. As in the DNA example, we will take the Numgram base to be 7 by way of example and not by way of limitation.

For the purpose of our example, we will not adopt an explicit alphabet for the open and closed parenthesis. We now examine Statement 1, reproduced below, and, ignoring the parenthesis, convert all of the numbers into base 7 to arrive at Statement 3.)

(12, 1, 5, 2, 20) ((10, 6, 4, 9, 3) (7, 5, 2) (9, 16)) (((10, 6) (4, 9) (3, 7) (5, 2, 4, 1) (5, 2) (9, 16))) ((((14, 2) (4, 1) (5, 2) (4, 1)(5, 2) (4, 1) (5, 2) (9) (16)))) (((((14, 2) (4, 1) (5, 2) (4, 1) (5, 2) (4, 1) (4, 1) (18))))) (Statement 1)

Statement 1 is converted to base 7 resulting in the following Statement 3.

15, 1, 5, 2. 26, 13, 6, 4, 12, 3, 10, 5, 2, 12, 22, 13, 6, 4, 12, 3, 10, 5, 2, 4, 1, 5, 2, 12, 22, 20, 2, 4, 1, 5, 2, 4, 1, 5, 2, 12, 22. 20, 2, 4, 1, 5, 2, 4, 1, 5, 2, 4, 1, 5, 2, 4, 1, 24 (Statement 3)

The frequency distribution of the numbers in Statement 3 are shown in Table 14 below as well as their conversion to base 7 for input into Numgram.

TABLE 14

| | Number of | Number in |
|---|---|---|
| | base 7 | base 7 |
| | symbols in | symbols in |
| Base 7 | Statement 3 | Statement 3 |
| symbols | (in base 10) | (in base 7) |
| 0 | 4 | 4 |
| 1 | 20 | 26 |
| 2 | 28 | 40 |
| 3 | 4 | 4 |
| 4 | 11 | 14 |
| 5 | 10 | 13 |
| 6 | 3 | 3 |

A Numgram table may now be produced as in the DNA examples as follows:

TABLE 15

| | | | | | | | Row Number |
|---|---|---|---|---|---|---|---|
| 0 | 1 | 2 | 3 | 4 | 5 | 6 | 1 |
| 4 | 26 | 40 | 4 | 14 | 13 | 3 | 2 |
| 1 | 2 | 1 | 2 | 3 | 0 | 0 | 3 |
| 2 | 2 | 2 | 1 | 0 | 0 | 0 | 4 |
| 3 | 1 | 3 | 0 | 0 | 0 | 0 | 5 |
| 4 | 1 | 0 | 2 | 0 | 0 | 0 | 6 |
| 4 | 1 | 1 | 0 | 1 | 0 | 0 | 7 |
| 3 | 3 | 0 | 0 | 1 | 0 | 0 | 8 |
| 4 | 1 | 0 | 2 | 0 | 0 | 0 | 9 |
| 4 | 1 | 1 | 0 | 1 | 0 | 0 | 10 |
| 3 | 3 | 0 | 0 | 1 | 0 | 0 | 11 |

It may be seen that row 6 is a repeat of row 9 and the above Numgram attractor process has a 3-cycle oscillatory behavior. Consistent with our DNA example, we assign this behavior a token value of 0.

One may now take Statement 1 and build inverting pyramids as in Table 7 of the DNA example, to create sub-statements with one number dropped from the right and left ends in order to produce a source multi-set space (see FIGS. 2A and 2B) which, when passed through the Numgram process produces token strings. These token strings will be a sequence of 1's and 0's as in the case of the DNA example.

Alternatively, instead of dropping off one point (number) at a time, one may first drop off one region within a ring of resolution and build inverting pyramids with the remaining number by chopping off one point at a time from what is remaining. Alternatively, one could, instead of chopping off one point at a time, continue to chop off one ring at a time. Thus, in reference to Statement 1, one would drop off the right or end points corresponding to region 9 in FIG. 16 to obtain the following statement 4.

(12, 1, 5, 2, 20) ((10, 6, 4, 9, 3) (7, 5, 2) (9, 16)) (((10, 6) (4, 9) (3, 7) (5, 2, 4, 1) (5, 2) (9, 16)))((((14, 2) (4, 1) (5, 2) (4, 1) (5, 2) (4, 1) (5, 2) (9) (16)))) (((((14, 2) (4, 1) (5, 2) (4, 2) (5, 2) (4, 1) (5, 2) (4, 1))))) (Statement 4)

In a similar fashion, one can drop off region 1 (the only region) of FIG. 12B, that is the numbers (12, 1, 5, 2, 20) from the left side of Statement 1. One can then proceed to prepare inverting pyramids with ever decreasing sequence strings by chopping off the end or beginning regions within each ring of resolution. This amounts to chopping off all numbers within a pair of parenthesis from the left and right sides of Statement 1 to arrive at the inverting pyramids in a similar fashion as done in the DNA example. (See, for example, Table 7 above). Thus, each set of numbers inside a pair of parenthesis is treated as one of the letters in Table 7 and the inverting pyramids are built in the same fashion as in Table 7. The resulting sequences are the source multi-set space of FIGS. 2A and 2B.

As before, each resulting lines of the inverted pyramids are converted to the Numgram attractor count base (base 7 in our example) and fed through the Numgrarm attractor process.

In the DNA example, one took pairs and triplets of the nucleotides in the DNA “reads” or fragments and used these groupings to concatenate with the single nucleotide token to form the composite token strings. This grouping was done to give a more descriptive token string so that matching token strings would be possible by a simple ordering of the token strings within a target space. Extending this technique to the waveform example, one would first build the pyramids of FIG. 7 dropping one number off from the right and left ends of the sequence and then grouping the numbers two at a time. Since there are 21 possible choices of numbers in our alphabet of FIG. 10, then there are 441 (21×21) possible two-at-a-time combinations. (In the DNA example, there were only 4×4=16 possible two-at-a-time combinations). Each of these 441 possible combinations could be labeled in a similar fashion as Table 3 and the resulting numbers assigned to each of the lines in the inverted pyramids as done in the DNA example. Grouping the points three-at-a-time may not be needed to fully describe the waveforms, but if such groupings are desired they would result in 9261 combinations (21×21×21). While these numbers of combinations here may seem large, it should be realized that the resulting amount of information used to describe the waveform in this fashion and to build the resulting token strings is still quite small when compared to the say 20 Khz of information present in the original waveform.

The resulting token strings may be ordered (i.e., ranked) and compared just as in the DNA examples described earlier. Such ordering and comparing is done in the analytic space 2a-7 of FIG. 2A.

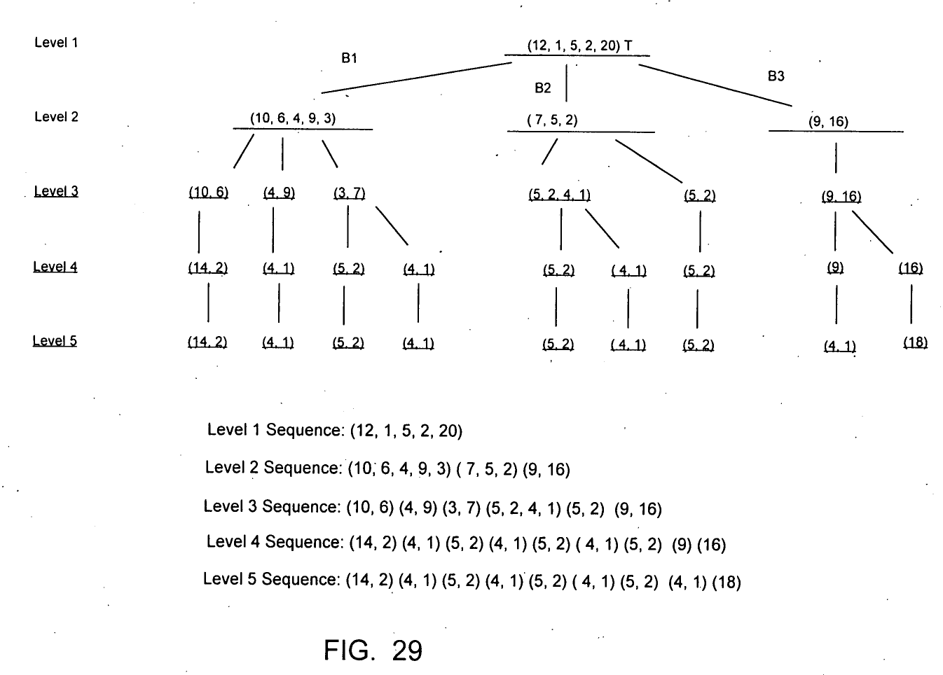

Other groupings of Statement 1 may also be performed. Statement 1 may be looked at as a tree diagram shown in FIG. 29. The trunk, T, of the diagram is the level 1 resolution description. Level 2 results in branches B1, B2 and B3. Sub-branches follow to the further levels. The tree diagram is taken directly from FIG. 16. One may additionally or alternatively form source multi-sets by eliminating an entire branch such as branch B3 (including all of its sub-branches) and then use the resulting level 5 sequence to build the inverting pyramids, by again chopping off from the right and left of the resulting level 5 sequence. One may chop off points at a time or rings at a time as before. One may also chop any of the other branches such as branch B1 and B2 and again use the resulting level 5 sequence to build the inverting pyramids as before. In each case, pairs and triplets (or higher orders if desired) of the resulting numbers may be grouped. The resulting token strings may then be concatenated in the target space (see FIG. 2A) and fed to the analytic space for ranking.

Instead of taking the numbers in the “statement” of the waveform in pairs and triplets to build the token strings as done in the DNA example, one may take groupings of regions of resolution. Regions of resolution are ontologically more significant for waveform descriptions than single, pairs and triplets used in the DNA example. For example, FIG. 25 shows 9 regions of resolution for the simple waveform illustrative example. In general there may be hundreds of regions. At the highest level of resolution in FIG. 25, the waveform statement is: (14, 2) (4, 1) (5,2) (4, 1) (5,2) (4,1) (5,2) (4,1) (18). It is noted that each region at this level of resolution contains only two points, and the regions which include the terminator points may consist on only one point. Thus, to give each of these two point regions an identification, one would have 21×21=441 identifiers. If one used the resolution level 2 description in FIG. 25, namely, (10, 6) (4, 9) (1, 5, 2) (20), one would choose from among the 441 label set to identify the points within the first, second and fourth pair of parenthesis and one would choose among a label set of 21×21×21=9261 to identify the points within the third parenthesis triplet. For the triplet identification, one can start the numbering with 442 and continue to provide 9261 separate identifiers which are distinct from the 441 identifiers used for two point regions. In this process, in building the inverting pyramids of Table 7, one may, still delete one number (point) from the left or right or may instead delete an entire region from the left and right. In this fashion, the Numgram attractor process is used to count the frequency of occurrence of these identifiers. In this fashion, the entire waveform (any statement of the waveform, e.g., Statement 1, Statement 2 etc.) may be re-described in terms of the combinatorial identity of the basic alphabet within regions, sub-regions, sub-sub-regions etc for any level of resolution. Such a full description makes sorting and finding waveforms extremely fast and efficient. For example, if the waveforms don't match at their lowest level of description, then there is no need to search further since they will not match at the higher levels of resolution either. Further, waveform regions at the ends of the segments may match with initial regions of other waveform segments and this matching would be apparent from the region and sub-regions groupings as discussed above.

In terms of application, one might be looking at trigger events. That is, one may be interested only in the number of times a particular waveform, such as a sawtooth waveform occurs. So in this case, it would be advantageous to look at a given ring of resolution and rings of lower resolution. If one is interested in an amplitude over a certain fixed value, then one may use a resolution that permits one to see that amplitude and then there is no need to go to higher resolutions because all the higher resolutions will automatically see that amplitude. So, it is only really necessary to go to lower resolution segments. Furthermore, in looking for trigger events, it may, depending on application, only be necessary to look at a few 10s or less cycles or max/min intervals. In other applications, one may be interested in a larger waveform group of segments. The key is to use trigger events (waveform shapes) which are constant and affine independent.

The target space 2A-5 of FIG. 2A, in the DNA example consist of the token strings built up from the interaction of the attractor process with the source multi-set. The source multi-set is itself embodied by the inverted pyramids as per Table 7. In the DNA example, the analytic space 2A-7 of FIG. 2A was obtained from the target space 2A-5 of FIG. 2A, by appending a source set identifying label to the target space representation. The analytic space was built up as the union of the source set identification labels and the attractor set representation in the target space and by defining an operator which permits comparisons, such as “compliment” “XOR” etc. The analytic space in the waveform examples likewise consist of a simple set of operators which permit ranking and comparison of token strings. One may or may not require a tag to identify the source multiset. In looking for trigger events discussed above, one need not use a tag to identify the source multiset. Thus, the use of the tag depends on the intended use of the attractor process.

In the above example of FIGS. 11-16, we have chosen to divide the waveform into regions as dictated by the location of the global maximum, the global minimum and then into sub-regions according to local maximum and local minimum values. In the example of FIGS. 22-25 we have divided the waveform into regions as dictated by the locations of the global maximum and global minimum and then into sub-regions according to the next global maximum and next global minimum across the whole of the waveform segment under consideration. These choices of using embedded and hierarchical max/min separates the waveform by separatrices. Topology happens to like separatrices because those are the bounds to diffeomorphic regions. A diffeomorphic region is a region separated by differentiable (in the sense of calculus) shapes. Regions 1-4 in FIG. 8 constitute different diffeomorphic region (each describable by a partial differential equation), and the zero slope points x1, x2, and x3 separating these regions are separatrices. If one knows the qualitative shape (as defined by the location of the min/max points, i.e., the separatrices) of the waveform, or in N-dimensions, of the manifold, then one can obtain closed form expressions of the underlying equations which can reproduce the waveform or manifold and which represent the physical system being studied or simulated. See for example, the germ and perturbations set forth in Table 2.2 of Gilmore (page 11). Thus, describing the waveform as a hierarchical sequence of embedded min/max, is analogous to organizing the waveform into hierarchies of their separatrices. This has important ramifications in catastrophe theory.

Catastrophe theory is the study of how the qualitative nature of the solutions of equations depends on the parameters that appear in the equations. As shown by the simple waveform in FIG. 8, equilibria points, or “critical points” of the waveform, are points where the gradient of the waveform is zero. These points are separatrices that separate the waveform into distinct regions. Most of the points of FIG. 8 have a non-zero slope and thus are non-critical points. In such a case, it is noteworthy that it is the critical points that serve to organize the space into qualitative regions.

The critical points of FIG. 8 are isolated critical points meaning that they are non-degenerate. They are also called Morse critical points, and they exist whenever the gradient of the waveform is zero and the determinate of the stability matrix Vᵢⱼ (i.e., the second derivative of the function defining the waveform) is not zero. In such a case one can write the potential in the vicinity of the critical points as a sum of quadratic terms with coefficients equal to the eigenvalues of the stability matrix. (See equation 2.2b of Gilmore, page 11). If, however, the determinate of the stability matrix is zero, then one must break the function into a Morse part and a non-Morse part. It is the non-Morse part that is tabulated in canonical form in Table 2.2 of Gilmore (page 11) as a sum of a germ and perturbation.

Critical points that have the determinate of Vᵢⱼ equal to zero are called non-isolated, degenerate of non-Morse critical points. The separatrices that are associated with these degenerate critical points are important in studying the qualitative properties of functions and serve to define open regions of the control parameter space in which the functions have similar qualitative properties. The control parameters are the constant coefficients of a function that control the qualitative properties of the solution. In equation (1) below, a, and b are the control parameters. Thus, for a family of functions, were most points in a control parameter space serve to parameterize Morse functions (gradient=zero and det Vᵢⱼ does not equal zero), it is noteworthy that it is the separatrices which parameterize the non-Morse functions, and which organize the qualitative properties of the family of functions. (See, in particular, Gilmore, Chapter 5, pp. 51-93). Within any open region away from the separatrices, small changes in the control parameters produce only small changes in the location of the critical points, and thus perturbations produce no changes in the qualitative nature of the functions parameterized by that region of the control space. For non-Morse functions qualitative changes take place when a perturbation is applied to the catastrophe germ. Since the germ and perturbations are canonical (see table 2.2 of Gilmore), the separatrices need only be studied once and all points within an open region defined by the separatrices will behave qualitatively the same.

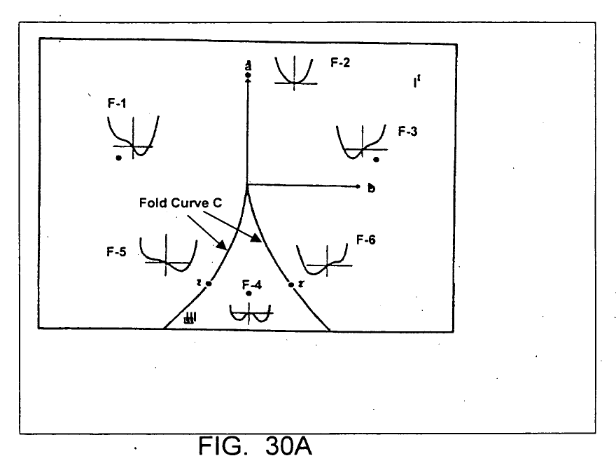

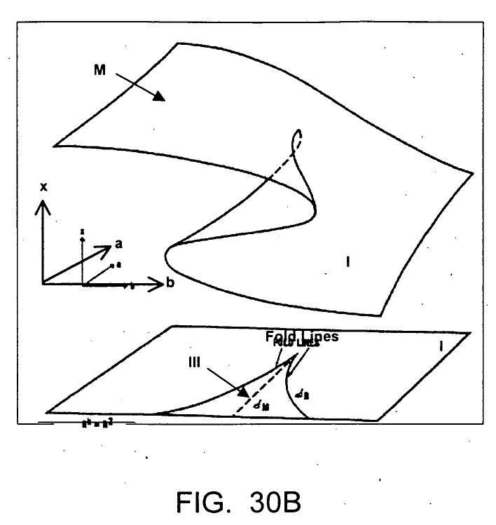

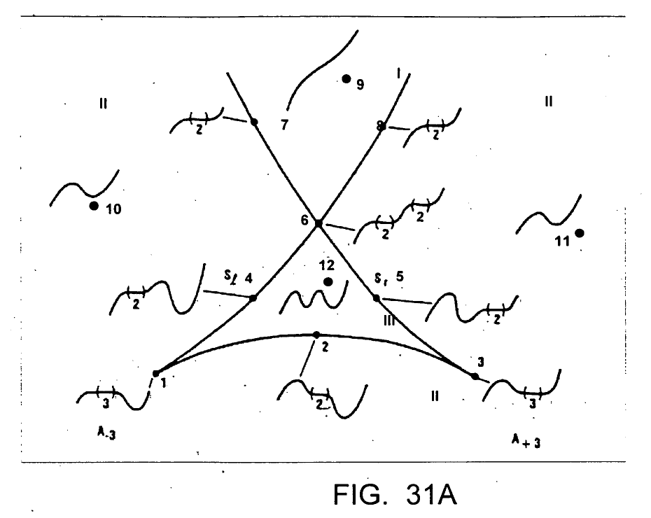

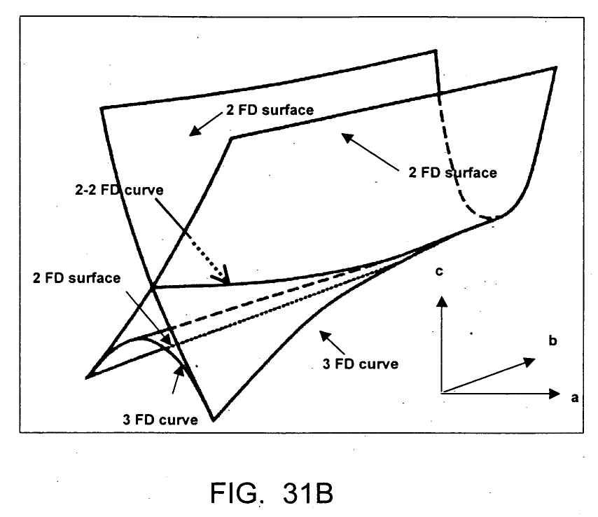

Within any open region of a control parameter space, the waveform has the same descriptive quality in terms of the number of its minimia and maxima. This is illustrated by the cusp catastrophe which often occurs in many technological fields. The cusp catastrophe is illustrated 60-61 and 97-106 of Gilmore and is reproduced here in FIGS. 30 and 31. The cusp catastrophe arises from the study of the qualitative properties of the waveform F(x; a, b) given below as equation (1) where the waveform has a one-parameter (e.g., x) non-Morse portion (e.g. x⁴, where x represents a state variable associated with the non-Morse form of the waveform and where a and b are control parameters. These control parameters parameterize the function.
F(x;a,b)=¼x⁴+½ax²+bx. Equation (1).

The critical points of the function are determined by setting the first derivative (i.e., the gradient) equal to zero; the two-fold degenerate points by setting the second derivative equal to zero; and the three-fold degenerate points by setting the third derivative equal to zero.

These conditions yield:
x³+ax+b=0 Equation (2)
3x²+a=0 Equation (3)
6x=0 Equation (4).

At the critical points, equation (2) is valid; at doubly degenerate critical points both equations (2) and (3) are valid; and at triply degenerate critical points equations (2), (3), and (4) are valid. From these relations one may obtain a relation between the control parameters a and b at the doubly degenerate critical points as
(a/3)³+(b/2)²=0 Equation (5).

Equation (5) is shown in FIG. 30A as a fold curve, C. The separatrix in control parameter space consist of the four-fold degenerate point x=a=b=0 and the fold curve C of equation (5). As shown in FIG. 30A, the separatrix divides the control parameter space into two open regions labeled I and III. Region I is so labeled because the control parameter space within this regions parameterized the function F(x; a, b) to have only one isolated critical point as shown by the representative functions F-1; F-2, and F-3 at various locations of the two-dimensions control parameter space. Note that b=0 for the function F-2. Because of the canonical form of the germ and perturbation (Table 2.2 in Gilmore and equation (1) above) all points within region I have only one isolated critical point. Similarly, in region III, all functions have three isolated critical points as shown by F-4 in FIG. 30A. At the fold curve C, functions have doubly degenerate critical points and a single isolated critical point as represented by the functions F-5 and F-6. The fold curve C is the separatrix that locates the degenerate critical points and separates different qualitative regions of the control parameter space. Thus, passing through the separatrix going from say regions III to region I, causes the “contraction” or pulling together or collapsing of two adjacent isolated critical points. In the case of FIG. 30A, passing from region III to region I results in two of the isolated critical points in region III to collapse (e.g., annihilate each other) to leave only one critical point functions in region I. See, for example, Gilmore, Chapter 7, pp. 107-140.

The geometry of the catastrophe cusp is shown in FIG. 30B. Equation (2) defines a 2-dimensional manifold, M, in a 3-dimensional space defined by the coordinate axes x-a-b. The fold lines of equation (5) are the projections of the manifold folds onto the control parameter plane a-b.

A similar presentation may be made for the A₄ control space where there are three control parameters a, b, and c, and A₄ is defined as:
A₄=⅕x⁵+⅓ax³+½bx²+cx Equation (6)

Again one may take first through fourth derivatives of Equation (6) to study the control manifolds and obtain the shape of the separatrices. The end view of the separatrices for the A₄ control space a, b, c, is shown in FIG. 31A, and the three dimensional (for control parameters a, b, and c) view of the separatrices is shown in FIG. 31B. See also pages 62-66 of Gilmore. Points on the separatrices have non-Morse degenerate critical points. For example, points 1 and 3 have an isolated minimum and isolated maximum point respectively and a three-fold degeneracy. Such points appear along lines labeled “3 FD curve” in FIG. 31B. Point 2 in FIG. 31A has one maximum and one minimum and a two fold degeneracy and is a projection of the “2 FD surface” of FIG. 31B. Points 4 and 5 of FIG. 31A are inverted pairs each having one minimum and one maximum and a two fold degeneracy along the separatrix. These points are projections of the right and left “2 FD surfaces” shown in FIG. 31B. Point 6 in FIG. 31A has two 2 fold degenerate critical points and is shown by the curve labeled “2-2 FD curve” in FIG. 31B. Points 7 and 8 of FIG. 31A have two fold degenerate points but do not have isolated minimum or maximum points. Points spaced from the separatrices have only Morse critical points (no degenerate points). These points appear in three regions labeled I, II and III, and all points within each region are qualitatively the same. Representative point 9 in region I has no critical points, points 10 and 11 in region II have two critical points and point 12 in region III has four critical points.

The process of decomposing waveforms hierarchically by their ontologies can be viewed as a series expansion, such as a Taylor series, broken up into regions bounded by qualitative critical points. (See Gilmore, Chapters 1-7 and Chapter 21). In cases where there are no critical points the terminators of the waveform act as boundaries. The terms expressed in the series expansion can be ordered from most contributory to least contributory with respect to the overall waveform shape. Each series term may represent a general region that can be decomposed into finer regions. These regions conform to a description of local behavior that is composed of a specific qualitative germ with a particular perturbation.

For any one germ there is a behavioral surface that can be segmented into regions bounded by a network of separatrices. Each region on this surface describes a characteristic quality of the waveform as it is perturbed. For example a waveform region that has only an inflection point with no local minima or maxima between its boundaries shows up as a location on the behavioral surface, e.g., point 9 in FIG. 31A. When the qualitative description falls directly on the separatrix it indicates that segment of the waveform, at that level of resolution description, contains degenerate critical points within the waveform description.

An analytical space can be established to map waveform alphabet points to families of equation forms so that ancillary calculations are no longer needed. Topological comparison of waveforms is achieved by examining their hierarchical grouping of qualitative ontologies.

For example, in FIG. 12B, the Level 1 sequence is a type A₂ with two critical points as depicted in Gilmore (Table 2.2, pg. 11, and also discussed at pages 58-59). Recalling that according to the adopted syntax one counts the right end point of each region as within the region (but not the left except for terminator points), the three regions for the Level 2 sequence of FIG. 13B are:

region I=A₄ catastrophe shown at point 6 in FIG. 31A, (and also shown in Gilmore's FIG. 5.7 page 64);

region 2=A₃ catastrophe shown at point F-5 in FIG. 30A (and also shown in Gilmore's FIG. 5.4 page 61); and

region 3=A₂ with two degenerate critical points (here counting the terminator point J as a minimum) as shown in Gilmore's FIG. 5.3 at page 59).

The DNA example set forth above has been further explained in terms of the flow charts of FIGS. 4-6B. Each of these flowcharts is equally applicable to the waveform embodiment of the inventions inasmuch as the results of the pattern extraction process yields a sequence of numbers (i.e., Statement 1) which is run through the Numgram process just as done with string 1 in the DNA example. The Numgram process of course does not know nor care what the source of the sequence is that is it interacting with. The Numgram process interacts with all number sequences given to it. As long as there is sequence and frequency, the Numgram process will provide a predictable output behavior (e.g., either one of at least two output behaviors to be useful as a classifier). Thus, embodiments of the invention include methods of determining the combinatorial identity of a waveform source set from a waveform multiset per FIG. 3; the method of determining or recognizing the family of permutations of a waveform source multiset in a space of waveform multisets as per FIG. 4; the method of determining the waveform source space multi-set's combinatorial identity within the waveform analytic space per FIG. 5; and the method of hierarchical waveform pattern recognition using attractor based characterization of feature sets per FIGS. 6A and 6B.

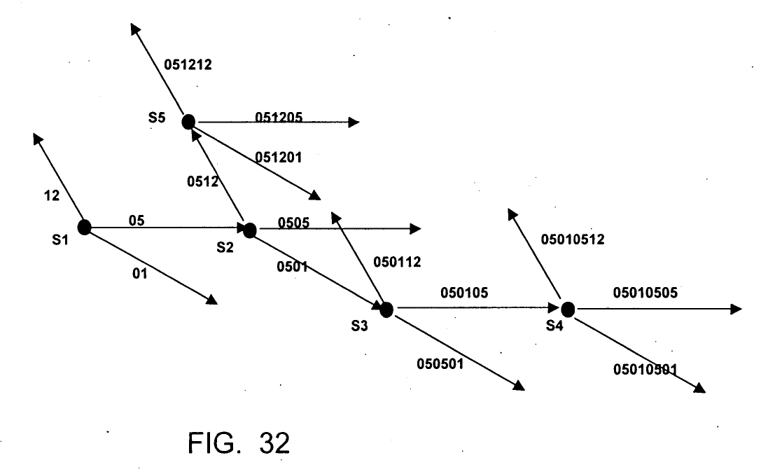

Using the waveform statement (e.g., Statement 1) developed above for the 21 symbol alphabet of FIG. 10, one may develop a representation scheme in an analytic space in which direction is defined by the address of the statement which itself is defined by the symbols of the alphabet and the applied syntax. Note here that the analytic space referred to is not the analytic space 2A-7 of FIG. 2A, but rather an analytic space defined by vectors and addition operators to simply represent the patterns extracted from the waveform and described as a statement such as statement 1. Such an analytic space is shown in FIG. 32. Point S1 of the analytic space is taken as the origin and three vectors 01, 05 and 12 are drawn around the origin. We have shown only three of the 21 possible vectors for simplicity although it should be understood that the same process illustrated in FIG. 32 is to be extended so that all 21 unique symbols of FIG. 10 are to be represented by a different direction in the analytic space of FIG. 32.

FIG. 32 shows points S1-S5 as examples. These points would correspond to the first five extracted pattern symbols of the waveform or waveform segment under consideration. In reference to FIG. 12A, these first five points would be points 12, 1, 5, 2, 20.

Continuing with the simplified illustration of FIG. 32, point S2 has address 05 in relation to point S1 and thus all vectors emanating from point S2 start with 05. Similarly, all points emanating from point S3 start with address 0501 and then append their possible directions to that address. Point S4 has address 050105 and point S5 has address 0512. In this fashion one may build an analytic space in which the alphabet used to describe the waveform is represented by vector directions and an addressing scheme that corresponds uniquely to the patterns extracted to describe the waveform. It should also be appreciated that although the vectors of FIG. 32 have been drawn with the same magnitude, in general different scalar values of the vectors could be used to represent say different levels of resolution. Thus, all vectors within the first level of resolution could be assigned one scalar value and those in the succeeding levels of resolution could be assigned a different scalar value.

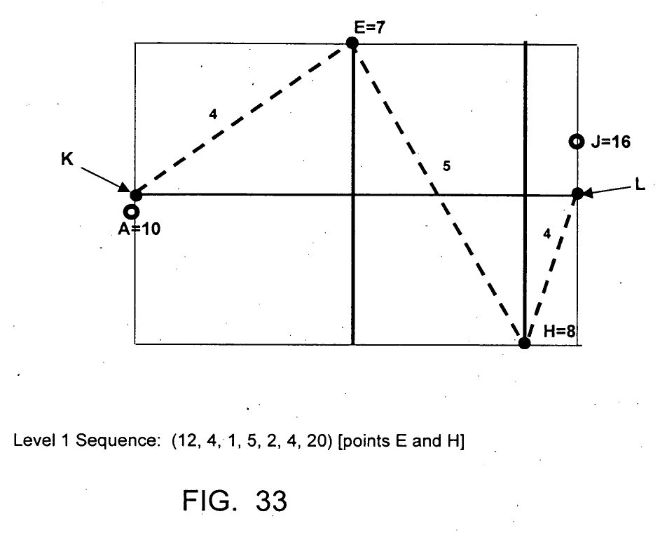

As yet another example of using different syntactical rules to extract patters from a waveform, reference is made to FIG. 33. In this example, one is interested in characterizing points outside of a band defined by identifying a global maximum and minimum points and then identifying the next local maximum and the next local minimum points to continually narrow the band. In this “band pass” example, one starts with the waveform of FIG. 11 (after normalization) reproduced in FIG. 33 but showing only the global maximum point E, the global minimum point H and the terminator points A and J. As a syntactical rule, the terminator points at the first level of resolution are visible and positioned at the meridian line K-L. The dotted line connects these “visible” points. In FIG. 33, the positions of these terminator points taken from FIG. 11 are shown by open circles, but the meridian positions of these points for the purposes of the band pass syntactical rules applied in this example are shown as large solid points just as are the points E and H. Under these band pass syntactical rules, one assumes that points are only visible (i.e., their values can be determined) when they are outside of the band, but one also assumes that one knows of the existence of all points even in-band points.

The global maximum point E is assigned a pattern 1 and the global minimum point H is assigned a pattern 2. Point A, to the left of point E is assigned a pattern 12 since, as stated earlier, at this level of resolution one assumes the terminator points are on the meridian. Pattern 4 is assigned between points A and E and in this case, the “4” is used to indicate that there are additional points between points A and E, but these additional points are not yet visible in that they are not yet outside the band (that is, the first level band defined by everything equal to or above point E and everything equal to or below point H). Applying similar reasoning, a 5 pattern is assigned between points E and H to indicate that there are additional points within the band and between points E and H. Point J to is to the right of point H and is assumed to be on the meridian at this first level of resolution. It is thus assigned pattern 20. Pattern 4 connects points H and J, again indicating the existence of additional in-band points between points H and J. As shown in FIG. 33, the statement describing the waveform for the first or lowest level of resolution is (12, 4, 1, 5, 2, 4, 20).

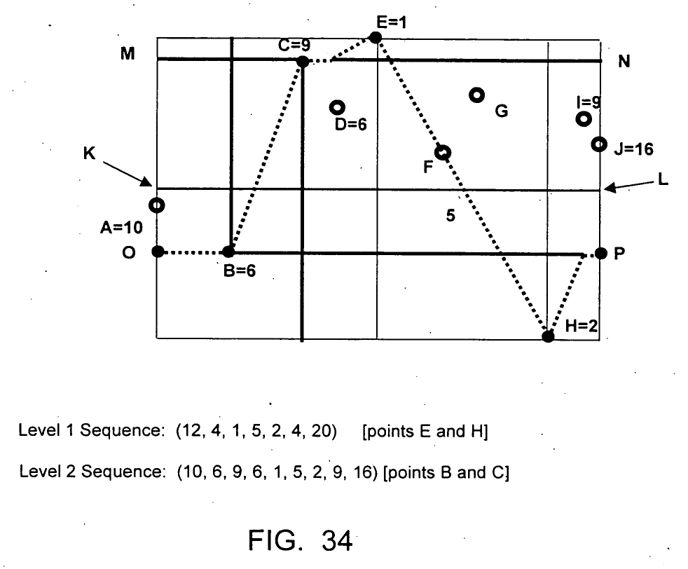

FIG. 34 shows the next level of resolution obtained by finding the local maximum point C and local minimum point B. At this second level of resolution, the syntactical rules adopted do not nor place the terminator points at the meridian. At this second level of resolution, point A is not yet visible so it is assigned a label 10. Point B sees point A to its left as equal and point C to its right as higher and thus is labeled 6. Point C sees point B to its left as lower and point D, whose existence is known but whose value is not yet determinable since it is still in-band, as even and thus is assigned a label 9. Point D, is known to exist but its value must, at this level of resolution, be taken as equal to that of point C but lower than that of point E. Thus, point D is assigned a value 6. (It is noted that if there were plural points between C and E and all of these points were inside the “band” defined lines M-N and O-P, then all of these points would be treated together as one and labeled “6”. Point E is the global maximum has pattern 1, and it sees point D to its left as lower (even though point D is in-band) and it sees point H to its right as lower. The line connecting point E to H is given pattern 5 indicating that there are more point connecting the two out of band points E and H. Again, point H is the global minimum and assigned pattern 2. Point I is somewhere in-band and thus serves to flatten out the dotted line at the band boarder to the terminator point J which is assigned pattern 16. Thus, the level 2 statement of the waveform under these syntactical rules is: (10, 6, 9, 6, 1, 5, 2, 9, 16).

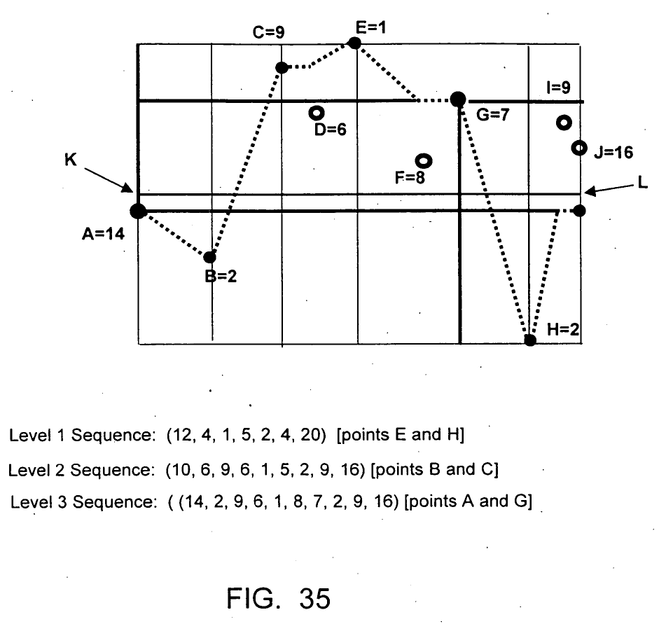

FIG. 35 shows the waveform for the third level of resolution. Here the next local maximum is point G and the next local minimum is point A. Point A is assigned pattern 14 since it sees point B to its right and lower. Point B sees point A to its left and higher and point C to its right and higher and thus is assigned pattern 2. Points C, D and E are again assigned points 9, 6 and 1 respectively. The in-band point 8 is now assigned pattern 8 and it has the effect of flattening out the dotted line from point E along the upper limit of the band until point G is reached. Point G is assigned a pattern 7 and points H, I and J are again assigned patters 2, 9, and 16 respectively. The level 3 sequence is thus, (14, 2, 9, 6, 1, 8, 7, 2, 9, 16).

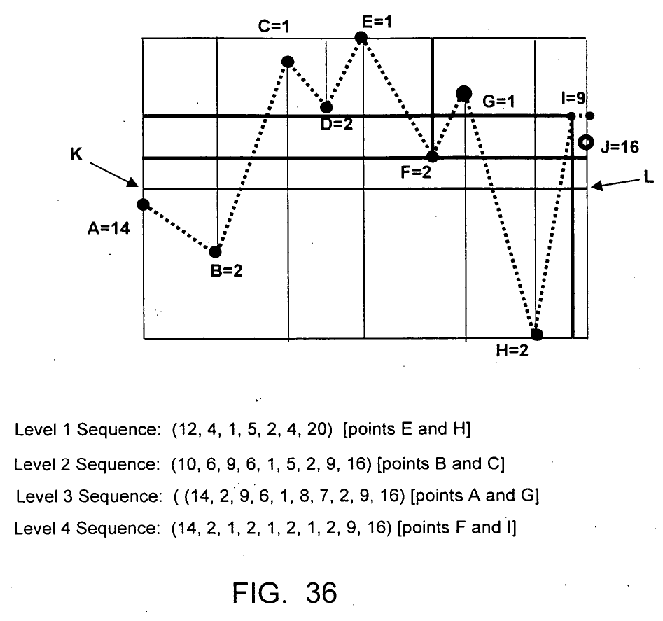

FIG. 36 shows the level 4 sequence where the next local minimum and maximum are identified as points F and I respectively. At this level, point D comes out of band and is assigned pattern 2 and point C is now an identifiable maximum and is assigned pattern 1. Similarly, point F is identifiable as a minimum and point G as a maximum. Point J is still in-band and is assigned pattern 16, and point I is assigned pattern 9. The level 4 sequence is then (14, 2, 1, 2, 1, 2, 1, 2, 9, 16).

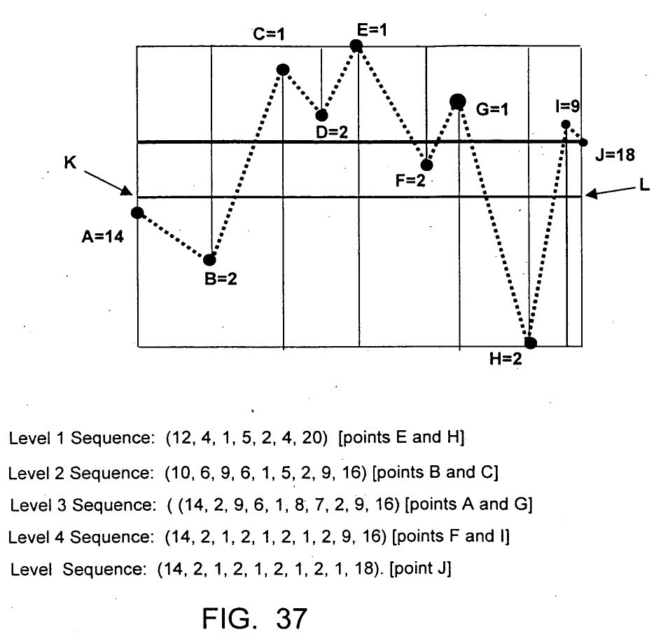

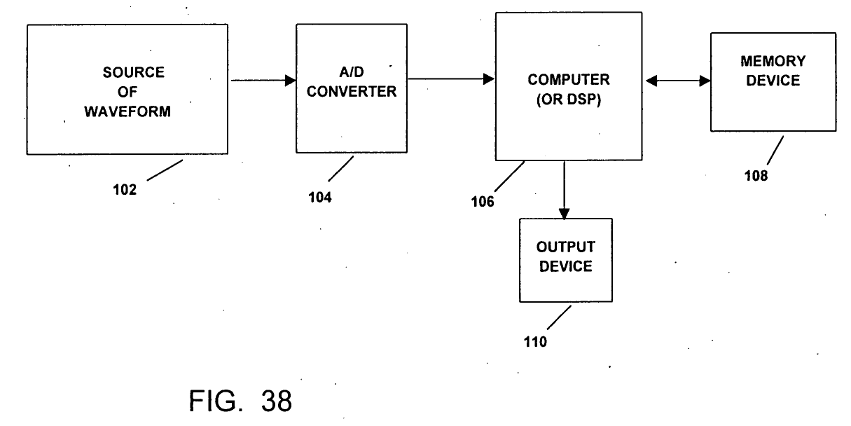

FIG. 37 shows the fifth and final level of resolution where point J comes out of band. Now all points are out of band (i.e., the band has become smaller and smaller so that no points are not in-band). Point J has a pattern assignment of 18, and point I a pattern of 1. The level 5 sequence is (14, 2, 1, 2, 1, 2, 1, 2, 1, 18).

The full statement of the waveform may now be obtained as before by combining all resolution sequences (in this case levels 1-5) to obtain a complete “statement” of the waveform in terms of the descriptive alphabet used and the syntactical rules applied. Inverted pyramids may again be produced as in Table 7 and the waveform statement fed through the Numgram attractor process to obtain token strings that are then compared and, if desired, sorted as a result of the comparison operation to rank the token strings so that like token strings are listed next to each other.

Examples of the hardware device for carrying out the embodiments of the invention comprise, inter alia, a digital computer or signal processor. The digital computer is programmed to carry out the various algorithms described above in connection with the FIGS. 1-37. More generally, the system or device may comprise any one or more of hardware, firmware and software configured to carry out the described algorithms and processes. For example, a waveform source (e.g., a heart monitor; assay apparatus or any waveform-based analytical equipment) typically provides an analog output. This output is digitized (fed through an analog to digital computer) and then input to the computer for analysis and pattern assignment applying the previously devised alphabet and syntactical rules. In practice, a database (or table or list) will be built up of previously analyzed waveform patterns (a database of their token strings) and the analysis of the currently observed waveform will be compared with the waveform database. It is important to recognize that the comparing and sorting operations are very simple operations and may be preformed with simple combinatorial logic or FPLA (field programmable logic arrays) and need not be implemented on a CPU. Thus, token strings may be compared and sorted in real time, and in many applications, such operations may be performed in-line in the communication's fiber system itself.

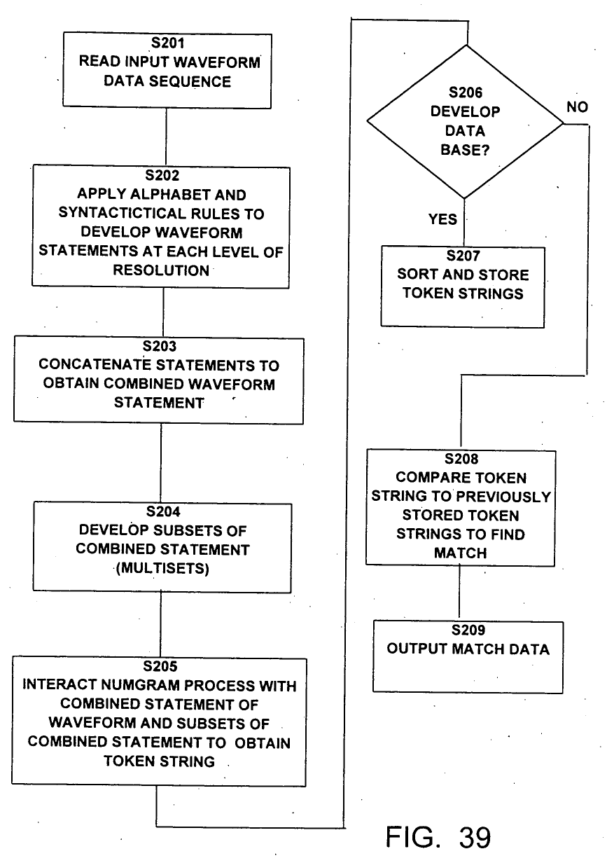

The apparatus described above may be illustrated in reference to FIG. 38 which shows in block diagram form the elementary components of a hardware embodiment of the invention. A waveform source 102 feeds an analog waveform signal to an analog to digital (A/D) converter 104 which in turns feeds the digital representation of the waveform into a computer or digital signal processor 106. The computer 106 is programmed to perform the algorithms described in connection with one or more of the various embodiments of the invention described above, and an overall flowchart of the program operation is illustrated in connection with FIG. 39 described below. The computer 106 accesses a memory device 108 to store (and preferably also sort or order) the token stings derived from the Numgram attractor process. The computer may operate in a database building mode in which a large set of token strings (each string corresponding to different reference waveform) may be stored in the memory device 108 to build a database. The computer 106 may also operate in a comparison mode in which the token string of an input waveform is compared to the token strings in the database of the memory device 106 to find a match or a region of closest match. An output device 110 such as, by way of example and not by way of limitation, a display, printer, memory unit or the like, is connected to the computer 106 to provide or store (or transmit for downstream output and/or storage) the results of the comparison. In the event the waveform source 102 provides a digital output, the A/D converter is omitted.

The flowchart of FIG. 39 shows the two modes of operation of the computer 106. In step S201, the computer 106 operates to read the input waveform data sequence. This waveform data sequence is the digital data from the A/D converter 104 and has been discussed above in reference to FIG. 7 as an illustrative teaching example. In step S202, the program executed on the computer operates to apply a previously determined alphabet and syntactical rules to the waveform data sequence to obtain a statement of the waveform data sequence at each level of resolution. A non-limiting example of an alphabet is shown in FIG. 10, and different syntactical rules have been discussed in connection with FIGS. 11-16; 19-25; 27-29; and 33-37.

In step S203 the different statements of the waveform sequence at the different levels of resolution are concatenated to obtain a combined statement of the waveform, such as Statement 1 discussed above in connection with FIGS. 11-16. In step S204 a multiset of statements is obtained by taking subsequences of the sequence defined by the combined statement. A representative and non-limiting example of such multisets is the inverted pyramids shown in Table 7. The program now goes to step S205 where the multiset is interacted with the Numgram attractor process to obtain a token string. At step S206 it is determined if the program is being operated in a database building mode, in which case the program branches to step S207, or if the program is not operating in a database building mode, in which case the program goes to step S208 corresponding to the comparison mode of operation. In the database building mode of step S207 the token string determined from step S205 is stored. Preferably, the token sting is also sorted (i.e., ordered in relation to the already stored tokens) so that the subsequent search operations in the comparison mode may be efficiently carried out. After the token string is stored, the program may return to process another input waveform sequence. In the comparison step S208, the token string of interest of step S206 is compared with the stored (and preferably sorted) tokens in the database (memory device 108) to find a match or the find the stored token strings that come closest to the token string of interest. The output match results are provided in step S209. The program then returns to step S201 to read another input waveform data sequence.

The present invention has been described in reference to preferred embodiments thereof, and numerous modifications may be made which are within the scope of the invention as set forth by the appended claims.

What is claimed is:

1. A method of waveform comparison comprising:
(a) mapping, through an attractor process, at least first and second waveform sequence source multisets, from an original representation space (ORS) into an attractor behavior space;
(i) each of said at least first and second waveform sequence source multisets being a plurality of subsets of a first and second waveform sequence and each subset having a plurality of waveform sequence elements;
(ii) said attractor process being an iterative process which causes first and second waveform sequences source multisets in the ORS to converge to at least two distinct behaviors in said attractor behavior space;
(iii) wherein each behavior in said attractor behavior space is assigned a distinct symbol from a symbol scheme,
(iv) said mapping resulting in a first and second token string, each consisting of a series of said symbols, corresponding to said first and second waveform sequence source multisets respectively;
(b) mapping, through said attractor process and into said attractor behavior space, a plurality of first and second waveform subsequences source multisets of said first and second waveform sequences respectively,
(i) said plurality of first and second waveform subsequence source multisets each being a plurality of subsets of a different one of a plurality of first and second waveform subsequence of said first and second waveform sequence and each having a number of waveform sequence elements;
(ii) said mapping resulting in a plurality of first and second subsequence token strings, each consisting of a series of said symbols, corresponding to said plurality of first and second waveform subsequence source multisets respectively; and
(c) comparing said first token string and said plurality of first subsequence token strings with said second token string and said plurality of second subsequence token strings to determine a match among said first and second waveform sequence source multisets and said plurality of first and second waveform subsequences source multisets.

2. The method as recited in claim 1 further including the step of forming said at least first and second waveform sequence source multisets by, for each of said first and second waveform sequences:
(a) removing j sequence elements, where j is an integer initially equal to one, from one end of said waveform sequence;
(b) iteratively repeating step (a) at least once for j=j+1 at each iteration, and at most for j equal to the number of sequence elements in said waveform sequence.

3. The method as recited in claim 2 further including the step of forming said at least first and second waveform sequence source multisets by, for each of said first and second waveform sequences:
(c) removing k sequence elements, where k is an integer initially equal to one, from the other end of said waveform sequence; and
(d) iteratively repeating step (c) at least once for k=k+1 at each iteration, and at most for k equal to the number of sequence elements in said waveform sequence.

4. The method as recited in claim 3 further including the step of forming said at least first and second waveform subsequence source multisets by, for each of said plurality of first and second waveform subsequences:
(e) removing j sequence elements, where j is an integer initially equal to one, from one end of said waveform subsequence;
(f) iteratively repeating step (e) at least once for j=j+1 at each iteration, and at most for j equal to the number of sequence elements in said waveform subsequence.

5. The method as recited in claim 4 further including the step of forming said at least first and second waveform subsequence source multisets by for each of said plurality of first and second waveform subsequences:
(g) removing k sequence elements, where k is an integer initially equal to one, from the other end of said waveform subsequence; and
(h) iteratively repeating step (g) at least once for k=k+1 at each iteration, and at most for k equal to the number of sequence elements in said waveform subsequence.

6. The method as recited in claim 1 wherein said mapping of said at least first and second waveform sequence source multisets is performed taking said sequence elements of each of said subsets of each of said first and second waveform sequence source multisets one-at-a-time and mapping the resulting one-at-a-time elements through said attractor process to form one-at-a-time tokens, sequences of said one-at-a-time tokens forming at least portions of said first and second token strings.

7. The method as recited in claim 1 wherein said mapping of said at least first and second waveform sequence source multisets is performed taking said sequence elements of each of said subsets of each of said first and second waveform sequence source multisets two-at-a-time and mapping the resulting two-at-a-time elements through said attractor process to form two-at-a-time tokens, sequences of said two-at-a-time tokens forming at least portions of said first and second token strings.

8. The method as recited in claim 1 wherein said mapping of said at least first and second waveform sequence source multisets is performed taking said sequence elements of each of said subsets of each of said first and second waveform sequence source multisets three-at-a-time and mapping the resulting three-at-a-time elements through said attractor process to form three-at-a-time tokens, sequences of said three-at-a-time tokens forming at least portions of said first and second token strings.

9. The method as recited in claim 6 wherein said mapping of said at least first and second waveform sequence source multisets is performed taking said sequence elements of each of said subsets of each of said first and second waveform sequence source multisets two-at-a-time and mapping the resulting two-at-a-time elements through said attractor process to form two-at-a-time tokens, sequences of said two-at-a-time tokens together with said one-at-a-time tokens forming at least portions of said first and second token strings.

10. The method as recited in claim 9 wherein said mapping of said at least first and second waveform sequence source multisets is performed taking said sequence elements of each of said subsets of each of said first and second waveform sequence source multisets three-at-a-time and mapping the resulting three-at-a-time elements through said attractor process to form three-at-a-time tokens, sequences of said three-at-a-time tokens, together with said two-at-a-time tokens and said one-at-a-time tokens forming at least portions of said first and second token strings.

11. The method as recited in claim 1 wherein said mapping of each of said plurality of first and second waveform subsequence source multisets is performed taking said sequence elements of each of said subsets of each of said plurality of first and second waveform subsequence source multisets one-at-a-time and mapping the resulting one-at-a-time elements through said attractor process to form one-at-a-time tokens, sequences of said one-at-a-time tokens forming at least portions of said plurality of first and second subsequence token strings.

12. The method as recited in claim 1 wherein said mapping of each of said plurality of first and second waveform subsequence source multisets is performed taking said sequence elements of each of said subsets of each of said plurality of first and second waveform subsequence source multisets two-at-a-time and mapping the resulting two-at-a-time elements through said attractor process to form two-at-a-time tokens, sequences of said two-at-a-time tokens forming at least portions of said plurality of first and second subsequence token strings.

13. The method as recited in claim 1 wherein said mapping of each of said plurality of first and second waveform subsequence source multisets is performed taking said sequence elements of each of said subsets of each of said plurality of first and second waveform subsequence source multisets three-at-a-time and mapping the resulting three-at-a-time elements through said attractor process to form three-at-a-time tokens, sequences of said three-at-a-time tokens forming at least portions of said plurality of first and second subsequence token strings.

14. The method as recited in claim 11 wherein said mapping of each of said plurality of first and second waveform subsequence source multisets is performed taking said sequence elements of each of said subsets of each of said plurality of first and second waveform subsequence source multisets two-at-a-time and mapping the resulting two-at-a-time elements through said attractor process to form two-at-a-time tokens, sequences of said two-at-a-time tokens forming, together with said one-at-a-time tokens, at least portions of said plurality of first and second subsequence token strings.

15. The method as recited in claim 14 wherein said mapping of each of said plurality of first and second waveform subsequence source multisets is performed taking said sequence elements of each of said subsets of each of said plurality of first and second waveform subsequence source multisets three-at-a-time and mapping the resulting three-at-a-time elements through said attractor process to form three-at-a-time tokens, sequences of said three-at-a-time tokens forming, together with said one-at-a-time tokens and said two-at-a-time tokens, at least portions of said plurality of first and second subsequence token strings.

16. The method as recited in claim 1 wherein said waveform sequence elements of each subset of each of said first and second waveform sequence source multisets is assigned using FIG. 10.

17. The method as recited in claim 1 wherein said waveform sequence elements of each subset of each of said first and second waveform sequence source multisets are derived by:
(a) representing a waveform of interest as a series of discrete points, each point having an amplitude value;
(b) assigning an alphabet symbol from an alphabet characterized by describing, for a given discrete point, the relative amplitude value of a point to the right and left of the given point such that the local shape of the waveform may be described relative to the given point.

18. The method as recited in claim 17 wherein the alphabet comprises the alphabet shown in FIG. 10.

19. The method as recited in claim 17 wherein said waveform comprises a plurality of waveform segments and each waveform segment is defined by a group of said waveform sequence elements, said mapping in steps (a) and (b) and said comparing in step (c) taking place individually for each of said waveform segments:

20. The method as recited in claim 19 wherein the alphabet comprises right and left terminator points for describing the right and left end points respectively of each segment, said terminator point indicating whether the segment is part of an interior region of a waveform or a beginning or end portion of a waveform.

21. The method as recited in claim 1 wherein said waveform sequence elements of each subset of each of said first and second waveform sequence source multisets are derived by:
(a) representing a first and second waveform of interest as a series of discrete points, each point having an amplitude value;
(b) defining each of said first and second waveforms between right and left terminator points, said terminator points having amplitude values;
(c) selecting, for each of said first and second waveforms, the global maximum and global minimum points according to their amplitude values, said global maximum and global minimum selected between said right and left terminator points;
(d) assigning an alphabet symbol to represent the selected global maximum, global minimum and terminator points, said alphabet symbol assigned to characterize said points based on amplitude values of adjacent ones of said global maximum, global minimum and terminator points, while ignoring all other points;
(e) dividing each of said first and second waveforms into regions according to the respective selected global maximum and global minimum points and the terminator points;
(f) within each region, selecting a local maximum and minimum points according to their amplitude values;
(g) within each region and for each of said first and second waveforms, assigning an alphabet symbol to represent the selected local maximum and local minimum points, said symbol assigned to characterize said local maximum and local minimum points based on amplitude values of adjacent ones of said local maximum, said local minimum, said global maximum, said global minimum, and said terminator points, if any, while ignoring all other points; and
(h) forming said first and second waveform sequence by combining said alphabet symbols assigned in steps (d) and (g).

22. The method as recited in claim 1 wherein said waveform sequence elements of each subset of each of said first and second waveform sequence source multisets are derived by:
(a) representing a first and second waveform of interest as a series of discrete points, each point having an amplitude value;
(b) defining each of said first and second waveforms between right and left terminator points, said terminator points having amplitude values;
(c) selecting, for each of said first and second waveforms, the global maximum and global minimum points according to their amplitude values, said global maximum and global minimum selected between said right and left terminator points;
(d) assigning an alphabet symbol to represent the selected global maximum, global minimum and terminator points, said alphabet symbol assigned to characterize said points based on amplitude values of adjacent ones of said global maximum, global minimum and terminator points, while ignoring all other points;
(e) dividing each of said first and second waveforms into regions according to the respective selected global maximum and global minimum points and the terminator points;
(f) selecting, for each of said first and second waveforms, the next global maximum and next global minimum points according to their amplitude values;
(g) assigning an alphabet symbol to represent the selected next global maximum and next global minimum points, said alphabet symbol assigned to characterize said points based on amplitude values of adjacent ones of said next global maximum, said next global minimum, said global maximum, said global minimum, and said terminator points, if any, while ignoring all other points; and
(h) forming a first sequence of symbols by combining the symbols assigned in steps (d) and (g).

23. A method of waveform comparison comprising:
(a) mapping, through an attractor process, a first waveform sequence source multiset, from an original representation space (ORS) into an attractor behavior space;
(i) said first waveform sequence source multisets being a plurality of subsets of a first waveform sequence and each subset having a plurality of waveform sequence elements;
(ii) said attractor process being an iterative and contractive process which causes first waveform sequences source multisets in the ORS to converge to at least two distinct behaviors in said attractor behavior space;
(iii) wherein each behavior in said attractor behavior space is assigned a distinct symbol from a symbol scheme,
(iv) said mapping resulting in a first token string consisting of a series of said symbols, corresponding to said first waveform sequence source multisets respectively;
(b) mapping, through said attractor process and into said attractor behavior space, a plurality of first waveform subsequences source multisets of said first waveform sequences respectively,
(i) said plurality of first waveform subsequence source multisets being a plurality of subsets of a different one of a plurality of a first waveform subsequence of said first waveform sequence and each having a number of waveform sequence elements;
(ii) said mapping resulting in a plurality of first subsequence token strings, each consisting of a series of said symbols, corresponding to said plurality of first waveform subsequence source multisets respectively; and
(c) mapping, through an attractor process, a second waveform sequence source multiset, from an original representation space (ORS) into an attractor behavior space;
(i) said second waveform sequence source multisets being a plurality of subsets of a second waveform sequence and each subset having a plurality of waveform sequence elements;
(ii) said attractor process being an iterative and contractive process which causes second waveform sequences source multisets in the ORS to converge to at least two distinct behaviors in said attractor behavior space;
(iii) wherein each behavior in said attractor behavior space is assigned a distinct symbol from said symbol scheme,
(iv) said mapping resulting in a second token string consisting of a series of said symbols, corresponding to said second waveform sequence source multisets respectively;
(d) mapping, through said attractor process and into said attractor behavior space, a plurality of second waveform subsequences source multisets of said second waveform sequences respectively,
(i) said plurality of second waveform subsequence source multisets being a plurality of subsets of a different one of a plurality of a second waveform subsequence of said second waveform sequence and each having a number of waveform sequence elements;
(ii) said mapping resulting in a plurality of second subsequence token strings, each consisting of a series of said symbols, corresponding to said plurality of second waveform subsequence source multisets respectively; and
(e) comparing said first token string and said plurality of first subsequence token strings with said second token string and said plurality of second subsequence token strings respectively to determine a match among said first and second waveform sequence source multisets and said plurality of first and second waveform subsequences source multisets.

24. A method of waveform comparison comprising:
(a) representing a first waveform as a first series of discrete points, each point having a value, a first waveform sequence source multiset being at least a portion of said first series of discrete points and a plurality of subsets of said portion of said first series of discrete points, and each subset having a plurality of said discrete points as waveform sequence elements;
(i) mapping, through an iterative and contractive process, said first waveform sequence source multiset into an attractor behavior space having at least two distinct behaviors with each behavior assigned a distinct symbol;
(ii) said mapping resulting in a first token string consisting of a series of said symbols, corresponding to said first waveform sequence source multisets;
(b) representing a second waveform as a second series of discrete points, each point having a value, a second waveform sequence source multiset being at least a portion of said second series of discrete points and a plurality of subsets of said portion of said second series of discrete points, and each subset having a plurality of said discrete points as waveform sequence elements;
(i) mapping, through said iterative and contractive process, said second waveform sequence source multiset into said attractor behavior space;
(ii) said mapping resulting in a second token string consisting of a series of said symbols, corresponding to said second waveform sequence source multisets;
(c) comparing said first token string and with said second token string to determine a match among said first and second waveform sequence source multisets.

25. The method as recited in claim 24 further comprising:
(a) mapping, through said iterative and contractive process into said attractor behavior space, a plurality of first waveform subsequences source multisets of said first waveform sequences respectively,
(i) said plurality of first waveform subsequence source multisets being a plurality of subsequences of said first series of discrete points and, for each subsequence, a plurality of subsets said first series of discrete points which belong so said subsequences, each subset having a plurality of said discrete points as waveform sequence elements
(ii) said mapping resulting in a plurality of first subsequence token strings, each consisting of a series of said symbols, corresponding to said plurality of first waveform subsequence source multisets respectively;
(b) mapping, through said iterative and contractive process into said attractor behavior space, a plurality of second waveform subsequences source multisets of said second waveform sequences respectively,
(i) said plurality of second waveform subsequence source multisets being a plurality of subsequences of said second series of discrete points and, for each subsequence, a plurality of subsets of said second series of discrete points which belong so said subsequences, each subset having a plurality of said discrete points as waveform sequence elements
(ii) said mapping resulting in a plurality of second subsequence token strings, each consisting of a series of said symbols, corresponding to said plurality of second waveform subsequence source multisets respectively;
(c) comparing said first token string and said plurality of first subsequence token strings with said second token string and said plurality of second subsequence token strings respectively to determine a match among said first and second waveform sequence source multisets and said plurality of first and second waveform subsequences source multisets.

26. The method as recited in claim 25 further including the step of forming said at least first and second waveform sequence source multisets by, for each of said first and second waveforms s:
(a) removing j sequence elements, where j is an integer initially equal to one, from one end of said waveform sequence;
(b) iteratively repeating step (a) at least once for j=j+1 at each iteration, and at most for j equal to the number of sequence elements in said waveform.

27. The method as recited in claim 26 further including the step of forming said at least first and second waveform subsequence source multisets by, for each of said plurality of first and second waveform subsequences:
(a) removing j sequence elements, where j is an integer initially equal to one, from one end of said waveform subsequence;
(b) iteratively repeating step (e) at least once for j=j+1 at each iteration, and at most for j equal to the number of sequence elements in said waveform subsequence.

28. The method as recited in claim 24 further including the step of forming said at least first and second waveform sequence source multisets by, for each of said first and second waveforms s:
(a) removing j sequence elements, where j is an integer initially equal to one, from one end of said waveform sequence;
(b) iteratively repeating step (a) at least once for j=j+1 at each iteration, and at most for j equal to the number of sequence elements in said waveform.

29. A method of comparing at least a first and second waveform comprising the steps of:
(a) representing the first waveform as a series of discrete points;
(b) setting k initially equal to “first” where k is an ordinal number;
(c) selecting a k plurality of points based on a k resolution examination of said series of discrete points;
(d) assigning symbols from an alphabet of symbols to represent the k plurality of points at said k resolution examination;
(e) incrementing k such that k=k+1;
(f) repeating steps (c) and (d) at least once;
(g) forming a sequence of symbols by combining the assigned symbols formed in steps (d);
(h) mapping said sequence with an iterative, contractive process which causes said sequence to converge on one of at least two different behaviors, and assigning a first token indicative of said behavior;
(i) representing the second waveform as a series of discrete points;
(j) setting m initially equal to “first” where m is an ordinal number;
(k) selecting a m plurality of points based on a m resolution examination of said series of discrete points;
(l) assigning symbols from said alphabet of symbols to represent the m plurality of points at said m resolution examination;
(m) incrementing m such that m=m+1;
(n) repeating steps (k) and (l) at least once;
(o) forming a sequence of symbols by combining the assigned symbols formed in steps (l);
(p) mapping said sequence with an iterative, contractive process which causes said sequence to converge on one of at least two different behaviors, and assigning a second token indicative of said behavior;
(q) comparing said first and second waveforms by comparing the first and second tokens.

30. The method as recited in claim 29 wherein said selecting steps (c) and (k) are performed by selecting successive maxima and minima points at each iteration of steps (f) and (n) respectively.


SEQUENCE LISTING (38 sequences)

SEQ ID NO: 1 - DNA, 19 bp, Artificial Sequence
  Description of Artificial Sequence Synthetic oligonucleotide
ggatacgtcgtataacgta

SEQ ID NO: 2 - DNA, 19 bp, Artificial Sequence
  Description of Artificial Sequence Synthetic oligonucleotide
tataacgtattagacacgg

SEQ ID NO: 3 - DNA, 18 bp, Artificial Sequence
  Description of Artificial Sequence Synthetic oligonucleotide
gatacgtcgtataacgta

SEQ ID NO: 4 - DNA, 17 bp, Artificial Sequence
  Description of Artificial Sequence Synthetic oligonucleotide
atacgtcgtataacgta

SEQ ID NO: 5 - DNA, 16 bp, Artificial Sequence
  Description of Artificial Sequence Synthetic oligonucleotide
tacgtcgtataacgta

SEQ ID NO: 6 - DNA, 15 bp, Artificial Sequence
  Description of Artificial Sequence Synthetic oligonucleotide
acgtcgtataacgta

SEQ ID NO: 7 - DNA, 14 bp, Artificial Sequence
  Description of Artificial Sequence Synthetic oligonucleotide
cgtcgtataacgta

SEQ ID NO: 8 - DNA, 13 bp, Artificial Sequence
  Description of Artificial Sequence Synthetic oligonucleotide
gtcgtataacgta

SEQ ID NO: 9 - DNA, 12 bp, Artificial Sequence
  Description of Artificial Sequence Synthetic oligonucleotide
tcgtataacgta

SEQ ID NO: 10 - DNA, 11 bp, Artificial Sequence
  Description of Artificial Sequence Synthetic oligonucleotide
cgtataacgta

SEQ ID NO: 11 - DNA, 10 bp, Artificial Sequence
  Description of Artificial Sequence Synthetic oligonucleotide
gtataacgta

SEQ ID NO: 12 - DNA, 18 bp, Artificial Sequence
  Description of Artificial Sequence Synthetic oligonucleotide
ggatacgtcgtataacgt

SEQ ID NO: 13 - DNA, 17 bp, Artificial Sequence
  Description of Artificial Sequence Synthetic oligonucleotide
ggatacgtcgtataacg

SEQ ID NO: 14 - DNA, 16 bp, Artificial Sequence
  Description of Artificial Sequence Synthetic oligonucleotide
ggatacgtcgtataac

SEQ ID NO: 15 - DNA, 15 bp, Artificial Sequence
  Description of Artificial Sequence Synthetic oligonucleotide
ggatacgtcgtataa

SEQ ID NO: 16 - DNA, 14 bp, Artificial Sequence
  Description of Artificial Sequence Synthetic oligonucleotide
ggatacgtcgtata

SEQ ID NO: 17 - DNA, 13 bp, Artificial Sequence
  Description of Artificial Sequence Synthetic oligonucleotide
ggatacgtcgtat

SEQ ID NO: 18 - DNA, 12 bp, Artificial Sequence
  Description of Artificial Sequence Synthetic oligonucleotide
ggatacgtcgta

SEQ ID NO: 19 - DNA, 11 bp, Artificial Sequence
  Description of Artificial Sequence Synthetic oligonucleotide
ggatacgtcgt

SEQ ID NO: 20 - DNA, 10 bp, Artificial Sequence
  Description of Artificial Sequence Synthetic oligonucleotide
ggatacgtcg

SEQ ID NO: 21 - DNA, 18 bp, Artificial Sequence
  Description of Artificial Sequence Synthetic oligonucleotide
ataacgtattagacacgg

SEQ ID NO: 22 - DNA, 17 bp, Artificial Sequence
  Description of Artificial Sequence Synthetic oligonucleotide
taacgtattagacacgg

SEQ ID NO: 23 - DNA, 16 bp, Artificial Sequence
  Description of Artificial Sequence Synthetic oligonucleotide
aacgtattagacacgg

SEQ ID NO: 24 - DNA, 15 bp, Artificial Sequence
  Description of Artificial Sequence Synthetic oligonucleotide
acgtattagacacgg

SEQ ID NO: 25 - DNA, 14 bp, Artificial Sequence
  Description of Artificial Sequence Synthetic oligonucleotide
cgtattagacacgg

SEQ ID NO: 26 - DNA, 13 bp, Artificial Sequence
  Description of Artificial Sequence Synthetic oligonucleotide
gtattagacacgg

SEQ ID NO: 27 - DNA, 12 bp, Artificial Sequence
  Description of Artificial Sequence Synthetic oligonucleotide
tattagacacgg

SEQ ID NO: 28 - DNA, 11 bp, Artificial Sequence
  Description of Artificial Sequence Synthetic oligonucleotide
attagacacgg

SEQ ID NO: 29 - DNA, 10 bp, Artificial Sequence
  Description of Artificial Sequence Synthetic oligonucleotide
ttagacacgg

SEQ ID NO: 30 - DNA, 18 bp, Artificial Sequence
  Description of Artificial Sequence Synthetic oligonucleotide
tataacgtattagacacg

SEQ ID NO: 31 - DNA, 17 bp, Artificial Sequence
  Description of Artificial Sequence Synthetic oligonucleotide
tataacgtattagacac

SEQ ID NO: 32 - DNA, 16 bp, Artificial Sequence
  Description of Artificial Sequence Synthetic oligonucleotide
tataacgtattagaca

SEQ ID NO: 33 - DNA, 15 bp, Artificial Sequence
  Description of Artificial Sequence Synthetic oligonucleotide
tataacgtattagac

SEQ ID NO: 34 - DNA, 14 bp, Artificial Sequence
  Description of Artificial Sequence Synthetic oligonucleotide
tataacgtattaga

SEQ ID NO: 35 - DNA, 13 bp, Artificial Sequence
  Description of Artificial Sequence Synthetic oligonucleotide
tataacgtattag

SEQ ID NO: 36 - DNA, 12 bp, Artificial Sequence
  Description of Artificial Sequence Synthetic oligonucleotide
tataacgtatta

SEQ ID NO: 37 - DNA, 11 bp, Artificial Sequence
  Description of Artificial Sequence Synthetic oligonucleotide
tataacgtatt

SEQ ID NO: 38 - DNA, 10 bp, Artificial Sequence
  Description of Artificial Sequence Synthetic oligonucleotide
tataacgtat